(19) United States
(12) Patent Application Publication
(10) Pub. No.: US 2021/0130542 A1
(43) Pub. Date: May 6, 2021

(54) CATALYSTS SUITABLE FOR THE RING-OPENING POLYMERISATION OF CYCLIC ESTERS AND CYCLIC AMIDES

(71) Applicant: SCG CHEMICALS CO., LTD., Bangkok (TH)

(72) Inventors: Charlotte Katherine Williams, Oxford (GB); Christopher Blair Durr, Oxford (GB)

(21) Appl. No.: 16/644,311

(22) PCT Filed: Sep. 4, 2018
(86) PCT No.: PCT/GB2018/052502

§ 371 Date: Mar. 4, 2020

(30) Foreign Application Priority Data
Sep. 5, 2017 (GB) 1714264.7

(51) Int. Cl. C08G 63/82; C08G 69/16; C07F 7/28

(52) U.S. Cl. CPC C08G 63/823; C07F 7/28; C08G 69/16

(57) ABSTRACT

A new family of Group IV transition metal catalytic compounds are provided, which are capable of catalysing the ROP of cyclic esters and cyclic amides to yield polymers of high molecular weight and narrow PDI. The new family of catalysts are surprisingly active not only in catalysing the ROP of lactones such as caprolactone, but also macrolactones (e.g. ω-pentadecalactone, PDL), where the reduced amount of ring strain would typically compromise efficient polymerisation. Also provided is a process for the ring opening polymerisation (ROP) of a cyclic ester or a cyclic amide employing the new catalytic compounds.

### INTRODUCTION

The present invention relates to catalytic compounds, in particular those that are suitable for catalysing the ring-opening polymerisation (ROP) of cyclic esters (e.g. lactones) and cyclic amides (e.g. lactams). The present invention also relates to a process of polymerising cyclic esters and cyclic amides.

### BACKGROUND OF THE INVENTION

Poly(olefins), such as poly(ethylene) and poly(propylene), are derived almost entirely from non-renewable fossil fuel feedstocks. These materials, consisting of kinetically inert C—C and C—H bonds, also lack a viable biodegradation pathways, thus they will persist in the environment unless recycled. The desirable thermal and mechanical properties gained from poly(olefins) stem from regions of crystallinity, or semi-crystallinity, between overlapping aliphatic chains. These properties can be closely mimicked by poly(esters) derived from the ring-opening polymerisation (ROP) of macrolactones, which contain long sequences of aliphatic chains between ester functionalities.¹ Materials of this kind will retain the attractive properties of polyolefins while allowing for biodecomposition through hydrolysis.

The first detailed report of the ROP of macrolactones by Endo et al. showed how the addition of various group I methoxides at elevated temperature can afford low molecular weight poly(macrolactones) comprised of 12- and 13-membered rings.² More recently, detailed kinetic studies of Al-salen catalysts have shown that polymerizations of lactones larger than caprolactone proceed at similar rates.⁴⁻⁵

There is therefore a need for new compounds that exhibit high catalytic activity in catalysing the ROP of cyclic esters, such as lactones—across the range of ring sizes—to high molecular weight.

The present invention was devised with the foregoing in mind.

### SUMMARY OF THE INVENTION

According to a first aspect of the present invention there is provided a compound having a structure according to formula (I-A), (I-B) or (I-C) defined herein.

According to a second aspect of the present invention there is provided a process for the ring opening polymerisation (ROP) of a cyclic ester or a cyclic amide, the process comprising the step of:
a) contacting a compound according to the first aspect of the invention with one or more cyclic esters or cyclic amides.

According to a third aspect of the present invention there is provided a use of a compound according to the first aspect of the invention in the ring opening polymerisation (ROP) of one or more cyclic esters or cyclic amides.

### DETAILED DESCRIPTION OF THE INVENTION

### Definitions

The term “(m-nC)” or “(m-nC) group” used alone or as a prefix, refers to any group having m to n carbon atoms.

The term “alkyl” as used herein refers to straight or branched chain alkyl moieties, typically having 1, 2, 3, 4, 5 or 6 carbon atoms. This term includes reference to groups such as methyl, ethyl, propyl (n-propyl or isopropyl), butyl (n-butyl, sec-butyl or tert-butyl), pentyl, hexyl and the like. In particular, an alkyl may have 1, 2, 3 or 4 carbon atoms.

The term “alkenyl” as used herein refers to straight or branched chain alkenyl moieties, typically having 1, 2, 3, 4, 5 or 6 carbon atoms. The term includes reference to alkenyl moieties containing 1, 2 or 3 carbon-carbon double bonds (C═C). This term includes reference to groups such as ethenyl (vinyl), propenyl (allyl), butenyl, pentenyl and hexenyl, as well as both the cis and trans isomers thereof.

The term “alkynyl” as used herein refers to straight or branched chain alkynyl moieties, typically having 1, 2, 3, 4, 5 or 6 carbon atoms. The term includes reference to alkynyl moieties containing 1, 2 or 3 carbon-carbon triple bonds (C═C). This term includes reference to groups such as ethynyl, propynyl, butynyl, pentynyl and hexynyl.

The term “haloalkyl” as used herein refers to alkyl groups being substituted with one or more halogens (e.g. F, Cl, Br or I). This term includes reference to groups such as 2-fluoropropyl, 3-chloropentyl, as well as perfluoroalkyl groups, such as perfluoromethyl.

The term “alkoxy” as used herein refers to —O-alkyl, wherein alkyl is straight or branched chain and comprises 1, 2, 3, 4, 5 or 6 carbon atoms. In one class of embodiments, alkoxy has 1, 2, 3 or 4 carbon atoms. This term includes reference to groups such as methoxy, ethoxy, propoxy, isopropoxy, butoxy, tert-butoxy, pentoxy, hexoxy and the like.

The term “dialkylamino” as used herein means a group —N(R_{A})(R_{B}), wherein R_{A} and R_{B} are alkyl groups.

The term “aryl” or “aromatic” as used herein means an aromatic ring system comprising 6, 7, 8, 9 or 10 ring carbon atoms. Aryl is often phenyl but may be a polycyclic ring system, having two or more rings, at least one of which is aromatic. This term includes reference to groups such as phenyl, naphthyl and the like. Unless otherwise specification, aryl groups may be substituted by one or more substituents. A particularly suitable aryl group is phenyl.

The term “aryloxy” as used herein refers to —O-aryl, wherein aryl has any of the definitions discussed herein. Also encompassed by this term are aryloxy groups in having an alkylene chain situated between the 0 and aryl groups.

The term “heteroaryl” or “heteroaromatic” means an aromatic mono-, bi-, or polycyclic ring incorporating one or more (for example 1-4, particularly 1, 2 or 3) heteroatoms selected from nitrogen, oxygen or sulfur. Examples of heteroaryl groups are monocyclic and bicyclic groups containing from five to twelve ring members, and more usually from five to ten ring members. The heteroaryl group can be, for example, a 5- or 6-membered monocyclic ring or a 9- or 10-membered bicyclic ring, for example a bicyclic structure formed from fused five and six membered rings or two fused six membered rings. Each ring may contain up to about four heteroatoms typically selected from nitrogen, sulfur and oxygen. Typically the heteroaryl ring will contain up to 3 heteroatoms, more usually up to 2, for example a single heteroatom.

The term “heteroaryloxy” as used herein refers to —O-heteroaryl, wherein heteroaryl has any of the definitions discussed herein. Also encompassed by this term are heteroaryloxy groups in having an alkylene chain situated between the 0 and heteroaryl groups.

The term “carbocyclyl”, “carbocyclic” or “carbocycle” means a non-aromatic saturated or partially saturated monocyclic, or a fused, bridged, or spiro bicyclic carbocyclic ring system(s). Monocyclic carbocyclic rings contain from about 3 to 12 (suitably from 3 to 7) ring atoms. Bicyclic carbocycles contain from 7 to 17 carbon atoms in the rings, suitably 7 to 12 carbon atoms, in the rings. Bicyclic carbocyclic rings may be fused, spiro, or bridged ring systems. A particularly suitable carbocyclic group is adamantyl.

The term “heterocyclyl”, “heterocyclic” or “heterocycle” means a non-aromatic saturated or partially saturated monocyclic, fused, bridged, or spiro bicyclic heterocyclic ring system(s). Monocyclic heterocyclic rings contain from about 3 to 12 (suitably from 3 to 7) ring atoms, with from 1 to 5 (suitably 1, 2 or 3) heteroatoms selected from nitrogen, oxygen or sulfur in the ring. Bicyclic heterocycles contain from 7 to 17 member atoms, suitably 7 to 12 member atoms, in the ring. Bicyclic heterocyclic(s) rings may be fused, spiro, or bridged ring systems.

The term “halogen” or “halo” as used herein refers to F, Cl, Br or I. In a particular, halogen may be F or CI, of which CI is more common.

The term “substituted” as used herein in reference to a moiety means that one or more, especially up to 5, more especially 1, 2 or 3, of the hydrogen atoms in said moiety are replaced independently of each other by the corresponding number of the described substituents. The term “optionally substituted” as used herein means substituted or unsubstituted.

It will, of course, be understood that substituents are only at positions where they are chemically possible, the person skilled in the art being able to decide (either experimentally or theoretically) without inappropriate effort whether a particular substitution is possible.

The terms “cyclic esters” and “cyclic amides” as used herein refer to heterocycles containing at least one ester or amide moiety. It will be understood that lactides, lactones and lactams are encompassed by these terms.

### Compounds of the Invention

According to a first aspect of the present invention there is provided a compound having a structure according to formula (I-A), (I-B) or (I-C) shown below:

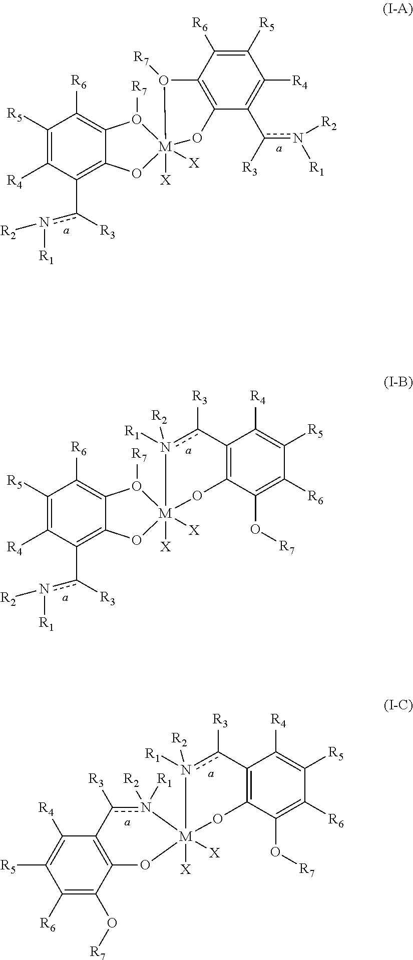

wherein

M is a Group IV transition metal,

each X is independently selected from halo, hydrogen, a phosphonate, sulfonate or boronate group, (1-4C)dialkylamino, (1-6C)alkyl, (1-6C)alkoxy, aryl, and aryloxy, any of which may be optionally substituted one of more groups selected from halo, oxo, hydroxy, amino, nitro, (1-6C)alkyl, (2-6C)alkenyl, (2-6C)alkynyl, (1-6C)haloalkyl, (1-6C)alkoxy, aryl and Si[(1-4C)alkyl]₃,

R₂ is absent or is selected from hydrogen, halo, oxo, hydroxy, amino, nitro, (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and (1-6C)alkoxy, bond a is a carbon-nitrogen single bond (C—N) or a carbon-nitrogen double bond (C═N), with the proviso that when R₂ is absent, bond a is a carbon-nitrogen double bond (C═N), and when R₂ is other than absent, bond a is a carbon-nitrogen single bond (C—N),

R₃, R₄, R₅ and R₆ are each independently selected from hydrogen, halo, oxo, hydroxy, amino, nitro, (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and (1-6C)alkoxy,

R₇ is selected from (1-6C)alkyl, (2-6C)alkenyl, (2-6C)alkynyl, (1-6C)haloalkyl, aryl, heteroaryl, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and (1-6C)alkoxy,

R₁ is a group having the formula (II) shown below:

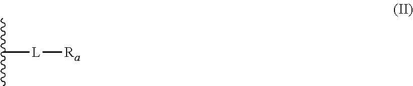

wherein
Rₐ is selected from (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (2-6C)alkenyl, (2-6C)alkynyl, (1-6C)haloalkyl, aryl, aryloxy, heteroaryl, heteroaryloxy, carbocyclyl and heterocyclyl,
L is a group —[C(Rₓ)₂]ₙ—
   wherein
      each Rₓ is independently selected from hydrogen, (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and aryl, and
      n is 0, 1, 2, 3 or 4.

Through detailed investigations, the inventors have developed a new family of Group IV transition metal-based catalysts capable of catalysing the ROP of cyclic esters and cyclic amides to yield polymers of high molecular weight and narrow PDI. The new family of catalysts are surprisingly active not only in catalysing the ROP of lactones such as caprolactone, but also macrolactones (e.g. ω-pentadecalactone, PDL), where the reduced amount of ring strain would typically compromise efficient polymerisation.

The new family of catalysts encompasses three different coordination chemistry, embodied by formulae (I-A), (I-B) and (I-C). As depicted below, in formula (I-A), both bidentate phenyl-containing ligands are bound to M via two oxygen atoms (O,O:O,O coordination), thereby forming two 5-membered rings. In formula (I-B), one of the phenyl-containing ligands is bound to M via two oxygen atoms, whereas the other phenyl-containing ligand is bound to M via one oxygen atom and one nitrogen atom (O,O:N,O coordination), thereby forming one 5-membered ring and one 6-membered ring. In formula (I-C), both bidentate phenyl-containing ligands are bound to M via one oxygen atom and one nitrogen atom (N,O:N,O coordination), thereby forming two 6-membered rings.

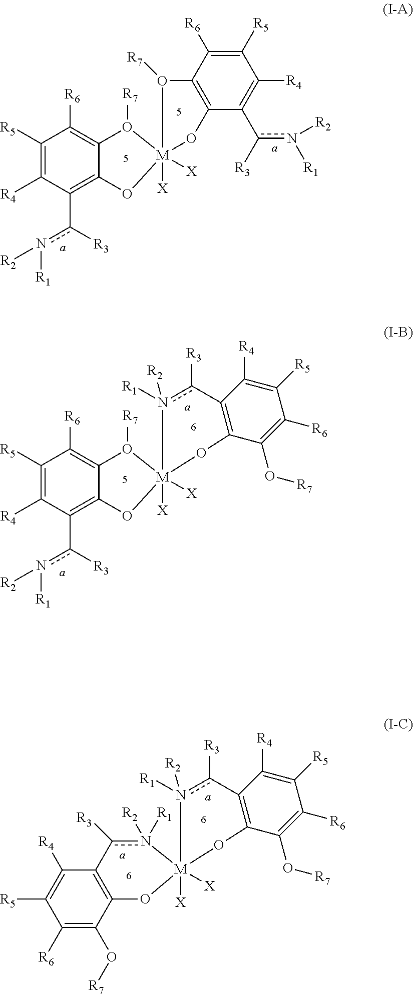

It will be appreciated that the compounds of the invention may exist in a number of structurally isomeric forms. For example, compound of formula (I-C) may exist in either of the following structural isomeric forms:

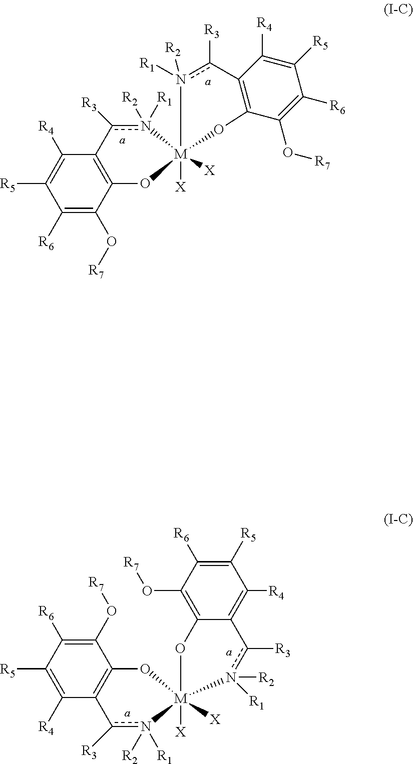

The compounds of the invention are suitable for catalysing the ROP of cyclic esters and cyclic amides.

In an embodiment, the compound has a structure according to formula (I-A) or (I-B). The particular coordination type depicted in formulae (I-A) and (I-B) is preferred.

In an embodiment, the compound has a structure according to formula (I-A). The particular coordination type depicted in formula (I-A) is most preferred.

In an embodiment, the compound has a structure according to formula (I-B).

In an embodiment, the compound has a structure according to formula (I-C).

In an embodiment, the compound has a structure according to formula (I-A), (I-B) or (I-C), wherein
M is a Group IV transition metal,
each X is independently selected from halo, hydrogen, a phosphonate, sulfonate or boronate group, (1-6C)alkyl, (1-6C)alkoxy, aryl, and aryloxy, any of which may be optionally substituted one of more groups selected from halo, oxo, hydroxy, amino, nitro, (1-6C)alkyl, (2-6C)alkenyl, (2-6C)alkynyl, (1-6C)haloalkyl, (1-6C)alkoxy, aryl and Si[(1-4C)alkyl]₃,
R₂ is absent or is selected from hydrogen, halo, oxo, hydroxy, amino, nitro, (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and (1-6C)alkoxy,
bond a is a carbon-nitrogen single bond (C—N) or a carbon-nitrogen double bond (C═N), with the proviso that when R₂ is absent, bond a is a carbon-nitrogen double bond (C═N), and when R₂ is other than absent, bond a is a carbon-nitrogen single bond (C—N),
R₃, R₄, R₅ and R₆ are each independently selected from hydrogen, halo, oxo, hydroxy, amino, nitro, (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and (1-6C)alkoxy,
R₇ is selected from (1-6C)alkyl, (2-6C)alkenyl, (2-6C)alkynyl, (1-6C)haloalkyl, aryl, heteroaryl, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and (1-6C)alkoxy,
R₁ is a group having the formula (II) shown below:

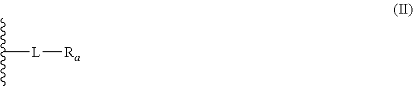

wherein
   Rₐ is selected from (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (2-6C)alkenyl, (2-6C)alkynyl, (1-6C)haloalkyl, aryl, aryloxy, heteroaryl, heteroaryloxy, carbocyclyl and heterocyclyl,
   L is a group —[C(Rₓ)₂]ₙ—
      wherein
         each Rₓ is independently selected from hydrogen, (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and aryl, and
         n is 0, 1, 2, 3 or 4.

In an embodiment, M is selected from titanium, zirconium and hafnium. Suitably, M is selected from titanium and zirconium. More suitably, M is titanium.

In an embodiment, each X is independently selected from halo, hydrogen, (1-4C)dialkylamino, (1-6C)alkoxy, and aryloxy, any of which may be optionally substituted one of more groups selected from halo, oxo, hydroxy, amino, nitro, (1-6C)alkyl, (2-6C)alkenyl, (2-6C)alkynyl, (1-6C)haloalkyl, (1-6C)alkoxy, aryl and Si[(1-4C)alkyl]₃.

In an embodiment, each X is independently selected from halo, hydrogen, (1-6C)alkoxy, and aryloxy, any of which may be optionally substituted one of more groups selected from halo, oxo, hydroxy, amino, nitro, (1-6C)alkyl, (2-6C)alkenyl, (2-6C)alkynyl, (1-6C)haloalkyl, (1-6C)alkoxy, aryl and Si[(1-4C)alkyl]₃.

In an embodiment, each X is independently selected from halo, hydrogen, (1-6C)alkoxy, and aryloxy, any of which may be optionally substituted one of more groups selected from halo, oxo, hydroxy, amino, nitro, (1-6C)alkyl, (1-6C)haloalkyl, (1-6C)alkoxy and aryl.

In an embodiment, each X is independently selected from halo, hydrogen, (1-4C)alkoxy, and phenoxy, any of which may be optionally substituted one of more groups selected from halo, oxo, hydroxy, amino, nitro, (1-4C)alkyl, (1-4C)haloalkyl, (1-4C)alkoxy and phenyl.

In an embodiment, each X is independently selected from halo, hydrogen, —N(CH₃)₂, —N(CH₂CH₃)₂ and (1-4C)alkoxy, any of which may be optionally substituted one of more groups selected from halo, hydroxy, amino, (1-4C)alkyl and (1-4C)alkoxy.

In an embodiment, each X is independently selected from halo, hydrogen, and (1-4C)alkoxy, any of which may be optionally substituted one of more groups selected from halo, hydroxy, amino, (1-4C)alkyl and (1-4C)alkoxy.

In an embodiment, each X is independently selected from chloro, bromo, —N(CH₃)₂, —N(CH₂CH₃)₂ and (1-4C)alkoxy.

In an embodiment, each X is independently selected from chloro, bromo and (1-4C)alkoxy.

In an embodiment, each X is independently (1-4C)alkoxy.

In an embodiment, each X is isopropoxy.

In an embodiment, each X is independently (1-4C)dialkylamino. Suitably, X is independently —N(CH₃)₂ or —N(CH₂CH₃)₂.

In an embodiment, R₂ is absent or is selected from hydrogen, hydroxy, (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-4C)alkyl, (1-4C)haloalkyl and (1-4C)alkoxy.

In an embodiment, R₂ is absent or is selected from hydrogen, hydroxy, (1-4C)alkyl, (2-4C)alkenyl, (2-4C)alkynyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy.

In an embodiment, R₂ is absent or is selected from hydrogen, (1-4C)alkyl, (2-4C)alkenyl, (2-4C)alkynyl and aryl, any of which may be optionally substituted with one or more substituents selected from halo, hydroxy, amino, (1-4C)alkyl and (1-4C)alkoxy.

In an embodiment, R₂ is absent or is selected from hydrogen, (1-4C)alkyl and phenyl, any of which may be optionally substituted with one or more substituents selected from halo, hydroxy, amino, (1-4C)alkyl and (1-4C)alkoxy.

In an embodiment, R₂ is absent or is selected from hydrogen, (1-4C)alkyl and phenyl.

In an embodiment, R₂ is absent or is selected from hydrogen and (1-4C)alkyl.

In an embodiment, R₂ is absent or hydrogen.

In an embodiment, R₂ is absent.

In an embodiment, R₂ is hydrogen.

In an embodiment, bond a is a carbon-nitrogen double bond (C═N).

In an embodiment, R₃, R₄, R₅ and R₆ are each independently selected from hydrogen, halo, oxo, hydroxy, amino, nitro, (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-4C)alkyl, (2-4C)alkenyl, (2-4C)alkynyl, (1-4C)haloalkyl and (1-4C)alkoxy.

In an embodiment, R₃, R₄, R₅ and R₆ are each independently selected from hydrogen, halo, oxo, hydroxy, amino, nitro, (1-4C)alkyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy.

In an embodiment, R₃, R₄, R₅ and R₆ are each independently selected from hydrogen, halo, amino, nitro, (1-4C)alkyl, (1-4C)haloalkyl, (1-4C)alkoxy, aryl and heteroaryl, any of which may be optionally substituted with one or more substituents selected from halo and (1-4C)alkyl.

In an embodiment, R₃, R₄, R₅ and R₆ are each independently selected from hydrogen, halo, amino, (1-4C)alkyl, (1-4C)haloalkyl, (1-4C)alkoxy and phenyl, any of which may be optionally substituted with one or more substituents selected from halo and (1-4C)alkyl.

In an embodiment, R₃, R₄, R₅ and R₆ are each independently selected from hydrogen, halo, amino, (1-4C)alkyl and phenyl, any of which may be optionally substituted with one or more substituents selected from halo and (1-4C)alkyl.

In an embodiment, R₃, R₄, R₅ and R₆ are each independently selected from hydrogen, (1-4C)alkyl and phenyl.

In an embodiment, R₃ is hydrogen.

In an embodiment, R₃, R₄, R₅ and R₆ are hydrogen.

In an embodiment, R₇ is selected from (1-6C)alkyl, (2-6C)alkenyl, (2-6C)alkynyl, (1-6C)haloalkyl, aryl and heteroaryl, any of which may be optionally substituted with one or more substituents selected from halo, oxo, hydroxy, amino, nitro, (1-6C)alkyl, (1-6C)haloalkyl and (1-6C)alkoxy.

In an embodiment, R₇ is selected from (1-4C)alkyl, (2-4C)alkenyl, (2-4C)alkynyl, (1-4C)haloalkyl, aryl and heteroaryl, any of which may be optionally substituted with one or more substituents selected from halo, oxo, hydroxy, amino, nitro, (1-4C)alkyl, (1-4C)haloalkyl and (1-4C)alkoxy.

In an embodiment, R₇ is selected from (1-4C)alkyl, (1-4C)haloalkyl, aryl and heteroaryl, any of which may be optionally substituted with one or more substituents selected from halo, hydroxy, amino, (1-4C)alkyl and (1-4C)alkoxy.

In an embodiment, R₇ is selected from (1-4C)alkyl and aryl, any of which may be optionally substituted with one or more substituents selected from halo, hydroxy, amino, (1-4C)alkyl and (1-4C)alkoxy.

In an embodiment, R₇ is selected from (1-2C)alkyl and phenyl, any of which may be optionally substituted with one or more substituents selected from halo, hydroxy, amino and (1-4C)alkyl. Suitably, the one or more optional substituents is halo (e.g. fluoro).

In an embodiment, R₇ is (1-2C)alkyl, optionally substituted with one or more substituents selected from halo.

In an embodiment, R₇ is (1-2C)alkyl.

In an embodiment, R₇ is methyl, optionally substituted with one or more fluoro substituents.

In an embodiment, R₇ is methyl or trifluoromethyl.

In a particularly suitable embodiment, R₇ is methyl.

In an embodiment, Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (2-6C)alkenyl, (2-6C)alkynyl, (1-6C)haloalkyl, aryl, aryloxy, heteroaryl, heteroaryloxy, carbocyclyl and heterocyclyl.

In an embodiment, Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy.

In an embodiment, Rₐ is selected from (1-4C)alkyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy.

In an embodiment, Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy.

In an embodiment, Rₐ is selected from phenyl, phenoxy, 5-7 membered heteroaryl, 5-7 membered heteroaryloxy, 5-12 membered carbocyclyl and 5-12 membered heterocyclyl, any of which (for example the phenyl group) may be optionally substituted with one or more substituents selected from halo, oxo, hydroxy, amino, nitro, (1-5C)alkyl, (1-5C)haloalkyl, phenyl, phenoxy, heteroaryl and heteroaryloxy.

In an embodiment, Rₐ is selected from phenyl, 5-7 membered heteroaryl and 5-12 membered carbocyclyl, any of which (for example the phenyl group) may be optionally substituted with one or more substituents selected from halo, oxo, hydroxy, amino, nitro, (1-5C)alkyl, (1-5C)haloalkyl, phenyl, and heteroaryl.

In an embodiment, Rₐ is selected from phenyl and 5-12 membered carbocyclyl, any of which (for example the phenyl group) may be optionally substituted with one or more substituents selected from halo, hydroxy, amino, (1-5C)alkyl, (1-5C)haloalkyl, phenyl, and heteroaryl.

In an embodiment, Rₐ is selected from phenyl, cyclohexyl and adamantyl, any of which (for example the phenyl group) may be optionally substituted with one or more substituents selected from halo, (1-5C)alkyl, phenyl, and heteroaryl.

In an embodiment, Rₐ is not unsubstituted phenyl or unsubstituted cyclohexyl.

In an embodiment, Rₐ is not unsubstituted phenyl.

In an embodiment, Rₐ is not unsubstituted cyclohexyl.

In an embodiment, Rₓ is independently selected from hydrogen, (1-6C)alkyl, (1-6C)alkoxy and aryl, any of which may be optionally substituted with one or more substituents selected from halo, oxo, hydroxy, amino, nitro, (1-6C)alkyl and (1-6C)haloalkyl.

In an embodiment, Rₓ is independently selected from hydrogen, (1-4C)alkyl, (1-4C)alkoxy and phenyl, any of which may be optionally substituted with one or more substituents selected from halo, amino and (1-6C)alkyl.

In an embodiment, Rₓ is independently selected from hydrogen, (1-4C)alkyl, and phenyl, any of which may be optionally substituted with one or more substituents selected from halo, amino and (1-3C)alkyl.

In an embodiment, each Rₓ is phenyl.

In an embodiment, n is 0, 1 or 2.

In an embodiment, n is 0 or 1.

In an embodiment, n is 0 (in which case Rₐ is bonded directly to N).

In an embodiment, the compound has a structure according to formula (I-A), (I-B) or (I-C), wherein

M is selected from titanium, zirconium and hafnium;
each X is independently selected from halo, hydrogen, (1-6C)alkoxy, and aryloxy, any of which may be optionally substituted one of more groups selected from halo, oxo, hydroxy, amino, nitro, (1-6C)alkyl, (1-6C)haloalkyl, (1-6C)alkoxy and aryl;
R₂ is absent or is selected from hydrogen, (1-4C)alkyl and phenyl;
R₃, R₄, R₅ and R₆ are each independently selected from hydrogen, halo, oxo, hydroxy, amino, nitro, (1-4C)alkyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₇ is selected from (1-4C)alkyl, (2-4C)alkenyl, (2-4C)alkynyl, (1-4C)haloalkyl, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound has a structure according to formula (I-A), (I-B) or (I-C), wherein

M is selected from titanium and zirconium;
each X is independently selected from halo, hydrogen, and (1-4C)alkoxy, any of which may be optionally substituted one of more groups selected from halo, hydroxy, amino, (1-4C)alkyl and (1-4C)alkoxy;
R₂ is absent or is selected from hydrogen, (1-4C)alkyl and phenyl;
R₃, R₄, R₅ and R₆ are each independently selected from hydrogen, halo, amino, (1-4C)alkyl, (1-4C)haloalkyl, (1-4C)alkoxy and phenyl, any of which may be optionally substituted with one or more substituents selected from halo and (1-4C)alkyl;
R₇ is selected from (1-4C)alkyl and aryl, any of which may be optionally substituted with one or more substituents selected from halo, hydroxy, amino, (1-4C)alkyl and (1-4C)alkoxy;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A), (I-B) or (I-C), wherein

M is selected from titanium and zirconium;
each X is independently selected from chloro, bromo and (1-4C)alkoxy;
R₂ is absent or is selected from hydrogen and (1-4C)alkyl;
R₃, R₄, R₅ and R₆ are each independently selected from hydrogen, halo, amino, (1-4C)alkyl and phenyl, any of which may be optionally substituted with one or more substituents selected from halo and (1-4C)alkyl;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A), (I-B) or (I-C), wherein

M is titanium;
each X is independently (1-4C)alkoxy;
   R₂ is absent;
   R₃, R₄, R₅ and R₆ are each independently selected from hydrogen, (1-4C)alkyl and phenyl;

### R₇ is (1-2C)alkyl;

R₁ is a group of formula (II) defined herein, wherein
Rₐ is selected from phenyl, cyclohexyl and adamantyl, any of which (for example the phenyl group group) may be optionally substituted with one or more substituents selected from halo, (1-5C)alkyl, phenyl, and heteroaryl;
each Rₓ is phenyl; and
n is 0 or 1.

In an embodiment, the compound has a structure according to formula (I-A-1), (I-B-1) or (I-C-1) shown below:

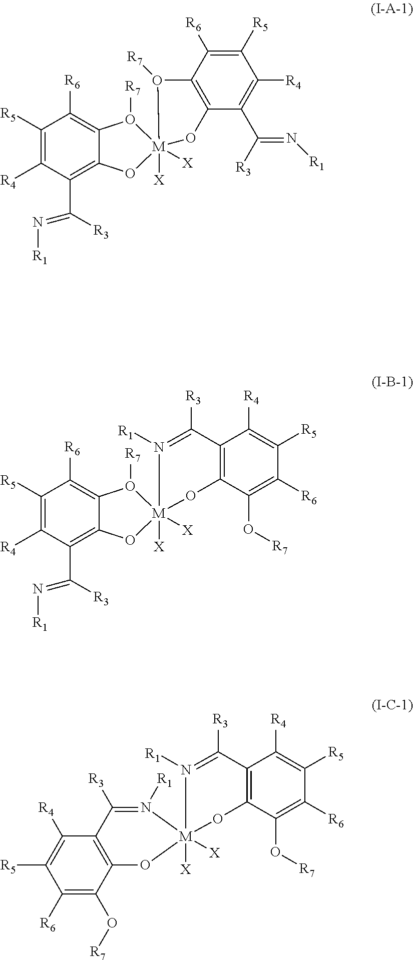

wherein M, X, R₁ and R₃-R₇ have any of the definitions discussed hereinbefore in respect of formulae (I-A), (I-B) and (I-C).

In an embodiment, the compound having a structure according to formula (I-A-1), (I-B-1) or (I-C-1) has a structure according to formula (I-A-1) or (I-B-1).

In an embodiment, the compound having a structure according to formula (I-A-1), (I-B-1) or (I-C-1) has a structure according to formula (I-A-1).

In an embodiment, the compound having a structure according to formula (I-A-1), (I-B-1) or (I-C-1) has a structure according to formula (I-B-1).

In an embodiment, the compound having a structure according to formula (I-A-1), (I-B-1) or (I-C-1) has a structure according to formula (I-C-1).

In an embodiment, the compound has a structure according to formula (I-A-1), (I-B-1) or (I-C-1), wherein

M is selected from titanium, zirconium and hafnium;
each X is independently selected from halo, hydrogen, (1-6C)alkoxy, and aryloxy, any of which may be optionally substituted one of more groups selected from halo, oxo, hydroxy, amino, nitro, (1-6C)alkyl, (1-6C)haloalkyl, (1-6C)alkoxy and aryl;
R₃, R₄, R₅ and R₆ are each independently selected from hydrogen, halo, oxo, hydroxy, amino, nitro, (1-4C)alkyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₇ is selected from (1-4C)alkyl, (2-4C)alkenyl, (2-4C)alkynyl, (1-4C)haloalkyl, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound has a structure according to formula (I-A-1), (I-B-1) or (I-C-1), wherein

M is selected from titanium and zirconium;
each X is independently selected from halo, hydrogen, and (1-4C)alkoxy, any of which may be optionally substituted one of more groups selected from halo, hydroxy, amino, (1-4C)alkyl and (1-4C)alkoxy;
R₃, R₄, R₅ and R₆ are each independently selected from hydrogen, halo, amino, (1-4C)alkyl, (1-4C)haloalkyl, (1-4C)alkoxy and phenyl, any of which may be optionally substituted with one or more substituents selected from halo and (1-4C)alkyl;
R₇ is selected from (1-4C)alkyl and aryl, any of which may be optionally substituted with one or more substituents selected from halo, hydroxy, amino, (1-4C)alkyl and (1-4C)alkoxy;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-1), (I-B-1) or (I-C-1), wherein

M is selected from titanium and zirconium;
each X is independently selected from chloro, bromo and (1-4C)alkoxy;
R₃, R₄, R₅ and R₆ are each independently selected from hydrogen, halo, amino, (1-4C)alkyl and phenyl, any of which may be optionally substituted with one or more substituents selected from halo and (1-4C)alkyl;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from phenyl and 5-12 membered carbocyclyl, any of which may (for example the phenyl group) be optionally substituted with one or more substituents selected from halo, hydroxy, amino, (1-5C)alkyl, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-1), (I-B-1) or (I-C-1), wherein

M is titanium;
each X is independently (1-4C)alkoxy;
R₃, R₄, R₅ and R₆ are each independently selected from hydrogen, (1-4C)alkyl and phenyl;

### R₇ is (1-2C)alkyl;

R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound has a structure according to formula (I-A-2), (I-B-2) or (I-C-2) shown below:

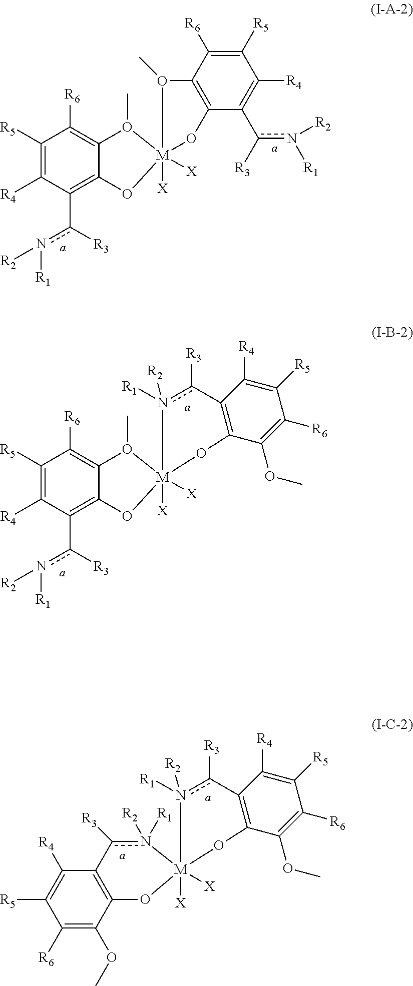

wherein M, X and R₁-R₆ have any of the definitions discussed hereinbefore in respect of formulae (I-A), (I-B) and (I-C).

In an embodiment, the compound having a structure according to formula (I-A-2), (I-B-2) or (I-C-2) has a structure according to formula (I-A-2) or (I-B-2).

In an embodiment, the compound having a structure according to formula (I-A-2), (I-B-2) or (I-C-2) has a structure according to formula (I-A-2).

In an embodiment, the compound having a structure according to formula (I-A-2), (I-B-2) or (I-C-2) has a structure according to formula (I-B-2).

In an embodiment, the compound having a structure according to formula (I-A-2), (I-B-2) or (I-C-2) has a structure according to formula (I-C-2).

In an embodiment, the compound has a structure according to formula (I-A-2), (I-B-2) or (I-C-2), wherein

M is selected from titanium, zirconium and hafnium;
each X is independently selected from halo, hydrogen, (1-6C)alkoxy, and aryloxy, any of which may be optionally substituted one of more groups selected from halo, oxo, hydroxy, amino, nitro, (1-6C)alkyl, (1-6C)haloalkyl, (1-6C)alkoxy and aryl;
R₂ is absent or is selected from hydrogen, (1-4C)alkyl and phenyl;
R₃, R₄, R₅ and R₆ are each independently selected from hydrogen, halo, oxo, hydroxy, amino, nitro, (1-4C)alkyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound has a structure according to formula (I-A-2), (I-B-2) or (I-C-2), wherein

M is selected from titanium and zirconium;
each X is independently selected from halo, hydrogen, and (1-4C)alkoxy, any of which may be optionally substituted one of more groups selected from halo, hydroxy, amino, (1-4C)alkyl and (1-4C)alkoxy;
R₂ is absent or is selected from hydrogen, (1-4C)alkyl and phenyl;
R₃, R₄, R₅ and R₆ are each independently selected from hydrogen, halo, amino, (1-4C)alkyl, (1-4C)haloalkyl, (1-4C)alkoxy and phenyl, any of which may be optionally substituted with one or more substituents selected from halo and (1-4C)alkyl;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-2), (I-B-2) or (I-C-2), wherein

M is selected from titanium and zirconium;
each X is independently selected from chloro, bromo and (1-4C)alkoxy;
R₂ is absent or hydrogen;
R₃, R₄, R₅ and R₆ are each independently selected from hydrogen, halo, amino, (1-4C)alkyl and phenyl, any of which may be optionally substituted with one or more substituents selected from halo and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-2), (I-B-2) or (I-C-2), wherein

M is titanium;
each X is independently (1-4C)alkoxy;
R₂ is absent or hydrogen;
R₃, R₄, R₅ and R₆ are each independently selected from hydrogen, (1-4C)alkyl and phenyl;
R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound has a structure according to formula (I-A-2), (I-B-2) or (I-C-2), wherein

M is selected from titanium and zirconium;
each X is independently selected from chloro, bromo and (1-4C)alkoxy;
R₂ is absent;
R₃, R₄, R₅ and R₆ are each independently selected from hydrogen, halo, amino, (1-4C)alkyl and phenyl, any of which may be optionally substituted with one or more substituents selected from halo and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-2), (I-B-2) or (I-C-2), wherein

M is titanium;
each X is independently (1-4C)alkoxy;
R₂ is absent or hydrogen;
R₃, R₄, R₅ and R₆ are each independently selected from hydrogen, (1-4C)alkyl and phenyl;
R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound has a structure according to formula (I-A-3), (I-B-3) or (I-C-3) shown below:

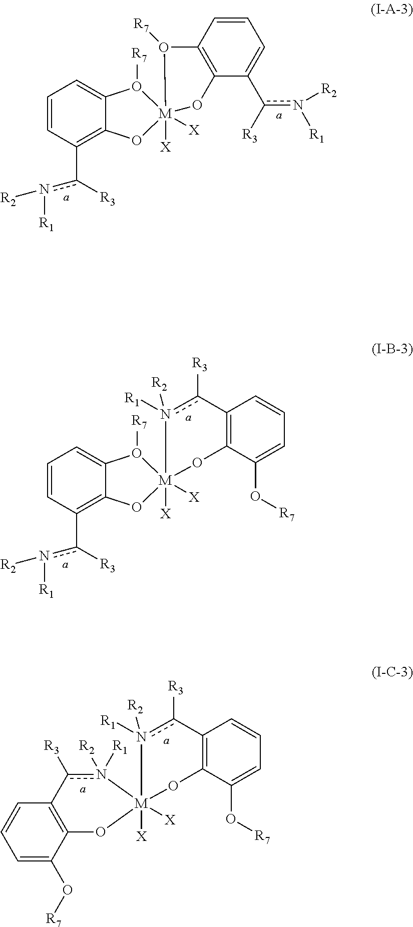

wherein M, X, R₁-R₃ and R₇ have any of the definitions discussed hereinbefore in respect of formulae (I-A), (I-B) and (I-C).

In an embodiment, the compound having a structure according to formula (I-A-3), (I-B-3) or (I-C-3) has a structure according to formula (I-A-3) or (I-B-3).

In an embodiment, the compound having a structure according to formula (I-A-3), (I-B-3) or (I-C-3) has a structure according to formula (I-A-3).

In an embodiment, the compound having a structure according to formula (I-A-3), (I-B-3) or (I-C-3) has a structure according to formula (I-B-3).

In an embodiment, the compound having a structure according to formula (I-A-3), (I-B-3) or (I-C-3) has a structure according to formula (I-C-3).

In an embodiment, the compound has a structure according to formula (I-A-3), (I-B-3) or (I-C-3), wherein

M is selected from titanium, zirconium and hafnium;
each X is independently selected from halo, hydrogen, (1-6C)alkoxy, and aryloxy, any of which may be optionally substituted one of more groups selected from halo, oxo, hydroxy, amino, nitro, (1-6C)alkyl, (1-6C)haloalkyl, (1-6C)alkoxy and aryl;
R₂ is absent or is selected from hydrogen, (1-4C)alkyl and phenyl;
R₇ is selected from (1-4C)alkyl, (2-4C)alkenyl, (2-4C)alkynyl, (1-4C)haloalkyl, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound has a structure according to formula (I-A-3), (I-B-3) or (I-C-3), wherein

M is selected from titanium and zirconium;
each X is independently selected from halo, hydrogen, and (1-4C)alkoxy, any of which may be optionally substituted one of more groups selected from halo, hydroxy, amino, (1-4C)alkyl and (1-4C)alkoxy;
R₂ is absent or is selected from hydrogen, (1-4C)alkyl and phenyl;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-3), (I-B-3) or (I-C-3), wherein

M is selected from titanium and zirconium;
each X is independently selected from chloro, bromo and (1-4C)alkoxy;
R₂ is absent or hydrogen;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-3), (I-B-3) or (I-C-3), wherein

M is selected from titanium and zirconium;
each X is independently selected from chloro, bromo and (1-4C)alkoxy;
R₂ is absent;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-3), (I-B-3) or (I-C-3), wherein

M is titanium;
each X is independently (1-4C)alkoxy;
R₂ is absent or hydrogen;

### R₇ is (1-2C)alkyl;

R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound has a structure according to formula (I-A-3), (I-B-3) or (I-C-3), wherein

M is titanium;
each X is independently (1-4C)alkoxy;
R₂ is absent;

### R₇ is (1-2C)alkyl;

R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound has a structure according to formula (I-A) or (I-B), wherein

M is selected from titanium, zirconium and hafnium;
each X is independently selected from halo, hydrogen, (1-6C)alkoxy, and aryloxy, any of which may be optionally substituted one of more groups selected from halo, oxo, hydroxy, amino, nitro, (1-6C)alkyl, (1-6C)haloalkyl, (1-6C)alkoxy and aryl;
R₂ is absent or is selected from hydrogen, (1-4C)alkyl and phenyl;
R₃, R₄, R₅ and R₆ are each independently selected from hydrogen, halo, oxo, hydroxy, amino, nitro, (1-4C)alkyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₇ is selected from (1-4C)alkyl, (2-4C)alkenyl, (2-4C)alkynyl, (1-4C)haloalkyl, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound has a structure according to formula (I-A) or (I-B), wherein

M is selected from titanium and zirconium;
each X is independently selected from halo, hydrogen, and (1-4C)alkoxy, any of which may be optionally substituted one of more groups selected from halo, hydroxy, amino, (1-4C)alkyl and (1-4C)alkoxy;
R₂ is absent or is selected from hydrogen, (1-4C)alkyl and phenyl;
R₃, R₄, R₅ and R₆ are each independently selected from hydrogen, halo, amino, (1-4C)alkyl, (1-4C)haloalkyl, (1-4C)alkoxy and phenyl, any of which may be optionally substituted with one or more substituents selected from halo and (1-4C)alkyl;
R₇ is selected from (1-4C)alkyl and aryl, any of which may be optionally substituted with one or more substituents selected from halo, hydroxy, amino, (1-4C)alkyl and (1-4C)alkoxy;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A) or (I-B), wherein

M is selected from titanium and zirconium;
each X is independently selected from chloro, bromo and (1-4C)alkoxy;
R₂ is absent or is selected from hydrogen and (1-4C)alkyl;
R₃, R₄, R₅ and R₆ are each independently selected from hydrogen, halo, amino, (1-4C)alkyl and phenyl, any of which may be optionally substituted with one or more substituents selected from halo and (1-4C)alkyl;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-3C)alkoxy, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A) or (I-B), wherein

M is titanium;
each X is independently (1-4C)alkoxy;
R₂ is absent;
R₃, R₄, R₅ and R₆ are each independently selected from hydrogen, (1-4C)alkyl and phenyl;

### R₇ is (1-2C)alkyl;

R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound has a structure according to formula (I-A) or (I-B), wherein

M is selected from titanium, zirconium and hafnium;
each X is independently selected from halo, hydrogen, (1-6C)alkoxy, (1-4C)dialkylamino and aryloxy, any of which may be optionally substituted one of more groups selected from halo, oxo, hydroxy, amino, nitro, (1-6C)alkyl, (1-6C)haloalkyl, (1-6C)alkoxy and aryl;
R₂ is absent or is selected from hydrogen, (1-4C)alkyl and phenyl;
R₃, R₄, R₅ and R₆ are each independently selected from hydrogen, halo, oxo, hydroxy, amino, nitro, (1-4C)alkyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₇ is selected from (1-4C)alkyl, (2-4C)alkenyl, (2-4C)alkynyl, (1-4C)haloalkyl, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound has a structure according to formula (I-A) or (I-B), wherein

M is selected from titanium and zirconium;
each X is independently selected from halo, hydrogen, (1-4C)dialkylamino and (1-4C)alkoxy, any of which may be optionally substituted one of more groups selected from halo, hydroxy, amino, (1-4C)alkyl and (1-4C)alkoxy;
R₂ is absent or is selected from hydrogen, (1-4C)alkyl and phenyl;
R₃, R₄, R₅ and R₆ are each independently selected from hydrogen, halo, amino, (1-4C)alkyl, (1-4C)haloalkyl, (1-4C)alkoxy and phenyl, any of which may be optionally substituted with one or more substituents selected from halo and (1-4C)alkyl;
R₇ is selected from (1-4C)alkyl and aryl, any of which may be optionally substituted with one or more substituents selected from halo, hydroxy, amino, (1-4C)alkyl and (1-4C)alkoxy;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A) or (I-B), wherein

M is selected from titanium and zirconium;
each X is independently selected from chloro, bromo, (1-2C)dialkylamino and (1-4C)alkoxy;
R₂ is absent or is selected from hydrogen and (1-4C)alkyl;
R₃, R₄, R₅ and R₆ are each independently selected from hydrogen, halo, amino, (1-4C)alkyl and phenyl, any of which may be optionally substituted with one or more substituents selected from halo and (1-4C)alkyl;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-3C)alkoxy, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A) or (I-B), wherein

M is titanium;
each X is independently (1-2C)dialkylamino or (1-4C)alkoxy;
R₂ is absent;
R₃, R₄, R₅ and R₆ are each independently selected from hydrogen, (1-4C)alkyl and phenyl;

### R₇ is (1-2C)alkyl;

R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound has a structure according to formula (I-A-1) or (I-B-1), wherein

M is selected from titanium, zirconium and hafnium;
each X is independently selected from halo, hydrogen, (1-6C)alkoxy, and aryloxy, any of which may be optionally substituted one of more groups selected from halo, oxo, hydroxy, amino, nitro, (1-6C)alkyl, (1-6C)haloalkyl, (1-6C)alkoxy and aryl;
R₃, R₄, R₅ and R₆ are each independently selected from hydrogen, halo, oxo, hydroxy, amino, nitro, (1-4C)alkyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₇ is selected from (1-4C)alkyl, (2-4C)alkenyl, (2-4C)alkynyl, (1-4C)haloalkyl, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound has a structure according to formula (I-A-1) or (I-B-1), wherein

M is selected from titanium and zirconium;
each X is independently selected from halo, hydrogen, and (1-4C)alkoxy, any of which may be optionally substituted one of more groups selected from halo, hydroxy, amino, (1-4C)alkyl and (1-4C)alkoxy;
R₃, R₄, R₅ and R₆ are each independently selected from hydrogen, halo, amino, (1-4C)alkyl, (1-4C)haloalkyl, (1-4C)alkoxy and phenyl, any of which may be optionally substituted with one or more substituents selected from halo and (1-4C)alkyl;
R₇ is selected from (1-4C)alkyl and aryl, any of which may be optionally substituted with one or more substituents selected from halo, hydroxy, amino, (1-4C)alkyl and (1-4C)alkoxy;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-1) or (I-B-1), wherein

M is selected from titanium and zirconium;
each X is independently selected from chloro, bromo and (1-4C)alkoxy;
R₃, R₄, R₅ and R₆ are each independently selected from hydrogen, halo, amino, (1-4C)alkyl and phenyl, any of which may be optionally substituted with one or more substituents selected from halo and (1-4C)alkyl;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-3C)alkoxy, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-1) or (I-B-1), wherein

M is titanium;
each X is independently (1-4C)alkoxy;
R₃, R₄, R₅ and R₆ are each independently selected from hydrogen, (1-4C)alkyl and phenyl;

### R₇ is (1-2C)alkyl;

R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound has a structure according to formula (I-A-1) or (I-B-1), wherein

M is selected from titanium, zirconium and hafnium;
each X is independently selected from halo, hydrogen, (1-6C)alkoxy, (1-4C)dialkylamino and aryloxy, any of which may be optionally substituted one of more groups selected from halo, oxo, hydroxy, amino, nitro, (1-6C)alkyl, (1-6C)haloalkyl, (1-6C)alkoxy and aryl;
R₃, R₄, R₅ and R₆ are each independently selected from hydrogen, halo, oxo, hydroxy, amino, nitro, (1-4C)alkyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₇ is selected from (1-4C)alkyl, (2-4C)alkenyl, (2-4C)alkynyl, (1-4C)haloalkyl, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound has a structure according to formula (I-A-1) or (I-B-1), wherein

M is selected from titanium and zirconium;
each X is independently selected from halo, hydrogen, (1-4C)dialkylamino and (1-4C)alkoxy, any of which may be optionally substituted one of more groups selected from halo, hydroxy, amino, (1-4C)alkyl and (1-4C)alkoxy;
R₃, R₄, R₅ and R₆ are each independently selected from hydrogen, halo, amino, (1-4C)alkyl, (1-4C)haloalkyl, (1-4C)alkoxy and phenyl, any of which may be optionally substituted with one or more substituents selected from halo and (1-4C)alkyl;
R₇ is selected from (1-4C)alkyl and aryl, any of which may be optionally substituted with one or more substituents selected from halo, hydroxy, amino, (1-4C)alkyl and (1-4C)alkoxy;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-1) or (I-B-1), wherein

M is selected from titanium and zirconium;
each X is independently selected from chloro, bromo, (1-2C)dialkylamino and (1-4C)alkoxy;
R₃, R₄, R₅ and R₆ are each independently selected from hydrogen, halo, amino, (1-4C)alkyl and phenyl, any of which may be optionally substituted with one or more substituents selected from halo and (1-4C)alkyl;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-3C)alkoxy, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-1) or (I-B-1), wherein

M is titanium;
each X is independently (1-2C)dialkylamino or (1-4C)alkoxy;
R₃, R₄, R₅ and R₆ are each independently selected from hydrogen, (1-4C)alkyl and phenyl;

### R₇ is (1-2C)alkyl;

R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound has a structure according to formula (I-A-2) or (I-B-2), wherein

M is selected from titanium, zirconium and hafnium;
each X is independently selected from halo, hydrogen, (1-6C)alkoxy, and aryloxy, any of which may be optionally substituted one of more groups selected from halo, oxo, hydroxy, amino, nitro, (1-6C)alkyl, (1-6C)haloalkyl, (1-6C)alkoxy and aryl;
R₂ is absent or is selected from hydrogen, (1-4C)alkyl and phenyl;
R₃, R₄, R₅ and R₆ are each independently selected from hydrogen, halo, oxo, hydroxy, amino, nitro, (1-4C)alkyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound has a structure according to formula (I-A-2) or (I-B-2), wherein

M is selected from titanium and zirconium;
each X is independently selected from halo, hydrogen, and (1-4C)alkoxy, any of which may be optionally substituted one of more groups selected from halo, hydroxy, amino, (1-4C)alkyl and (1-4C)alkoxy;
R₂ is absent or is selected from hydrogen, (1-4C)alkyl and phenyl;
R₃, R₄, R₅ and R₆ are each independently selected from hydrogen, halo, amino, (1-4C)alkyl, (1-4C)haloalkyl, (1-4C)alkoxy and phenyl, any of which may be optionally substituted with one or more substituents selected from halo and (1-4C)alkyl;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-2) or (I-B-2), wherein

M is selected from titanium and zirconium;
each X is independently selected from chloro, bromo and (1-4C)alkoxy;
R₂ is absent;
R₃, R₄, R₅ and R₆ are each independently selected from hydrogen, halo, amino, (1-4C)alkyl and phenyl, any of which may be optionally substituted with one or more substituents selected from halo and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-3C)alkoxy, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-2) or (I-B-2), wherein

M is titanium;
each X is independently (1-4C)alkoxy;
R₂ is absent;
R₃, R₄, R₅ and R₆ are each independently selected from hydrogen, (1-4C)alkyl and phenyl;
R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound has a structure according to formula (I-A-2) or (I-B-2), wherein

M is selected from titanium, zirconium and hafnium;
each X is independently selected from halo, hydrogen, (1-6C)alkoxy, (1-4C)dialkylamino and aryloxy, any of which may be optionally substituted one of more groups selected from halo, oxo, hydroxy, amino, nitro, (1-6C)alkyl, (1-6C)haloalkyl, (1-6C)alkoxy and aryl;
R₂ is absent or is selected from hydrogen, (1-4C)alkyl and phenyl;
R₃, R₄, R₅ and R₆ are each independently selected from hydrogen, halo, oxo, hydroxy, amino, nitro, (1-4C)alkyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound has a structure according to formula (I-A-2) or (I-B-2), wherein

M is selected from titanium and zirconium;
each X is independently selected from halo, hydrogen, (1-4C)dialkylamino and (1-4C)alkoxy, any of which may be optionally substituted one of more groups selected from halo, hydroxy, amino, (1-4C)alkyl and (1-4C)alkoxy;
R₂ is absent or is selected from hydrogen, (1-4C)alkyl and phenyl;
R₃, R₄, R₅ and R₆ are each independently selected from hydrogen, halo, amino, (1-4C)alkyl, (1-4C)haloalkyl, (1-4C)alkoxy and phenyl, any of which may be optionally substituted with one or more substituents selected from halo and (1-4C)alkyl;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-2) or (I-B-2), wherein

M is selected from titanium and zirconium;
each X is independently selected from chloro, bromo, (1-2C)dialkylamino and (1-4C)alkoxy;
R₂ is absent;
R₃, R₄, R₅ and R₆ are each independently selected from hydrogen, halo, amino, (1-4C)alkyl and phenyl, any of which may be optionally substituted with one or more substituents selected from halo and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-3C)alkoxy, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-2) or (I-B-2), wherein

M is titanium;
each X is independently (1-2C)dialkylamino or (1-4C)alkoxy;
R₂ is absent;
R₃, R₄, R₅ and R₆ are each independently selected from hydrogen, (1-4C)alkyl and phenyl;
R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound has a structure according to formula (I-A-3) or (I-B-3), wherein

M is selected from titanium, zirconium and hafnium;
each X is independently selected from halo, hydrogen, (1-6C)alkoxy, and aryloxy, any of which may be optionally substituted one of more groups selected from halo, oxo, hydroxy, amino, nitro, (1-6C)alkyl, (1-6C)haloalkyl, (1-6C)alkoxy and aryl;
R₂ is absent or is selected from hydrogen, (1-4C)alkyl and phenyl;
R₇ is selected from (1-4C)alkyl, (2-4C)alkenyl, (2-4C)alkynyl, (1-4C)haloalkyl, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound has a structure according to formula (I-A-3) or (I-B-3), wherein

M is selected from titanium and zirconium;
each X is independently selected from halo, hydrogen, and (1-4C)alkoxy, any of which may be optionally substituted one of more groups selected from halo, hydroxy, amino, (1-4C)alkyl and (1-4C)alkoxy;
R₂ is absent or is selected from hydrogen, (1-4C)alkyl and phenyl;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-3) or (I-B-3), wherein

M is selected from titanium and zirconium;
each X is independently selected from chloro, bromo and (1-4C)alkoxy;
R₂ is absent;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-3C)alkoxy, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-3) or (I-B-3), wherein

M is titanium;
each X is independently (1-4C)alkoxy;
R₂ is absent;

### R₇ is (1-2C)alkyl;

R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound has a structure according to formula (I-A-3) or (I-B-3), wherein

M is selected from titanium, zirconium and hafnium;
each X is independently selected from halo, hydrogen, (1-6C)alkoxy, (1-4C)dialkylamino and aryloxy, any of which may be optionally substituted one of more groups selected from halo, oxo, hydroxy, amino, nitro, (1-6C)alkyl, (1-6C)haloalkyl, (1-6C)alkoxy and aryl;
R₂ is absent or is selected from hydrogen, (1-4C)alkyl and phenyl;
R₇ is selected from (1-4C)alkyl, (2-4C)alkenyl, (2-4C)alkynyl, (1-4C)haloalkyl, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound has a structure according to formula (I-A-3) or (I-B-3), wherein

M is selected from titanium and zirconium;
each X is independently selected from halo, hydrogen, (1-4C)dialkylamino and (1-4C)alkoxy, any of which may be optionally substituted one of more groups selected from halo, hydroxy, amino, (1-4C)alkyl and (1-4C)alkoxy;
R₂ is absent or is selected from hydrogen, (1-4C)alkyl and phenyl;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-3) or (I-B-3), wherein

M is selected from titanium and zirconium;
each X is independently selected from chloro, bromo, (1-2C)dialkylamino and (1-4C)alkoxy;
R₂ is absent;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-3C)alkoxy, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-3) or (I-B-3), wherein

M is titanium;
each X is independently (1-2C)dialkylamino or (1-4C)alkoxy;
R₂ is absent;

### R₇ is (1-2C)alkyl;

R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound has a structure according to formula (I-A-4a), (I-B-4a) or (I-C-4a) shown below:

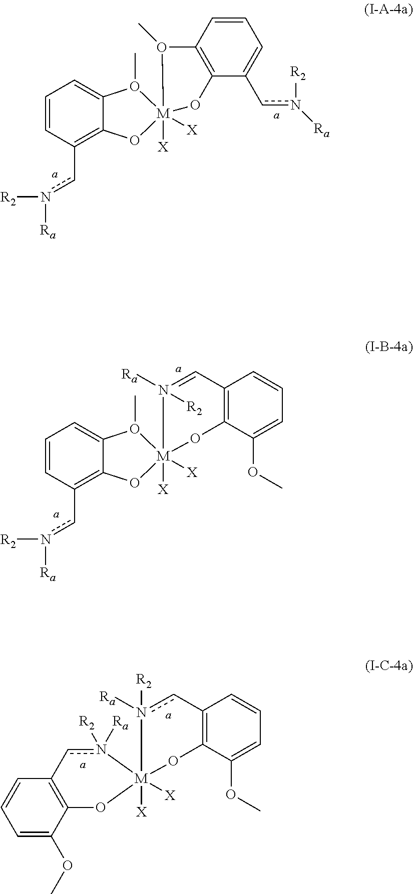

wherein
M is titanium or zirconium,
each X is independently isopropoxide, ethoxide, N(CH₃)₂ or N(CH₂CH₃)₂;
R₂ is absent (in which case bond a is a double bond) or hydrogen (in which case bond a is a single bond); and
Rₐ is selected from perfluorophenyl, cyclohexyl, 2,6-dimethylphenyl, 2,6-diisopropylphenyl, biphenyl, adamantyl, 2,4,6-tritertbutylphenyl and trityl.

In an embodiment, the compound has a structure according to formula (I-A-4a), (I-B-4a) or (I-C-4a), wherein R₂ is absent.

In an embodiment, the compound has a structure according to formula (I-A-4a), (I-B-4a) or (I-C-4a), wherein M is titanium and Rₐ is selected from 2,6-diisopropylphenyl, biphenyl, adamantyl, 2,4,6-tritertbutylphenyl and trityl.

In an embodiment, the compound has a structure according to formula (I-A-4a), (I-B-4a) or (I-C-4a), wherein M is titanium and Rₐ is selected from adamantyl, 2,4,6-tritertbutylphenyl and trityl.

In an embodiment, the compound has a structure according to formula (I-A-4b), (I-B-4b) or (I-C-4b) shown below:

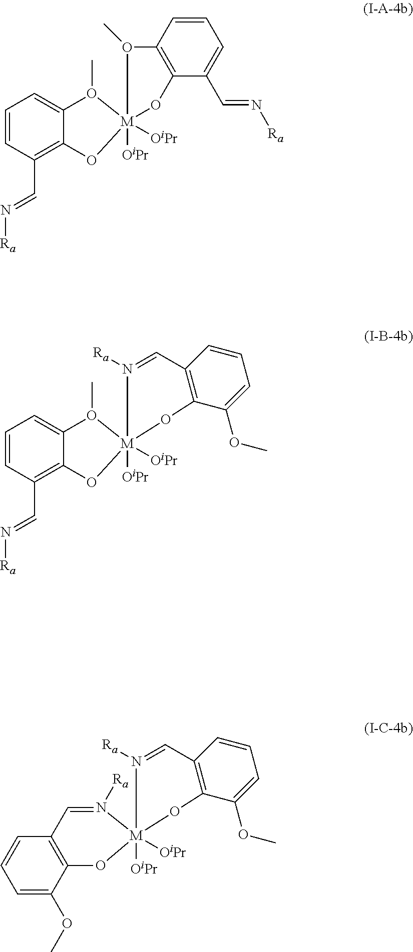

wherein M is titanium or zirconium, and Rₐ is selected from perfluorophenyl, cyclohexyl, 2,6-dimethylphenyl, 2,6-diisopropylphenyl, biphenyl, adamantyl, 2,4,6-tritertbutylphenyl and trityl.

In an embodiment, the compound has a structure according to formula (I-A-4b), (I-B-4b) or (I-C-4b), wherein M is titanium and Rₐ is selected from 2,6-diisopropylphenyl, biphenyl, adamantyl, 2,4,6-tritertbutylphenyl and trityl.

In an embodiment, the compound has a structure according to formula (I-A-4b), (I-B-4b) or (I-C-4b), wherein M is titanium and Rₐ is selected from adamantyl, 2,4,6-tritertbutylphenyl and trityl.

In an embodiment, the compound has a structure according to formula (I-A-4c), (I-B-4c) or (I-C-4c) shown below:

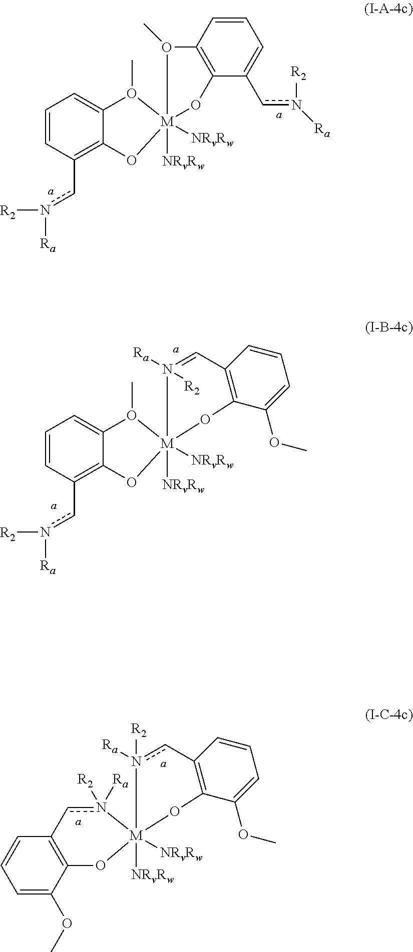

wherein
M is titanium or zirconium,
Rᵥ and R_{w} are each independently methyl or ethyl;
R₂ is absent (in which case bond a is a double bond) or hydrogen (in which case bond a is a single bond); and
Rₐ is selected from perfluorophenyl, cyclohexyl, 2,6-dimethylphenyl, 2,6-diisopropylphenyl, biphenyl, adamantyl, 2,4,6-tritertbutylphenyl and trityl.

In an embodiment, the compound has a structure according to formula (I-A-4c), (I-B-4c) or (I-C-4c), wherein R₂ is absent.

In an embodiment, the compound has a structure according to formula (I-A-4c), (I-B-4c) or (I-C-4c), wherein M is titanium and Rₐ is selected from 2,6-diisopropylphenyl, biphenyl, adamantyl, 2,4,6-tritertbutylphenyl and trityl.

In an embodiment, the compound has a structure according to formula (I-A-4c), (I-B-4c) or (I-C-4c), wherein M is titanium and Rₐ is selected from adamantyl, 2,4,6-tritertbutylphenyl and trityl.

In an embodiment, the compound is immobilised on a supporting substrate. Suitably, the supporting substrate is a solid. It will be appreciated that the compound may be immobilised on the supporting substrate by one or more covalent or ionic interactions, either directly, or via a suitable linking moiety. It will be appreciated that minor structural modifications resulting from the immobilisation of the compound of the supporting substrate (e.g. loss of one or both groups, X) are nonetheless within the scope of the invention. Suitably, the supporting substrate is selected from silica, alumina, zeolite and layered double hydroxide. Most suitably, the supporting substrate is silica.

### Preparation of the Compounds

The compounds of the present invention may be formed by any suitable process known in the art. Particular examples of processes for the preparation of compounds of the present invention are set out in the accompanying examples.

Generally, the processes of preparing a compound of the present invention as defined herein comprises:
(i) Reacting two equivalents of compound of formula A shown below:

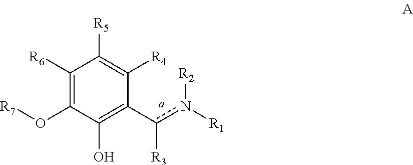

wherein R₁-R₇ and bond a have any of the definitions appearing hereinbefore, with one equivalent of a compound of formula B shown below:

M(X)₄ B
wherein M and X have any of the definitions appearing hereinbefore
in the presence of a suitable solvent.

Any suitable solvent may be used for step (i) of the process defined above. A particularly suitable solvent is dry toluene.

It will be appreciated that the compound of formula B may be used in a solvated form (e.g. M(X)₄.(THF)₂).

It will be appreciated that for certain identities of X, it may be necessary to treat the compound of formula A with a strong, non-nucleophilic base (such as potassium bis(trimethylsilyl)amide) prior to reaction with the compound of formula B. For example, when X is chloro, the compound of formula A may be treated with potassium bis(trimethylsilyl)amide prior to reaction with MCl₄.(THF)₂.

Step (i) is suitably conducted at low temperature (e.g. <0° C.). More suitably, step (i) is conducted at a temperature of −80 to 0° C. Other reaction conditions (e.g. pressures, reaction times, agitation, etc.) could be readily selected by one of ordinary skill in the art.

Compounds of formula A may be generally prepared by a process comprising the step of:
(i) Reacting, in a suitable solvent (such as acidic ethanol), a compound of formula C shown below:

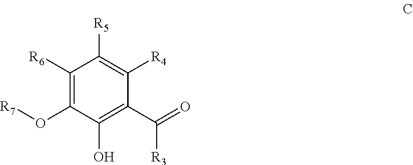

wherein R₃-R₇ have any of the definitions appearing hereinbefore, with a compound of formula D shown below:

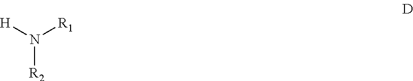

wherein R₁ and R₂ have any of the definitions appearing hereinbefore.

Step (i) is suitably conducted under refluxing conditions. Other reaction conditions (e.g. pressures, reaction times, agitation, etc.) could be readily selected by one of ordinary skill in the art.

### Polymerisation of Cyclic Esters and Cyclic Amides

According to a second aspect of the present invention there is provided a process for the ring opening polymerisation (ROP) of a cyclic ester or a cyclic amide, the process comprising the step of:
a) contacting a compound according to the first aspect of the invention with one or more cyclic esters or cyclic amides.

As discussed hereinbefore, the new family of Group IV transition metal-based catalysts are capable of catalysing the ROP of cyclic esters and cyclic amides to yield polymers of high molecular weight and narrow PDI. The new family of catalysts are surprisingly active not only in catalysing the ROP of lactones such as caprolactone, but also macrolactones (e.g. w-pentadecalactone, PDL), where the reduced amount of ring strain would typically compromise efficient polymerisation.

In an embodiment, the one or more cyclic esters or cyclic amides has a structure according to formula (III) shown below:

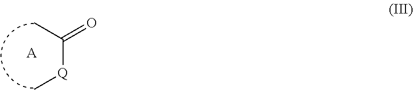

wherein
Q is selected from O or NR_{y}, wherein R_{y} is selected from hydrogen, (1-6C)alkyl, (2-6C)alkenyl and (2-6C)alkynyl; and
ring A is a 4-23 membered heterocycle containing 1 to 4 O or N ring heteroatoms in total, wherein the heterocycle is optionally substituted with one or more substituents selected from oxo, (1-6C)alkyl, (2-6C)alkenyl, (2-6C)alkynyl, (1-6C)alkoxy, aryl and heteroaryl.

It will be understood that the one or more cyclic esters and cyclic amides may be identical (e.g. all caprolactone) or different (e.g. a mixture of different cyclic esters and/or cyclic amides). Accordingly, the compounds of the invention may be used for the homopolymerisation or copolymerisation of cyclic esters and cyclic amides.

In an embodiment, Q is selected from O or NR_{y}, wherein R_{y} is selected from hydrogen, (1-3C)alkyl, (2-3C)alkenyl or (2-3C)alkynyl.

In an embodiment, Q is selected from O or NR_{y}, wherein R_{y} is selected from hydrogen and (1-3C)alkyl.

In an embodiment, Q is selected from O or NR_{y}, wherein R_{y} hydrogen.

In an embodiment, Q is O.

In an embodiment, ring A is a 6-23 membered heterocycle containing 1 to 3 O or N ring heteroatoms in total, wherein the heterocycle is optionally substituted with one or more substituents selected from oxo, (1-6C)alkyl, (1-6C)alkoxy and aryl.

In an embodiment, ring A is a 6-18 membered heterocycle containing 1 to 3 O or N ring heteroatoms in total, wherein the heterocycle is optionally substituted with one or more substituents selected from oxo, (1-6C)alkyl, (1-6C)alkoxy and aryl.

In an embodiment, ring A is a 6-16 membered heterocycle containing 1 to 2 O or N ring heteroatoms in total, wherein the heterocycle is optionally substituted with one or more substituents selected from oxo, (1-6C)alkyl, (1-6C)alkoxy and aryl.

In an embodiment, ring A is a 4-18 membered heterocycle containing 1 to 3 O or N ring heteroatoms in total, wherein the heterocycle is optionally substituted with one or more substituents selected from oxo, (1-6C)alkyl, (1-6C)alkoxy and aryl.

In an embodiment, ring A is a 4-16 membered heterocycle containing 1 to 2 O or N ring heteroatoms in total, wherein the heterocycle is optionally substituted with one or more substituents selected from oxo, (1-6C)alkyl, (1-6C)alkoxy and aryl.

In an embodiment, ring A is a 4, 6, 7 or 16 membered heterocycle containing 1 to 3 O or N ring heteroatoms in total, wherein the heterocycle is optionally substituted with one or more substituents selected from oxo, (1-6C)alkyl, (1-6C)alkoxy and aryl.

In an embodiment, ring A is a 4, 6, 7 or 16 membered heterocycle containing 1 to 2 O or N ring heteroatoms in total, wherein the heterocycle is optionally substituted with one or more substituents selected from oxo, (1-6C)alkyl, (1-6C)alkoxy and aryl.

In an embodiment, ring A does not contain any N heteroatoms.

In an embodiment, the one or more cyclic esters or cyclic amides is a lactone. Non-limiting examples of lactones include β-propiolactone, γ-butyrolactone, γ-valerolactone, ε-caprolactone and ω-pentadecalactone.

In an embodiment, the one or more cyclic esters or cyclic amides is a lactide. It will be appreciated by one of skill in the art that there are three stereoisomers of lactide, shown below, all of which are encompassed by the invention:

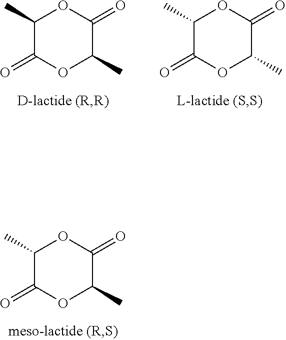

Suitably, the lactide is L-lactide.

In an embodiment, the one or more cyclic esters or cyclic amides is a lactam. Non-limiting examples of lactams include β-lactams (4 ring members), γ-lactams (5 ring members), δ-lactams (6 ring members) and ε-lactams (7 ring members).

In a particular embodiment, the one or more cyclic esters or cyclic amides is ε-caprolactone and rac-lactide, which are copolymerised during step a).

In an embodiment, in step a), the mole ratio of the compound of formula (I-A), (I-B) or (I-C) to the cyclic ester or cyclic amide is 1:50 to 1:10,000. Suitably, in step a), the mole ratio of the compound of formula (I-A), (I-B) or (I-C) to the cyclic ester or cyclic amide is 1:150 to 1:5000. More suitably, in step a), the mole ratio of the compound of formula (I-A), (I-B) or (I-C) to the cyclic ester or cyclic amide is 1:200 to 1:1000.

Step a) may be conducted in a solvent, or in the absence of a solvent (i.e. using neat reactants). When a solvent is used, any suitable solvent may be selected, including toluene, tetrahydrofuran and methylene chloride. Most suitably, step a) is conducted in the absence of a solvent.

Step a) may be conducted in the presence of a chain transfer agent suitable for use in the ring opening polymerisation of a cyclic ester or cyclic amide. In an embodiment, the chain transfer agent is a hydroxy-functional compound (e.g. an alcohol, diol or polyol). Suitably, the chain transfer agent is used in an excess with respect to the compound of formula (I-A), (I-B) or (I-C).

In an embodiment, step a) is conducted at a temperature of 15 to 150° C. Suitably, step a) is conducted at a temperature of 40 to 150° C. More suitably, step a) is conducted at a temperature of 50 to 120° C. Most suitably, step a) is conducted at a temperature of 60 to 120° C. (e.g. 80° C. or 100° C.).

Those of skill in the art, will be capable of selecting a suitable pressure at which to carry out step a). For example, step a) may be conducted at a pressure of 0.9 to 5 bar or 0.2 to 2 bar. Suitably, step a) is conducted at atmospheric pressure.

In an embodiment, step a) is conducted from a period of 1 minute to 96 hours. Suitably, step a) is conducted for a period of 5 minutes to 72 hours. Alternatively, step a) is conducted for a period of 15 minutes to 72 hours. Alternatively still, step a) is conducted for a period of 30 minutes to 72 hours.

According to a third aspect of the present invention, there is provided a use of a compound according to the first aspect of the invention in the ring opening polymerisation (ROP) of one or more cyclic esters or cyclic amides.

It will be appreciated that, in the context of the third aspect of the invention, the one or more cyclic esters or cyclic amides may have any of those definitions outlined in respect of the second aspect of the invention.

It will be appreciated that, in the context of the third aspect of the invention, the use of the compound according to the first aspect of the invention in the ring opening polymerisation (ROP) of one or more cyclic esters or cyclic amides may proceed according to any of those variables (quantities, temperatures, pressures, times, additives, etc) outlined in respect of the second aspect of the invention.

### EXAMPLES

One or more examples of the invention will now be described, for the purpose of illustration only, with reference to the accompanying figures, in which:

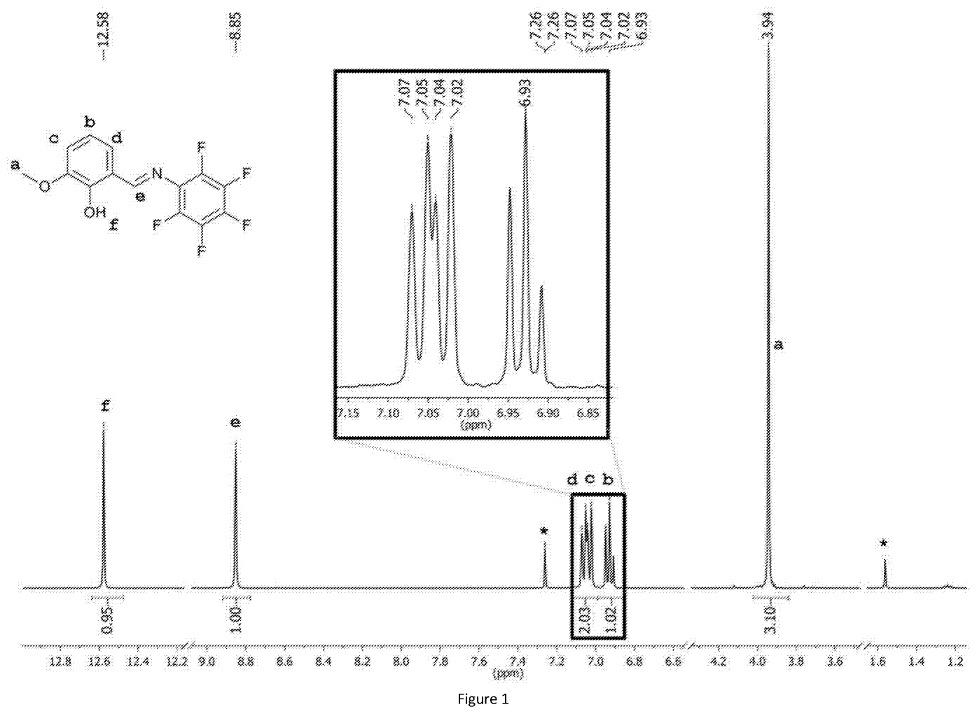

FIG. 1 shows the ¹H NMR spectrum of HL₁ in CDCl₃ at 400 MHz

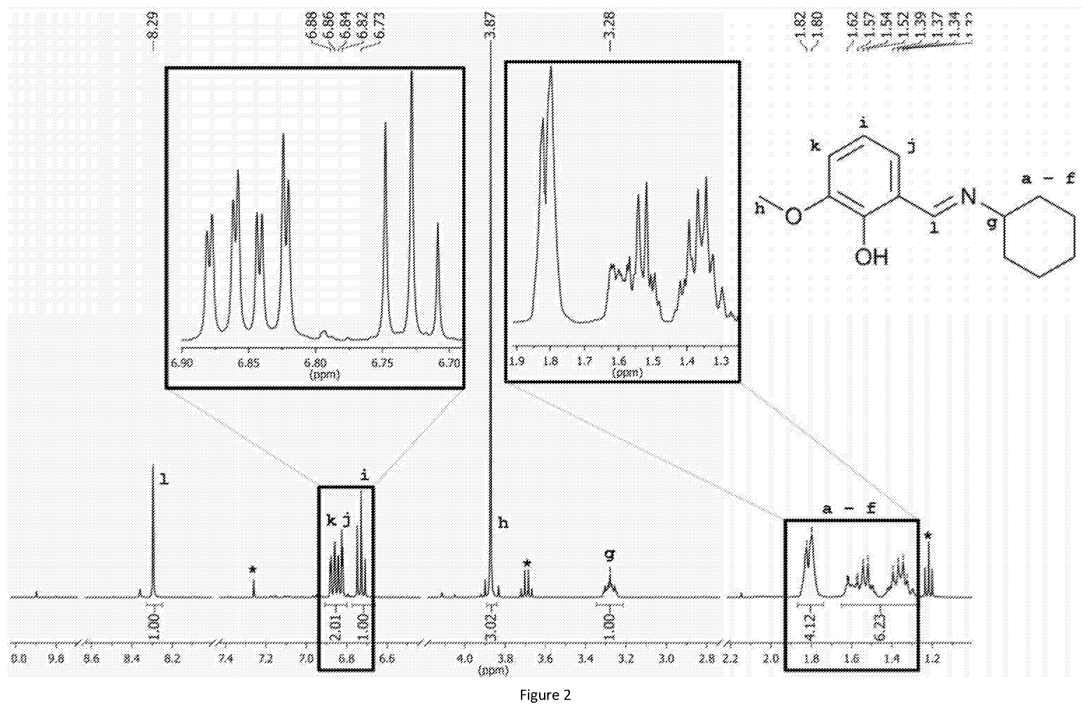

FIG. 2 shows the ¹H NMR spectrum of HL₂ in CDCl₃ at 400 MHz

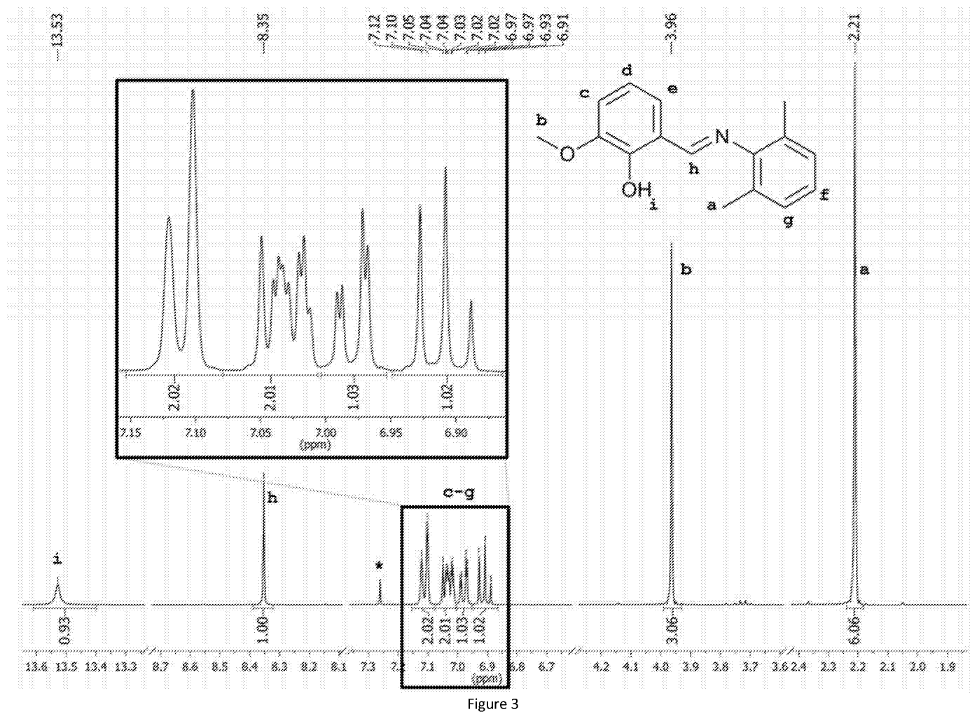

FIG. 3 shows the ¹H NMR spectrum of HL₃ in CDCl₃ at 400 MHz

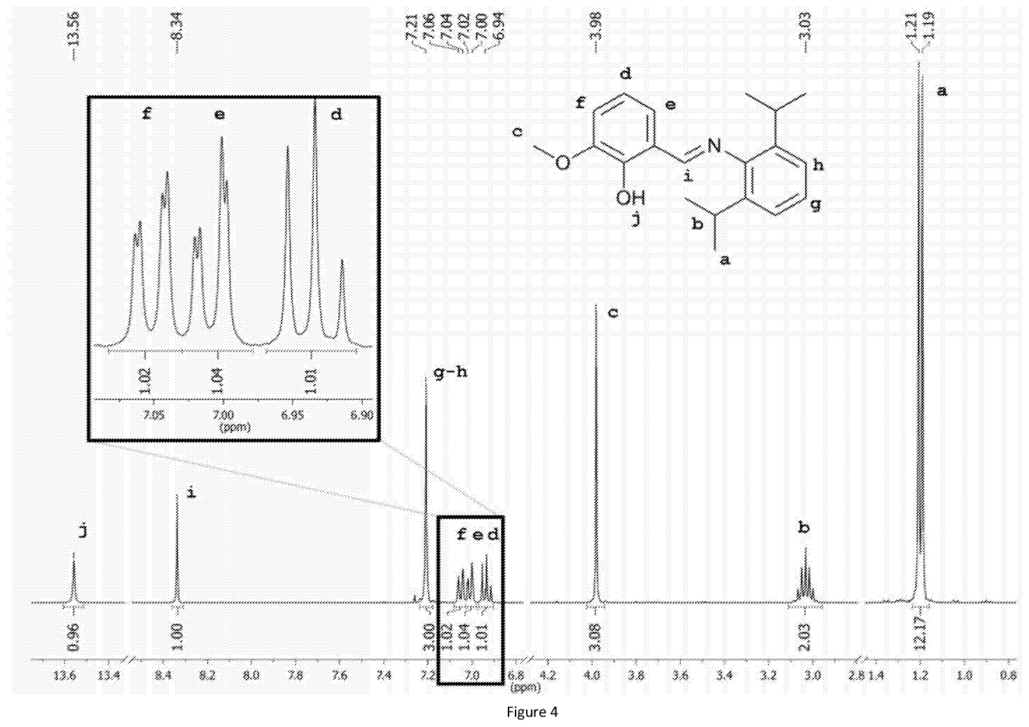

FIG. 4 shows the ¹H NMR spectrum of HL₄ in CDCl₃ at 400 MHz

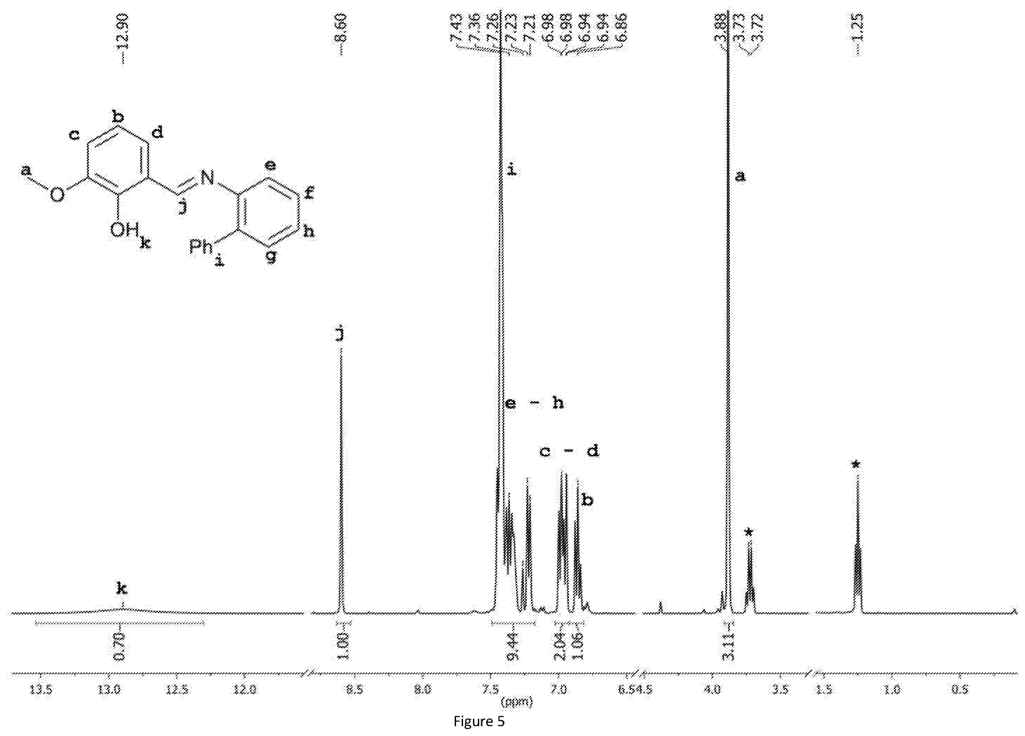

FIG. 5 shows the ¹H NMR spectrum of HL₅ in CDCl₃ at 400 MHz

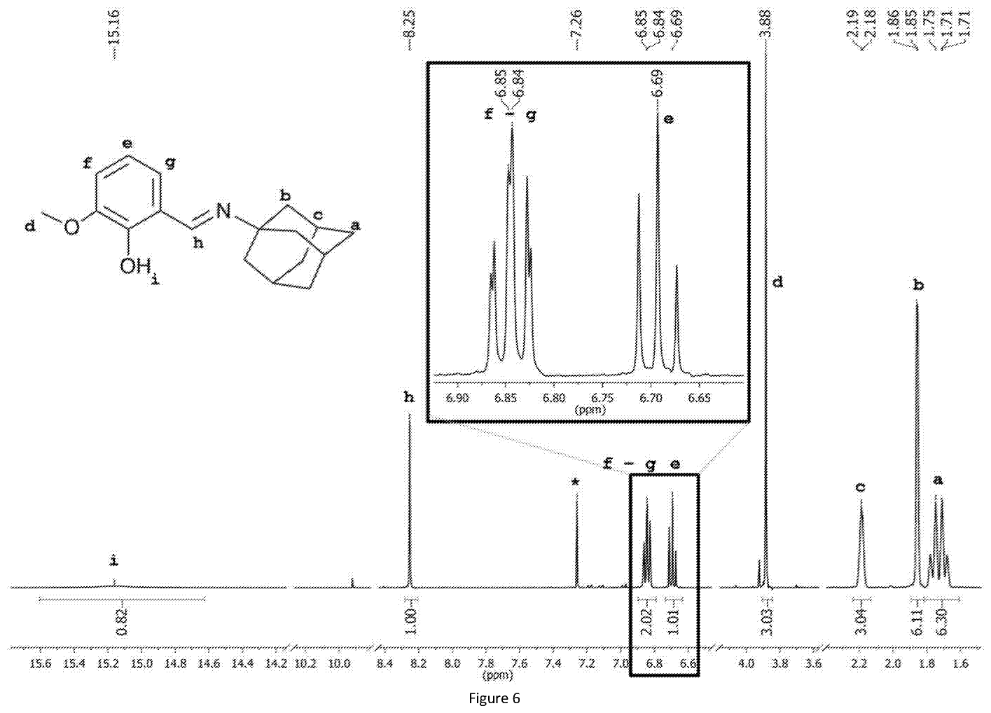

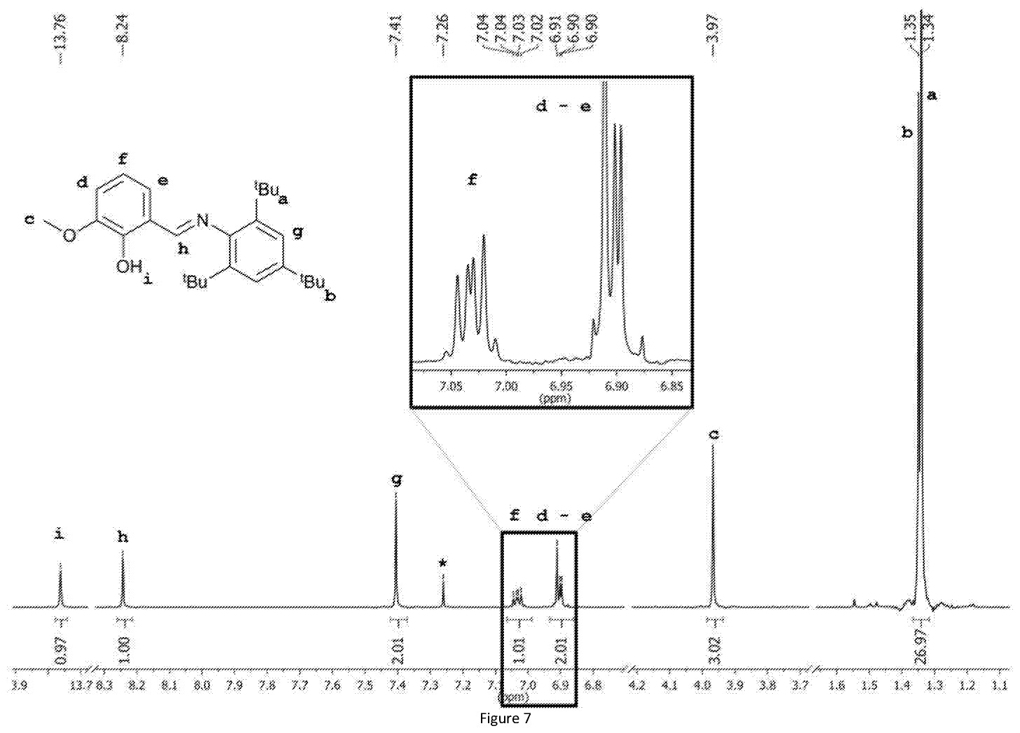

FIG. 6 shows the ¹H NMR spectrum of HL₆ in CDCl₃ at 400 MHz

FIG. 7 shows the ¹H NMR spectrum of HL₇ in CDCl₃ at 400 MHz

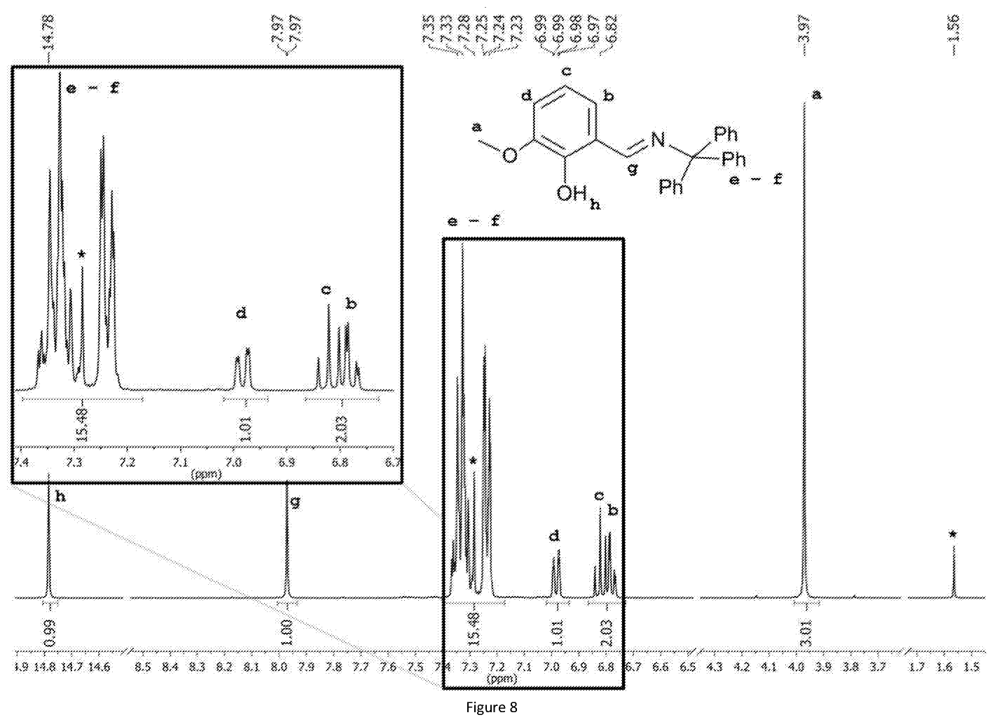

FIG. 8 shows the ¹H NMR spectrum of HL₈ in CDCl₃ at 400 MHz

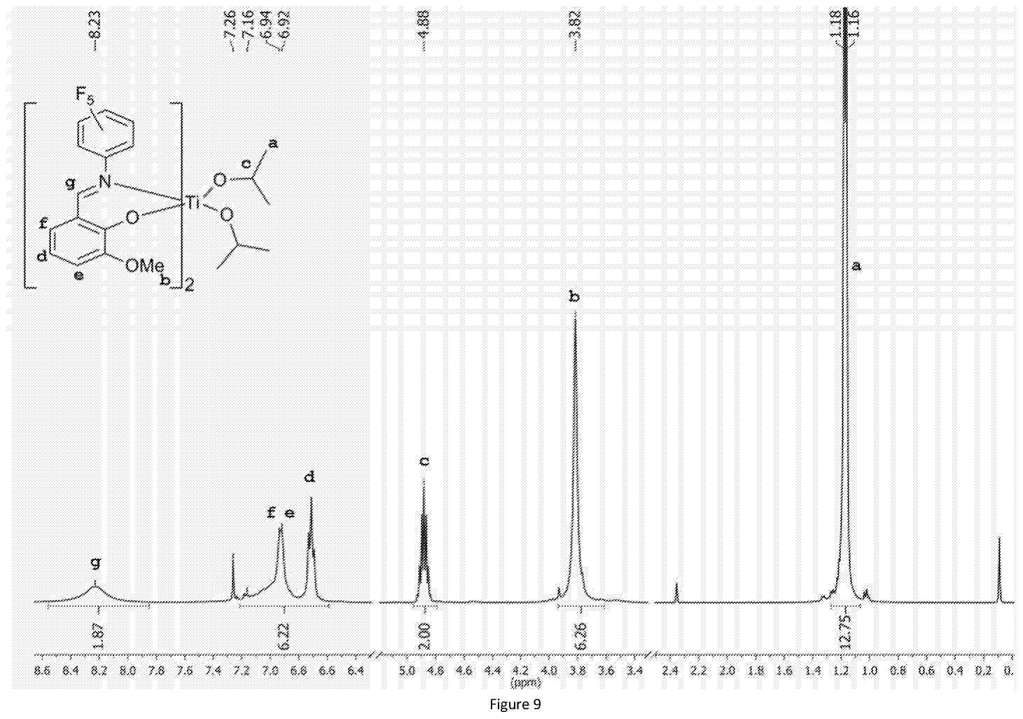

FIG. 9 shows the ¹H NMR spectrum of (L₁)₂Ti(OⁱPr)₂ in CDCl₃ at 400 MHz

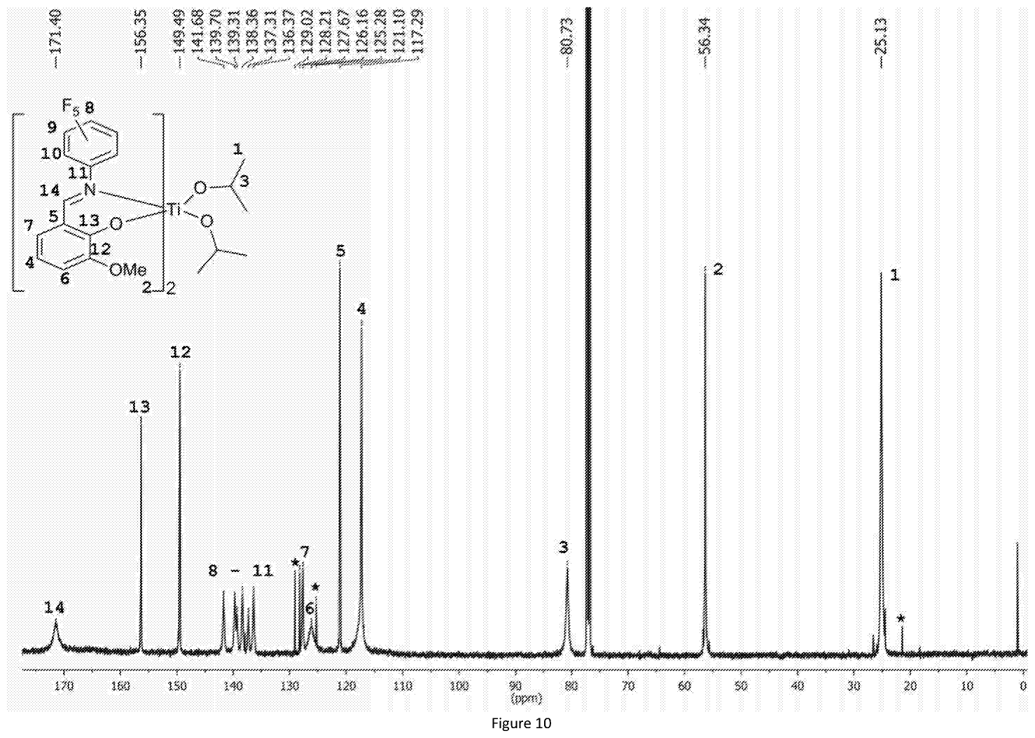

FIG. 10 shows the ¹³C{¹H} NMR spectrum of (L₁)₂Ti(OⁱPr)₂ in CDCl₃ at 125 MHz

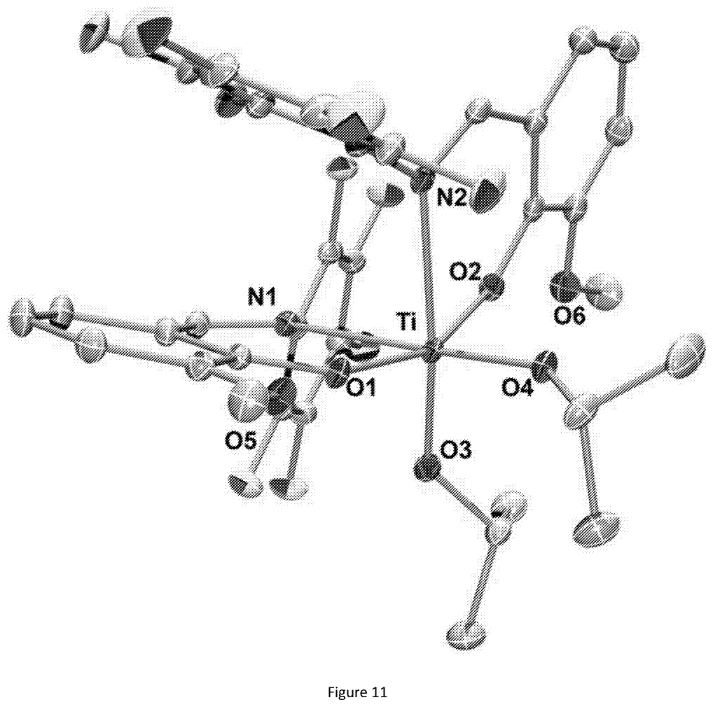

FIG. 11 shows the ORTEP representation of (L₁)₂Ti(OⁱPr)₂. Ellipsoids drawn at 50% probability, hydrogens and disorder omitted for clarity. Green=Titanium, Blue=Nitrogen, Scarlet=Oxygen, Gray=Carbon, Lime=Fluorine.

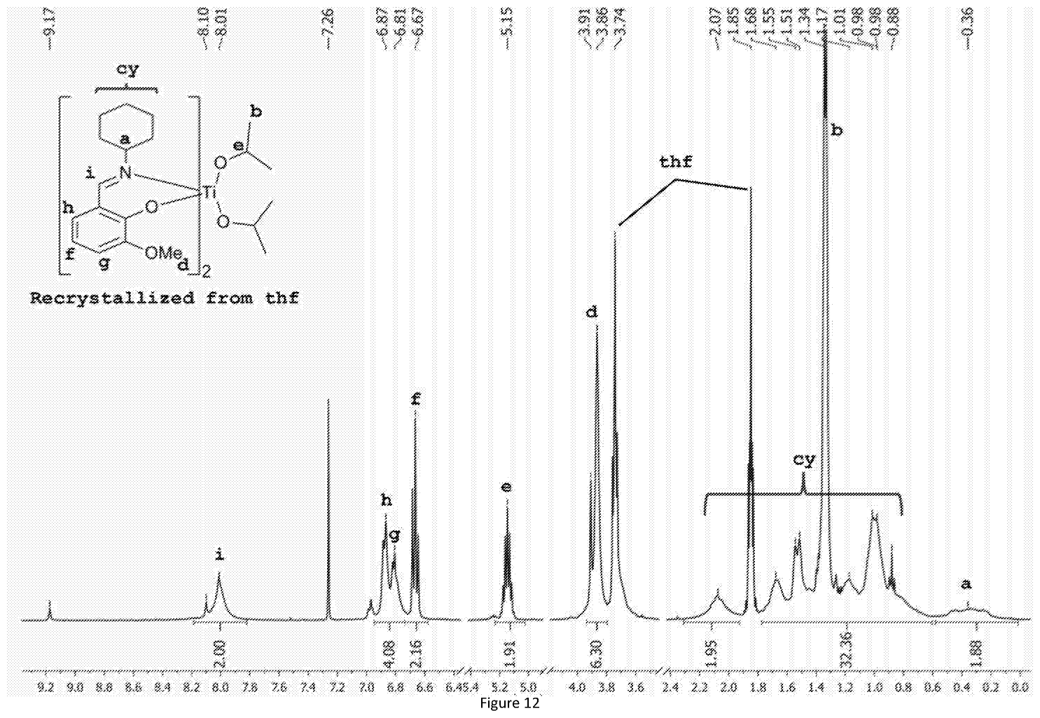

FIG. 12 shows the ¹H NMR spectrum of (L₂)₂Ti(OⁱPr)₂ in CDCl₃ at 400 MHz

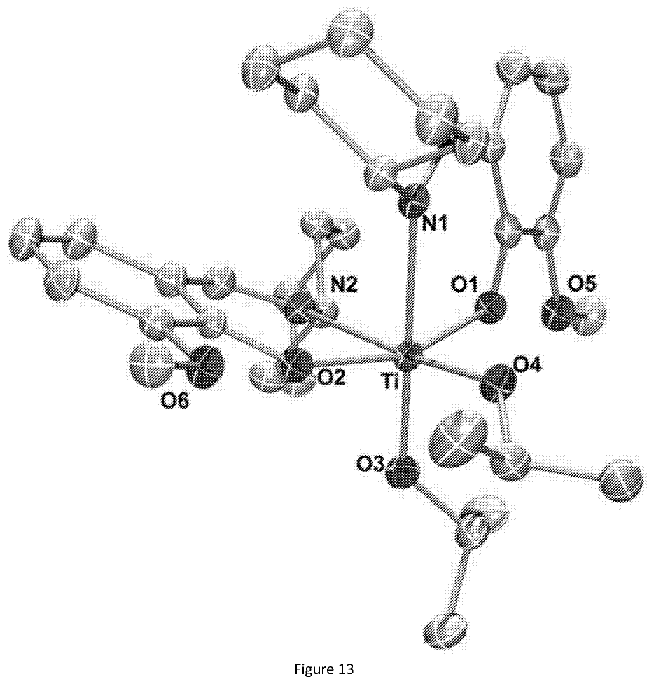

FIG. 13 shows the ORTEP representation of (L₂)₂Ti(OⁱPr)₂. Ellipsoids drawn at 50% probability, hydrogens and disorder omitted for clarity. Green=Titanium, Blue=Nitrogen, Scarlet=Oxygen, Gray=Carbon.

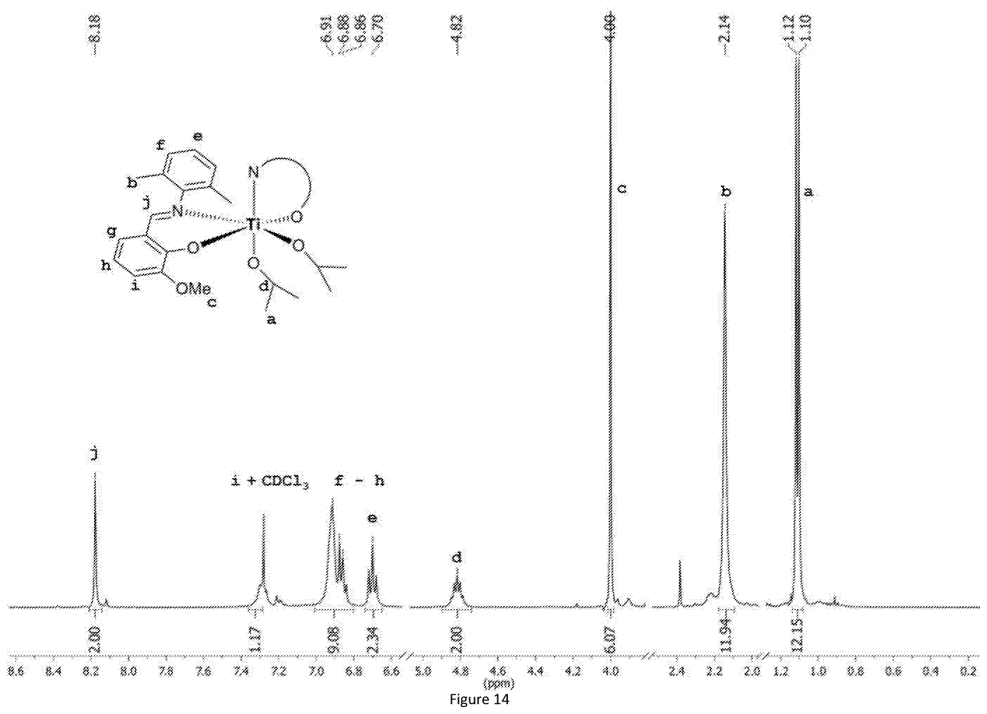

FIG. 14 shows the ¹H NMR spectrum of (L₃)₂Ti(OⁱPr)₂ in CDCl₃ at 400 MHz

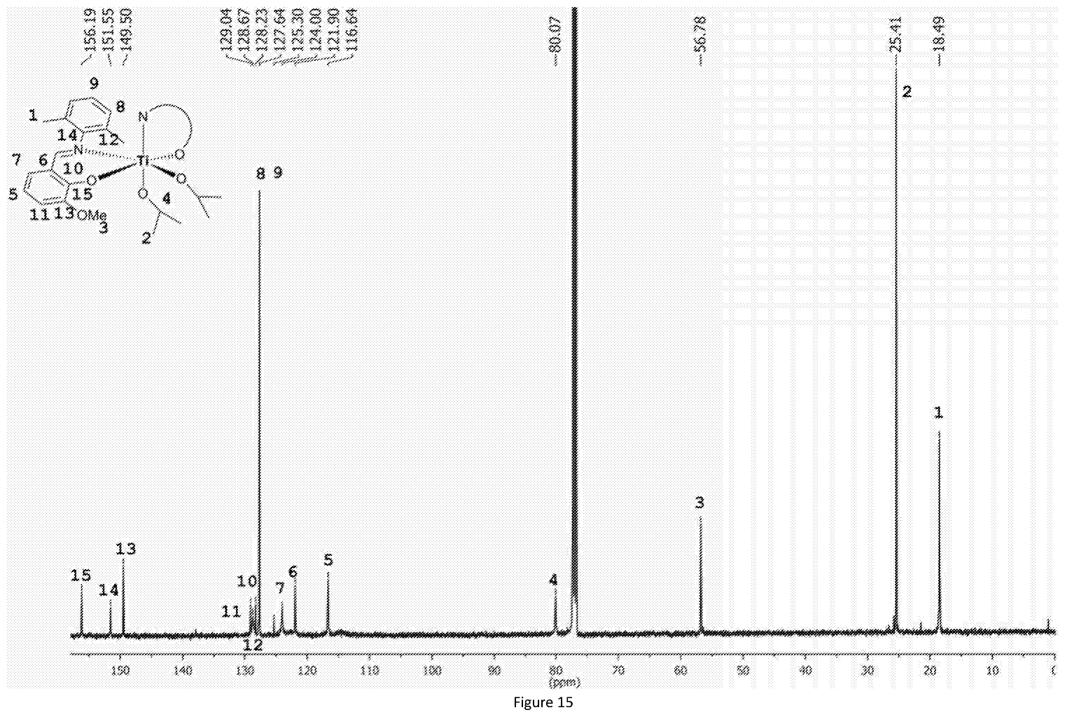

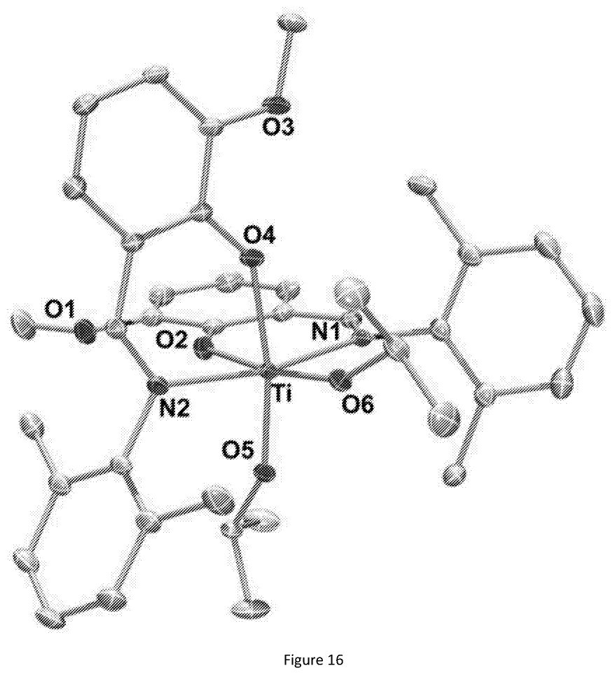

FIG. 15 shows the ¹³C{¹H} NMR spectrum of (L₃)₂Ti(OⁱPr)₂ in CDCl₃ at 125 MHz

FIG. 16 shows the ORTEP representation of (L₃)₂Ti(OⁱPr)₂. Ellipsoids drawn at 50% probability, hydrogens and disorder omitted for clarity. Green=Titanium, Blue=Nitrogen, Scarlet=Oxygen, Gray=Carbon.

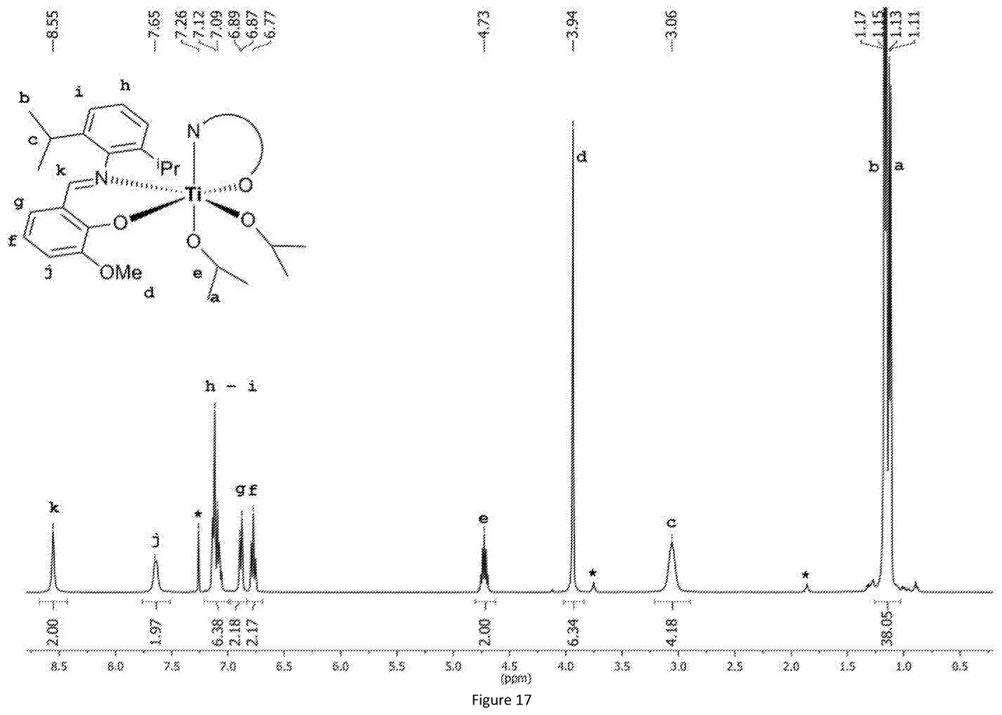

FIG. 17 shows the ¹H NMR spectrum of (L₄)₂Ti(OⁱPr)₂ in CDCl₃ at 400 MHz.

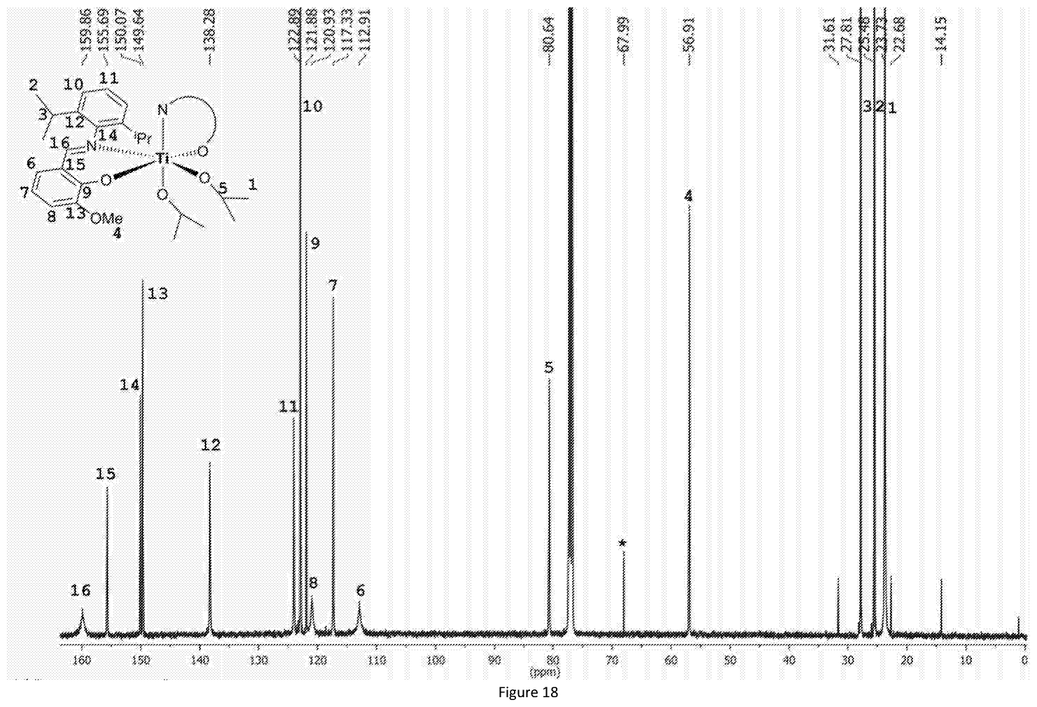

FIG. 18 shows the ¹³C{¹H} NMR spectrum of (L₄)₂Ti(OⁱPr)₂ in CDCl₃ at 125 MHz.

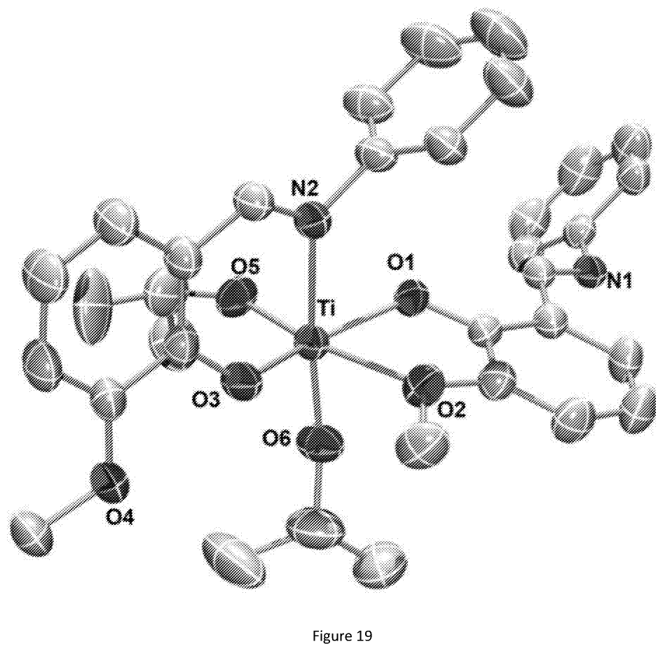

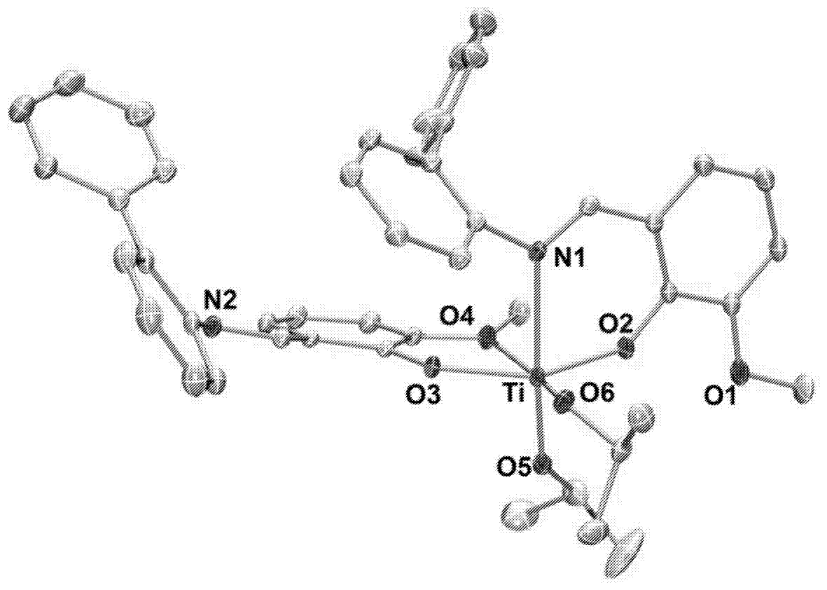

FIG. 19 shows the ORTEP representation of (L₄)₂Ti(OⁱPr)₂. Ellipsoids drawn at 50% probability, hydrogens, disorder, and isopropyls omitted for clarity. Green=Titanium, Blue=Nitrogen, Scarlet=Oxygen, Gray=Carbon

FIG. 20 shows the ORTEP representation of (L₅)₂Ti(OⁱPr)₂. Ellipsoids drawn at 50% probability, hydrogens and disorder omitted for clarity. Green=Titanium, Blue=Nitrogen, Scarlet=Oxygen, Gray=Carbon.

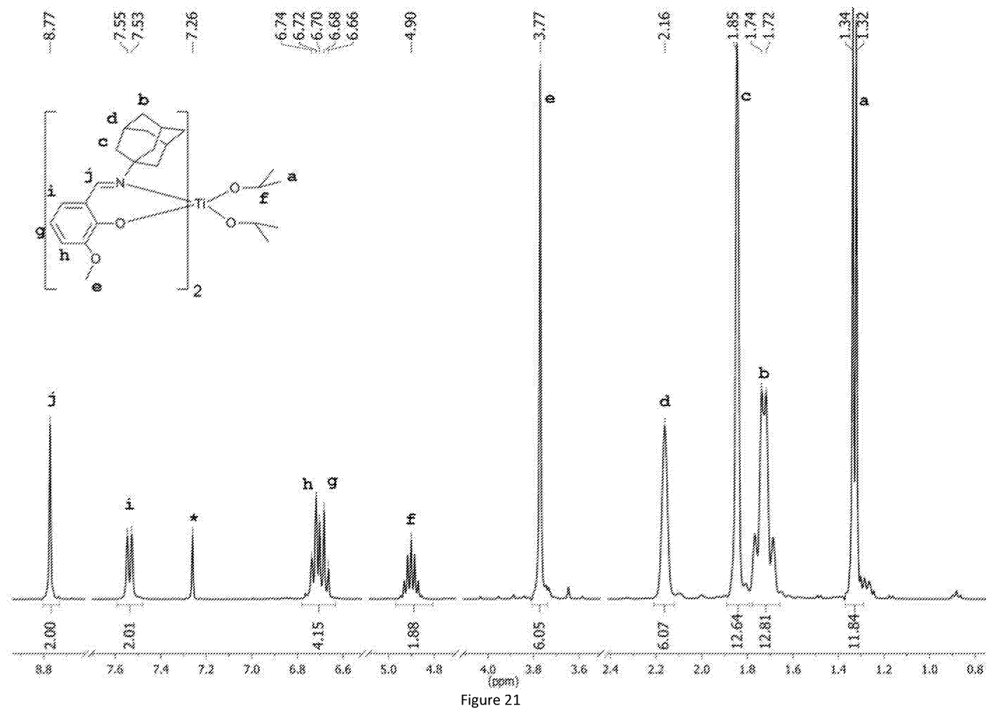

FIG. 21 shows the ¹H NMR spectrum of (L₆)₂Ti(OⁱPr)₂ in CDCl₃ at 400 MHz

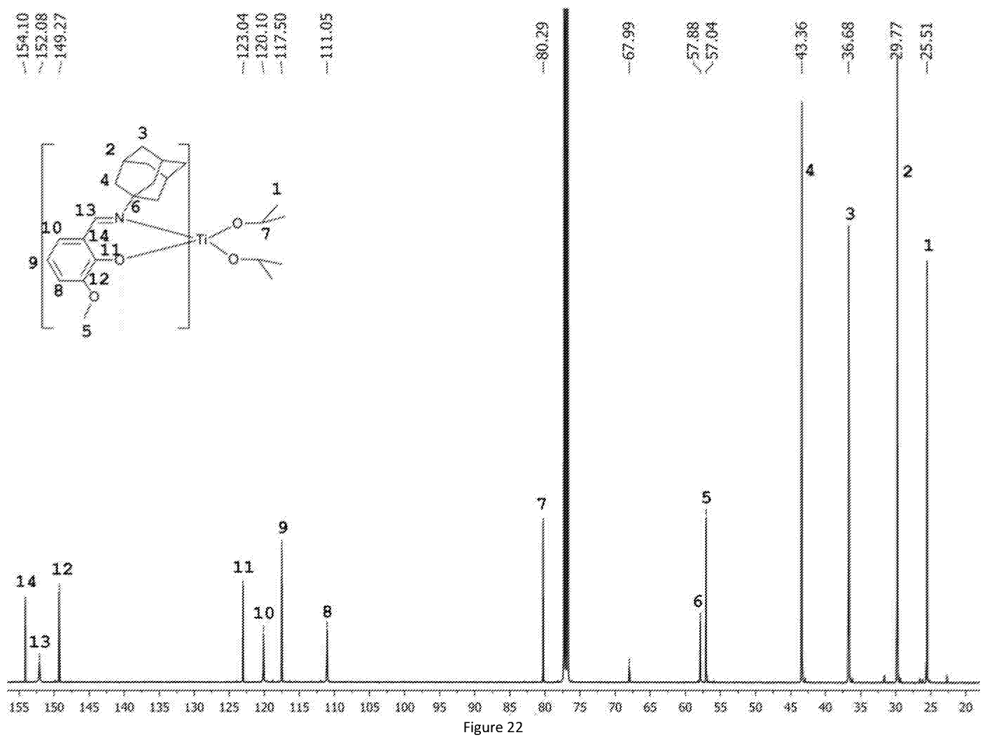

FIG. 22 shows the ¹³C{¹H} NMR spectrum of (L₆)₂Ti(OⁱPr)₂ in CDCl₃ at 125 MHz

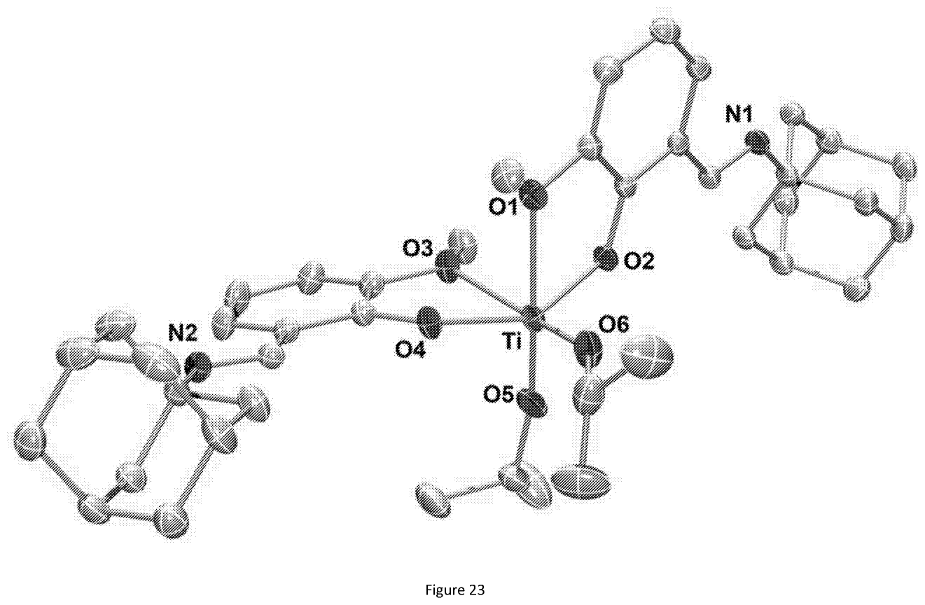

FIG. 23 shows the ORTEP representation of (L₆)₂Ti(OⁱPr)₂. Ellipsoids drawn at 50% probability, hydrogens and disorder omitted for clarity. Green=Titanium, Blue=Nitrogen, Scarlet=Oxygen, Gray=Carbon.

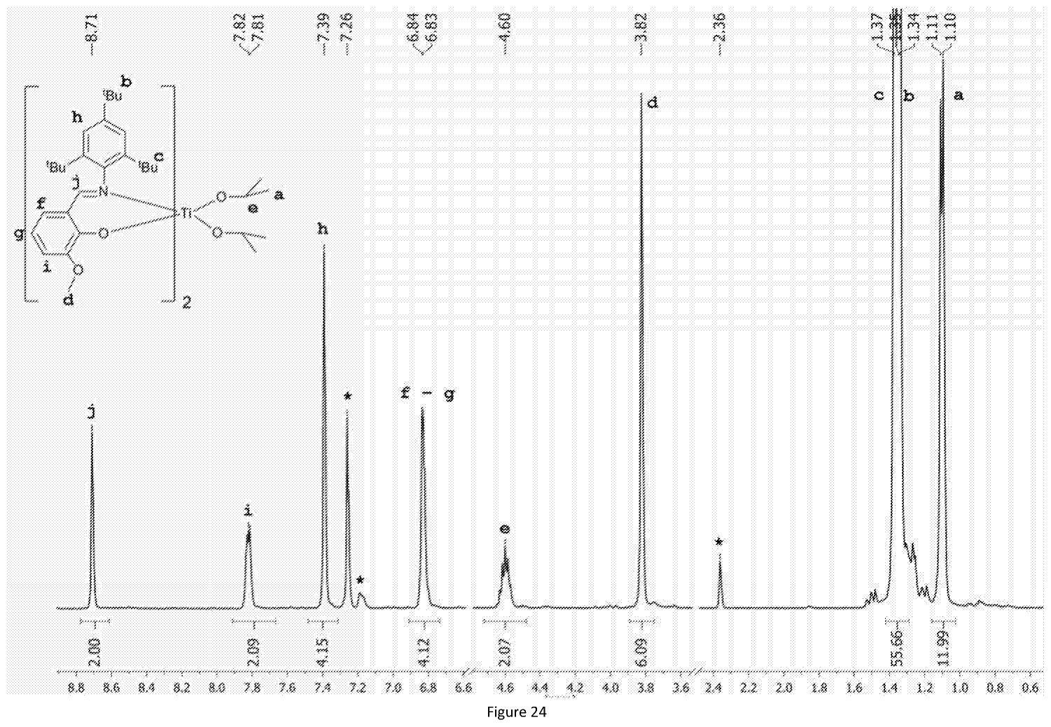

FIG. 24 shows the ¹H NMR spectrum of (L₇)₂Ti(OⁱPr)₂ in CDCl₃ at 400 MHz

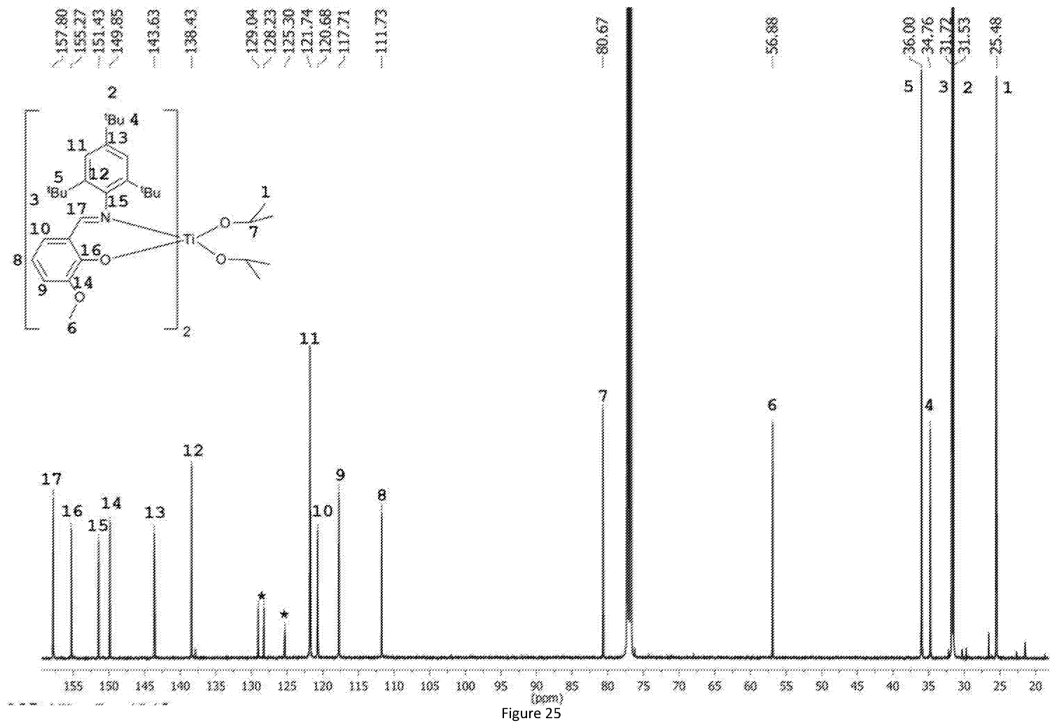

FIG. 25 shows the ¹³C{¹H} NMR spectrum of (L₇)₂Ti(OⁱPr)₂ in CDCl₃ at 125 MHz

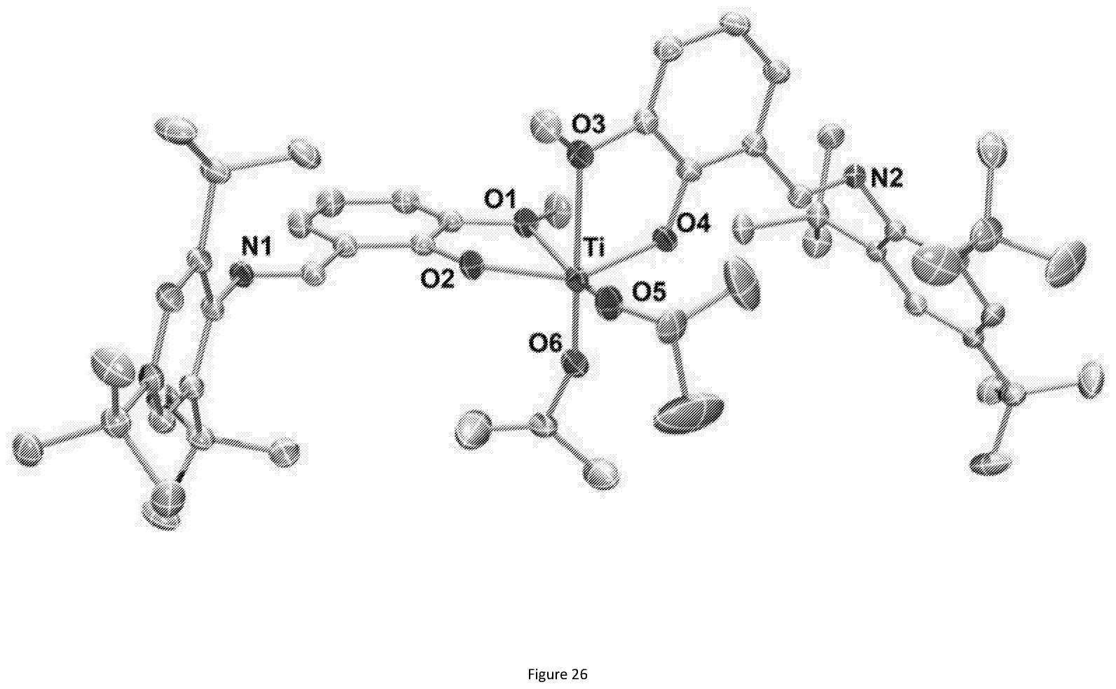

FIG. 26 shows the ORTEP representation of (L₇)₂Ti(OⁱPr)₂. Ellipsoids drawn at 50% probability, hydrogens and disorder omitted for clarity. Green=Titanium, Blue=Nitrogen, Scarlet=Oxygen, Gray=Carbon.

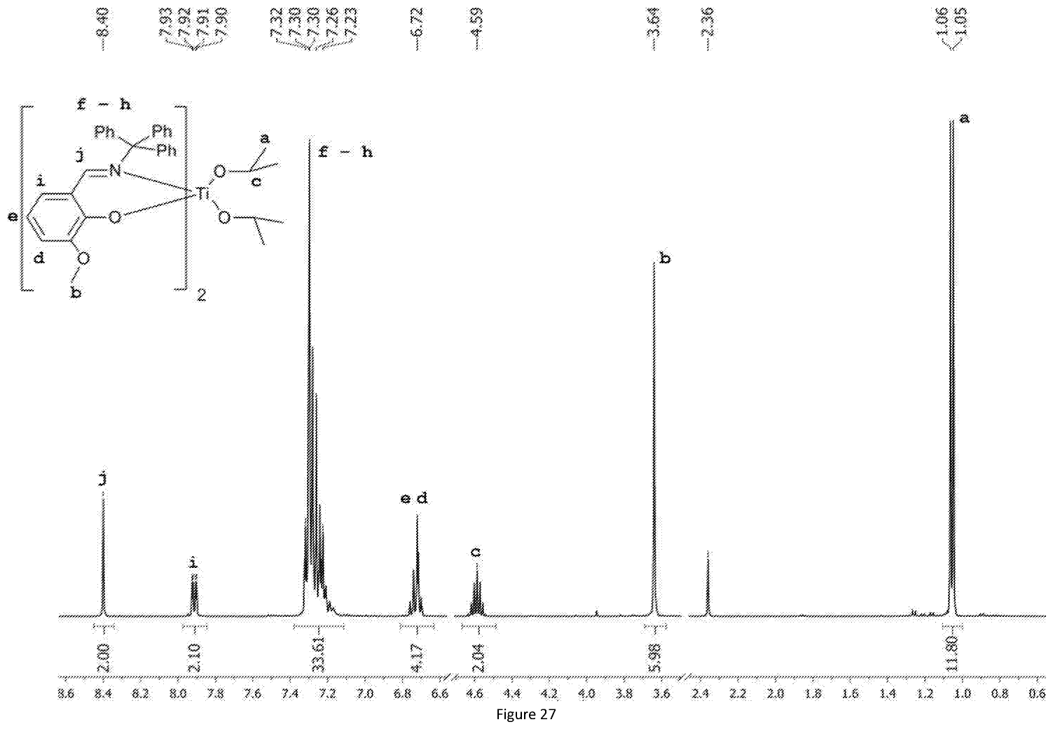

FIG. 27 shows the ¹H NMR spectrum of (L₈)₂Ti(OⁱPr)₂ in CDCl₃ at 400 MHz

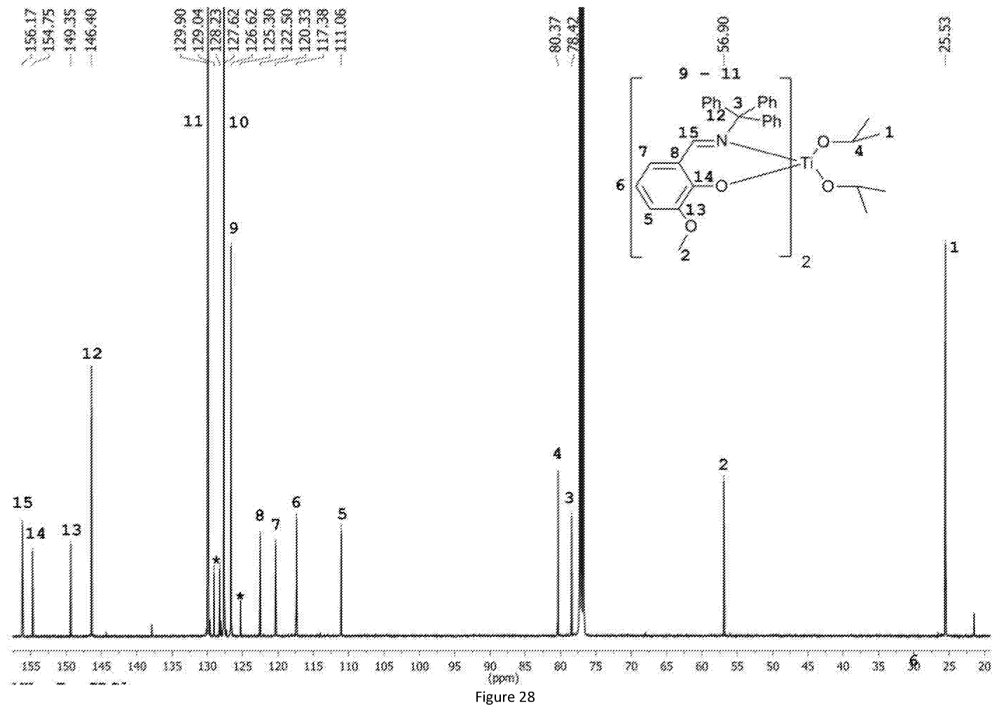

FIG. 28 shows the ¹³C{¹H} NMR spectrum of (L₈)₂Ti(OⁱPr)₂ in CDCl₃ at 125 MHz

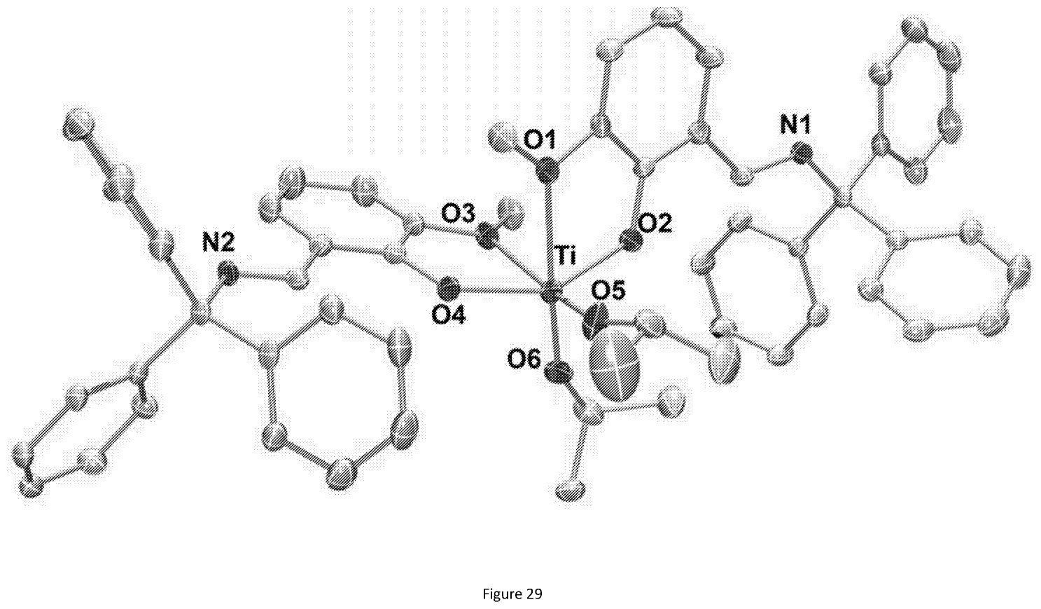

FIG. 29 shows the ORTEP representation of (L₈)₂Ti(OⁱPr)₂. Ellipsoids drawn at 50% probability, hydrogens and disorder omitted for clarity. Green=Titanium, Blue=Nitrogen, Scarlet=Oxygen, Gray=Carbon.

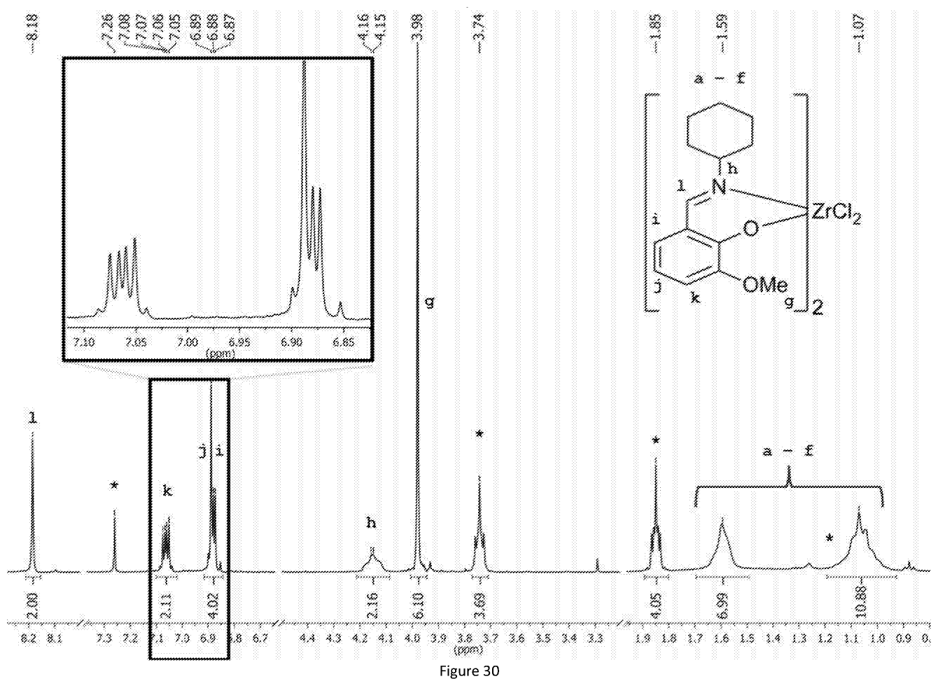

FIG. 30 shows the ¹H NMR spectrum of (L₂)₂ZrCl₂ in CDCl₃ at 400 MHz.

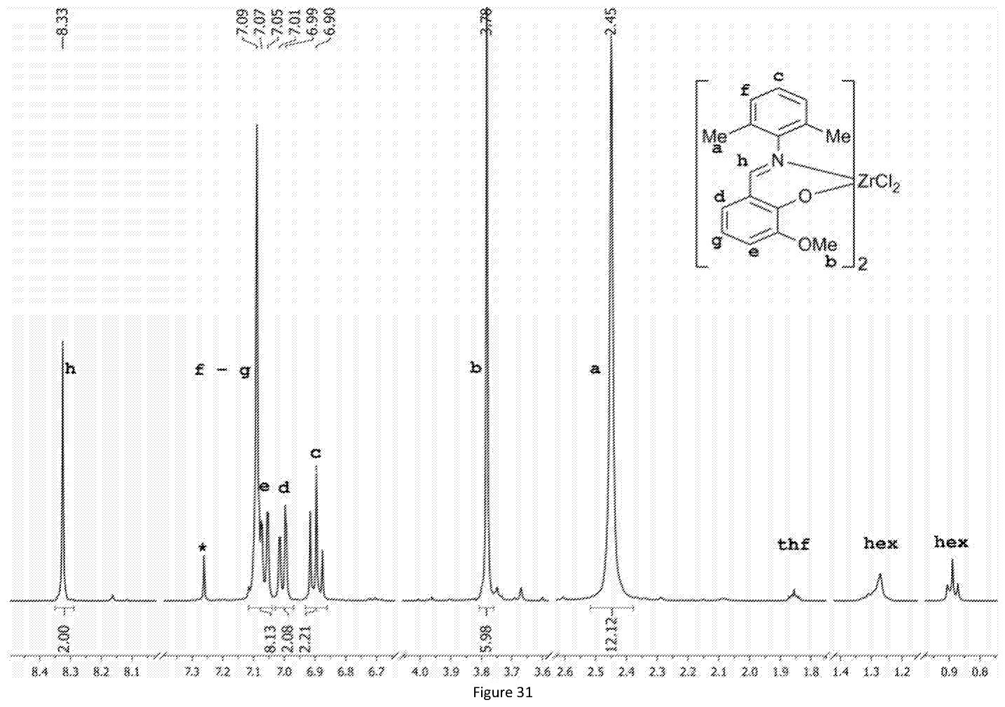

FIG. 31 shows the ¹H NMR spectrum of (L₃)₂ZrCl₂ in CDCl₃ at 400 MHz.

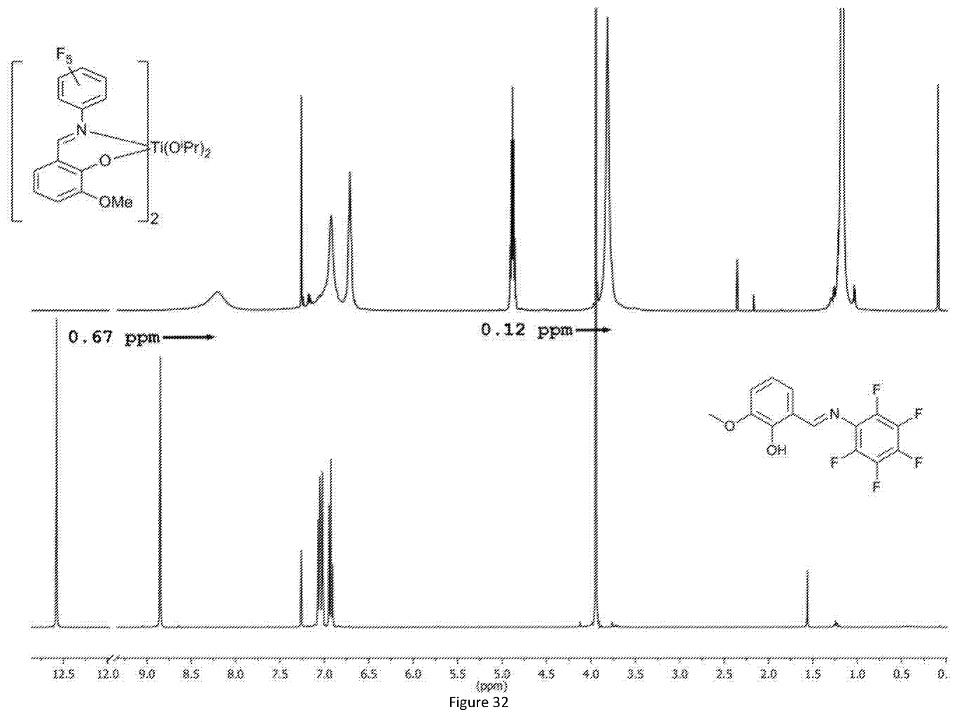

FIG. 32 shows comparative ¹H NMR spectra of (L₁)₂Ti(OⁱPr)₂ and HL₁, in CDCl₃, 400 MHz.

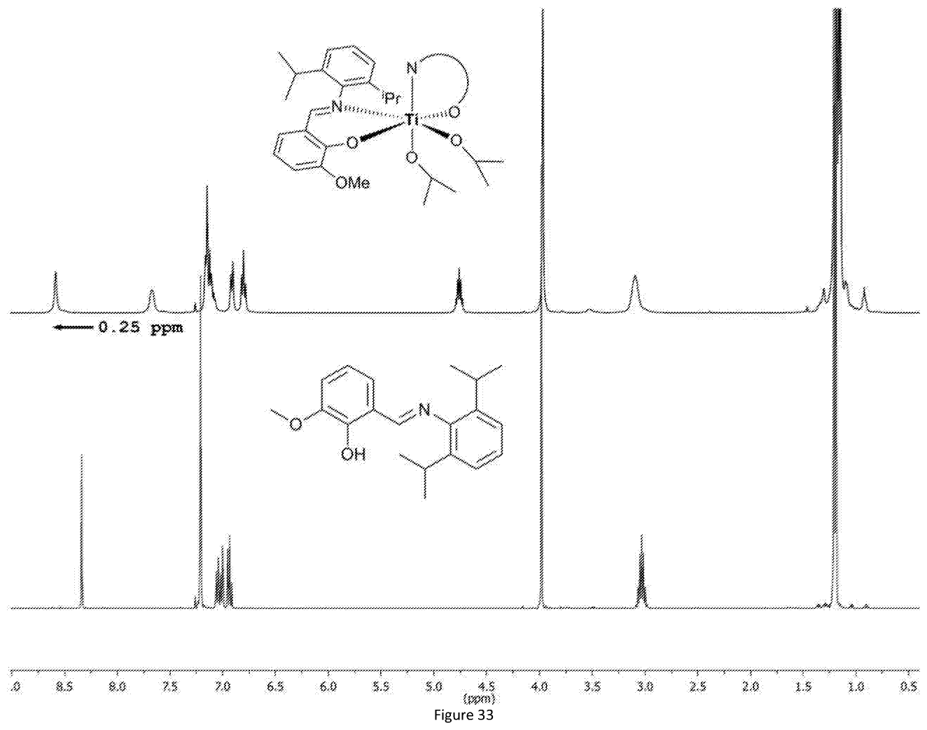

FIG. 33 shows comparative ¹H NMR spectra of (L₄)₂Ti(OⁱPr)₂ and HL₄, in CDCl₃, 400 MHz

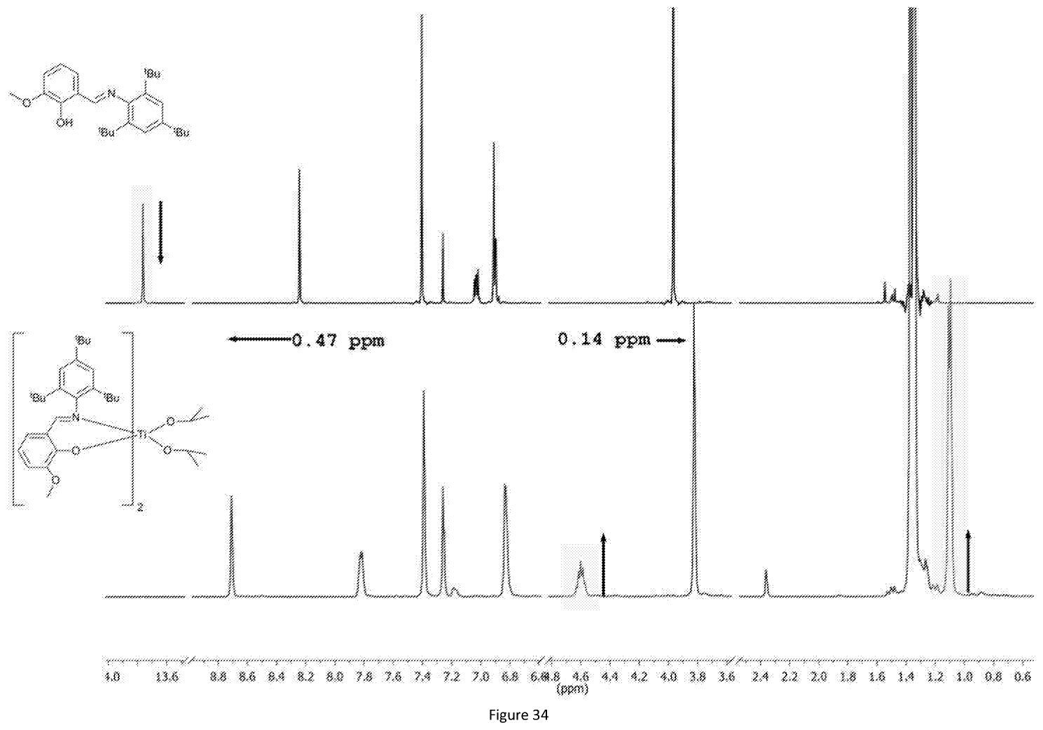

FIG. 34 shows comparative ¹H NMR spectra of (L₇)₂Ti(OⁱPr)₂ and HL₇, in CDCl₃, 400 MHz

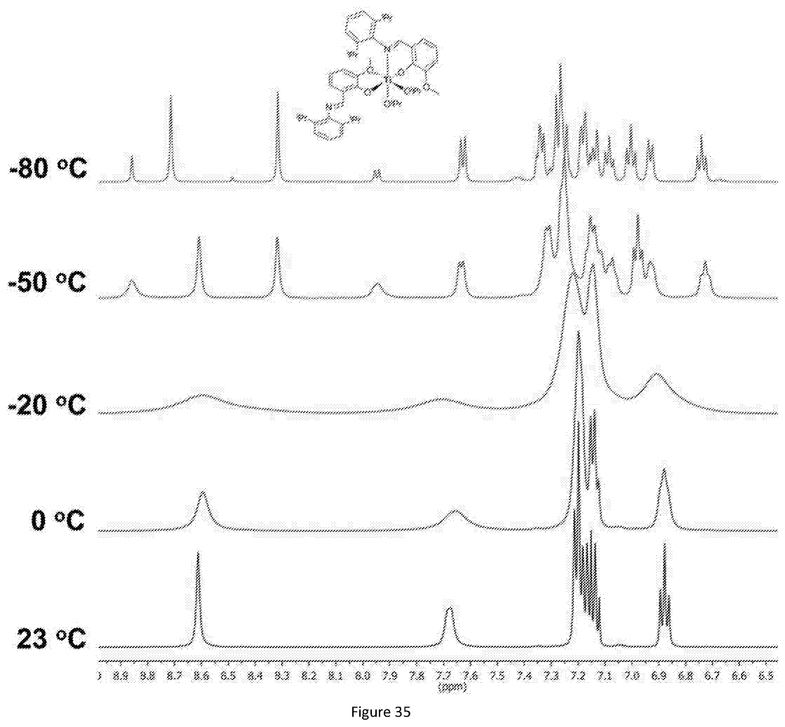

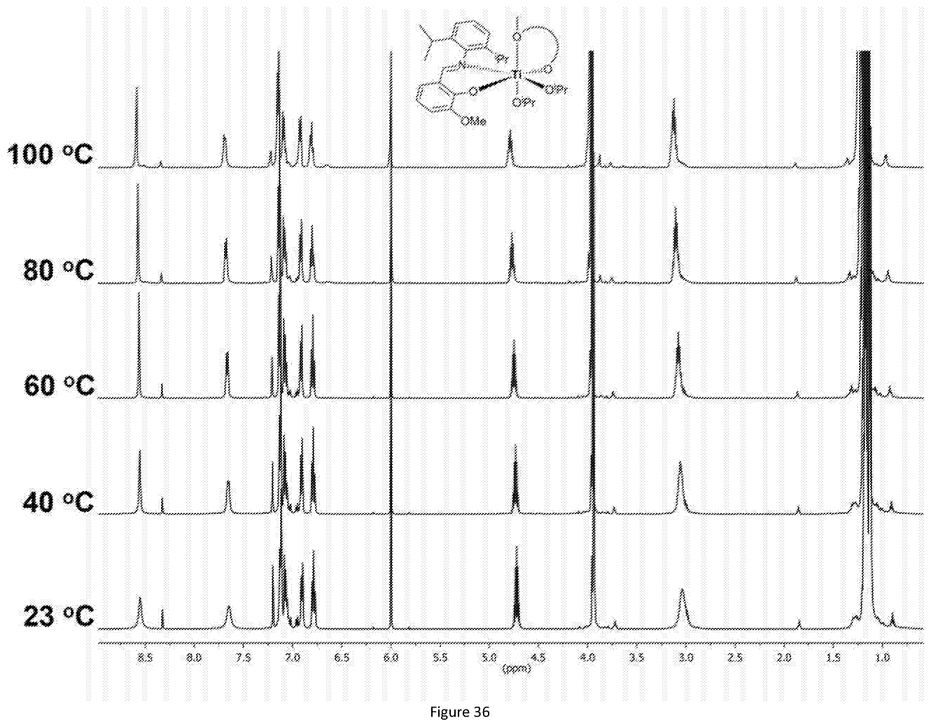

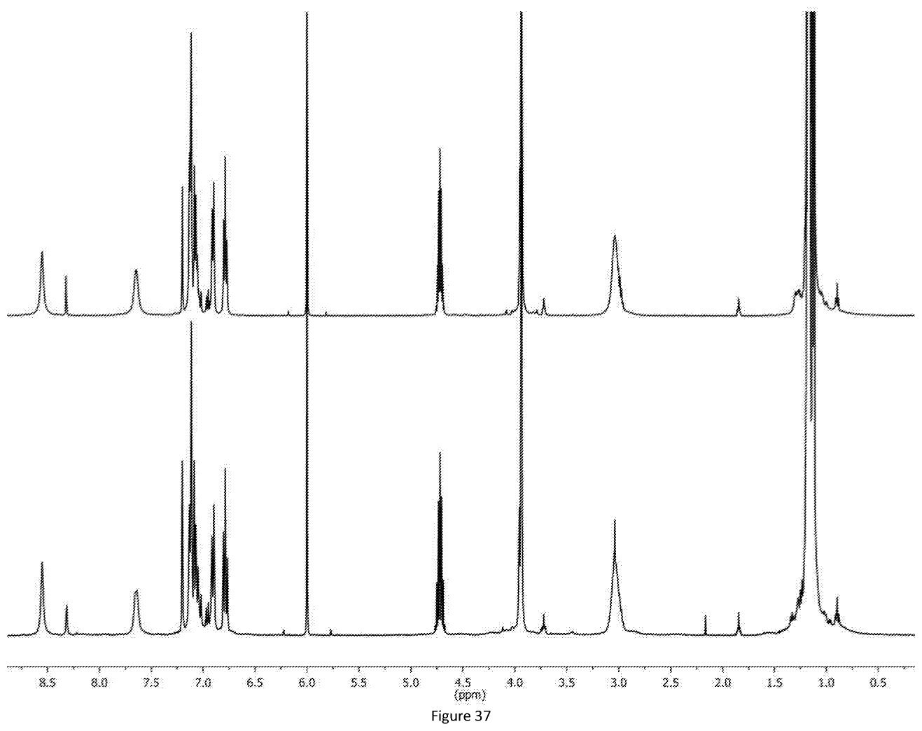

FIG. 35 shows variable temperature NMR of the imine region of (L₄)₂Ti(OⁱPr)₂ in d⁸-THF (500 MHz).

FIG. 36 shows variable high temperature ¹H NMR (500 MHz) of (L₄)₂Ti(OⁱPr)₂ in d²-tetrachloroethane

FIG. 37 shows ¹H NMR of (L₄)₂Ti(OⁱPr)₂ in d²-tetrachloroethane before heating (Top) and after heating for 24 h at 100° C. (bottom).

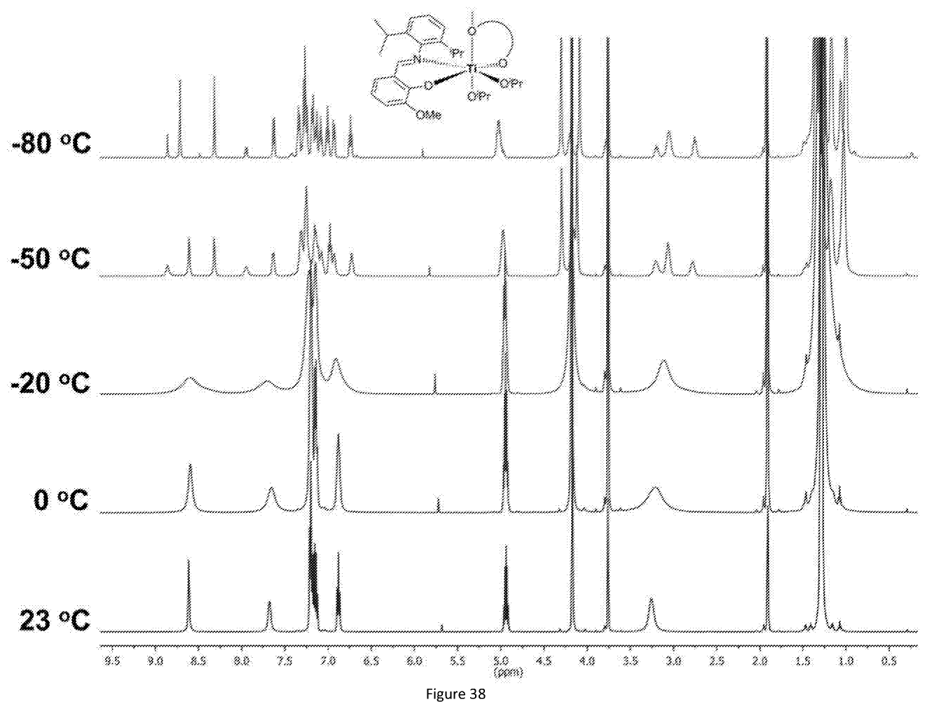

FIG. 38 shows variable low temperature ¹H NMR (500 MHz) of (L₄)₂Ti(OⁱPr)₂ in d⁸-THF

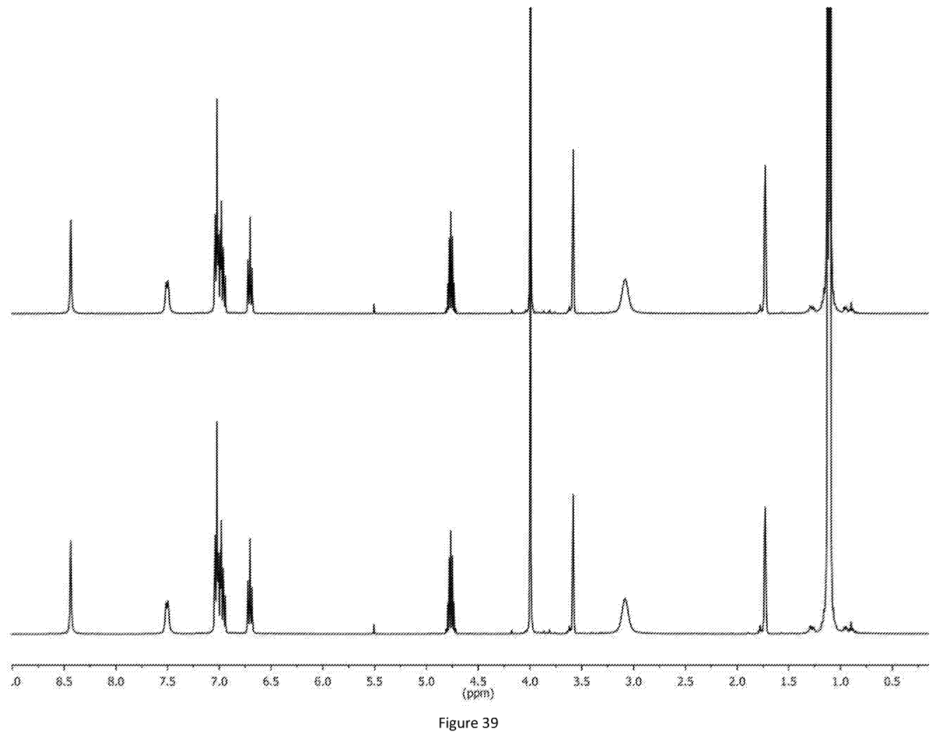

FIG. 39 shows ¹H NMR of (L₄)₂Ti(OⁱPr)₂ in d⁸-THF before heating (top) and after heating for 5 h at 70° C. (bottom).

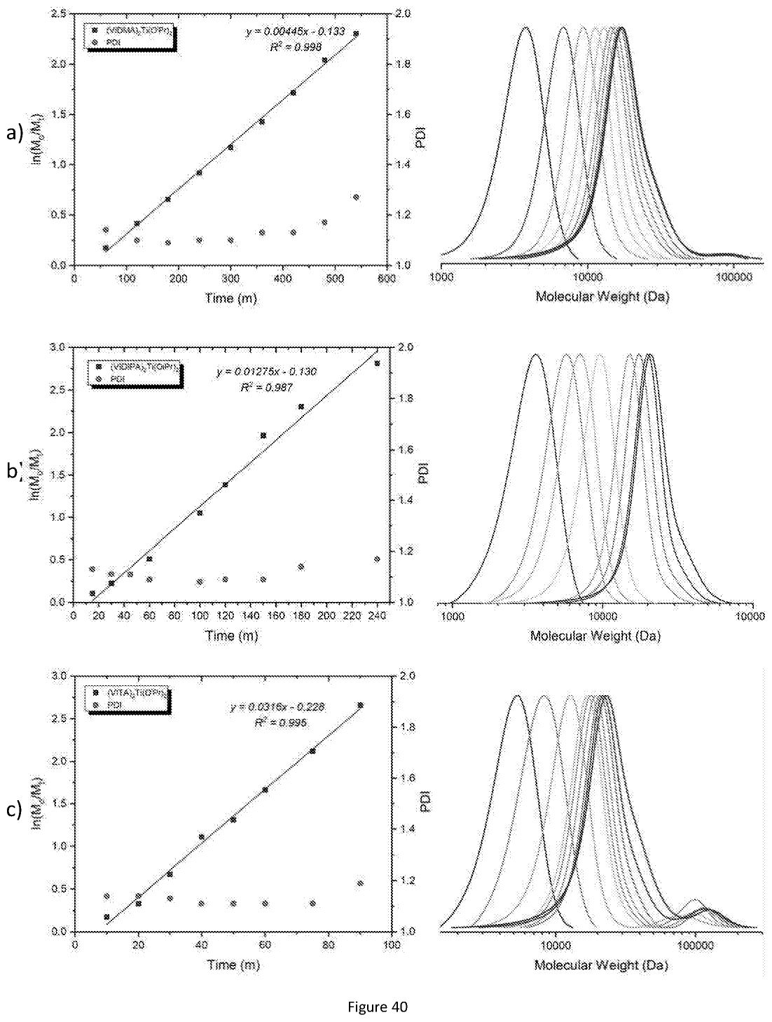

FIG. 40 shows (a) Kinetic plot of In([M₀]/[Mₜ]) and PDI against time for (L₃)₂Ti(OⁱPr)₂ (left); corresponding GPC traces per time point (right); (b) Kinetic plot of In([M₀][Mₜ]) and PDI against time for (L₄)₂Ti(OⁱPr)₂ (left); corresponding GPC traces per time point (right); (c) Kinetic plot of In([M₀][Mₜ]) and PDI against time for (L₈)₂Ti(OⁱPr)₂ (left); corresponding GPC traces per time point (right).

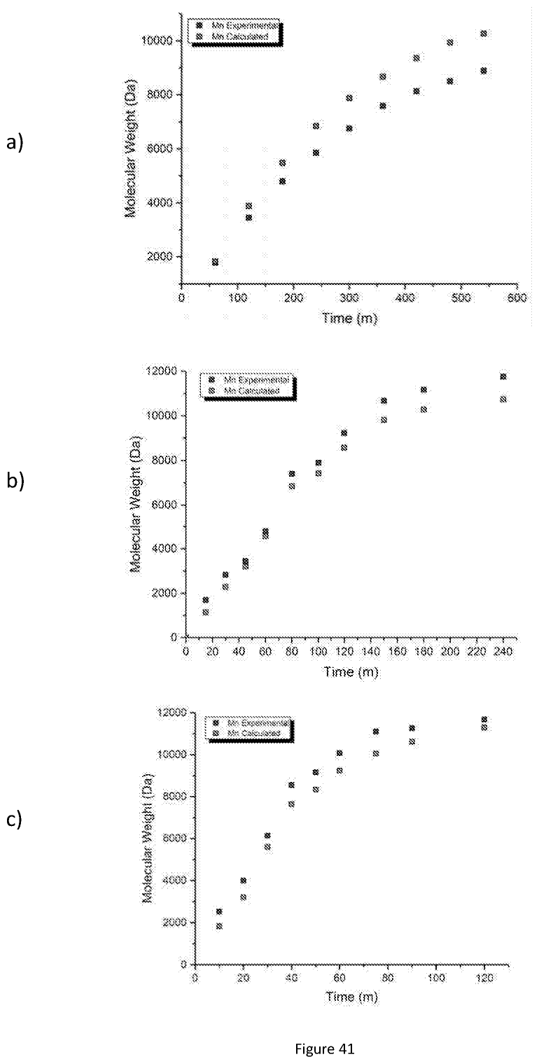

FIG. 41 shows (a) Mn Experimental vs Mn Calculated for PCL produced from (L₃)₂Ti(OⁱPr)₂. Experimental value relative to polystyrene standard corrected by a factor of 0.56, calculated value based on two growing chains; (b) Mn Experimental vs Mn Calculated for PCL produced from (L₄)₂Ti(OⁱPr)₂. Experimental value relative to polystyrene standard corrected by a factor of 0.56, calculated value based on two growing chains; (c) Mn Experimental vs Mn Calculated for PCL produced from (L₈)₂Ti(OⁱPr)₂. Experimental value relative to polystyrene standard corrected by a factor of 0.56, calculated value based on two growing chains.

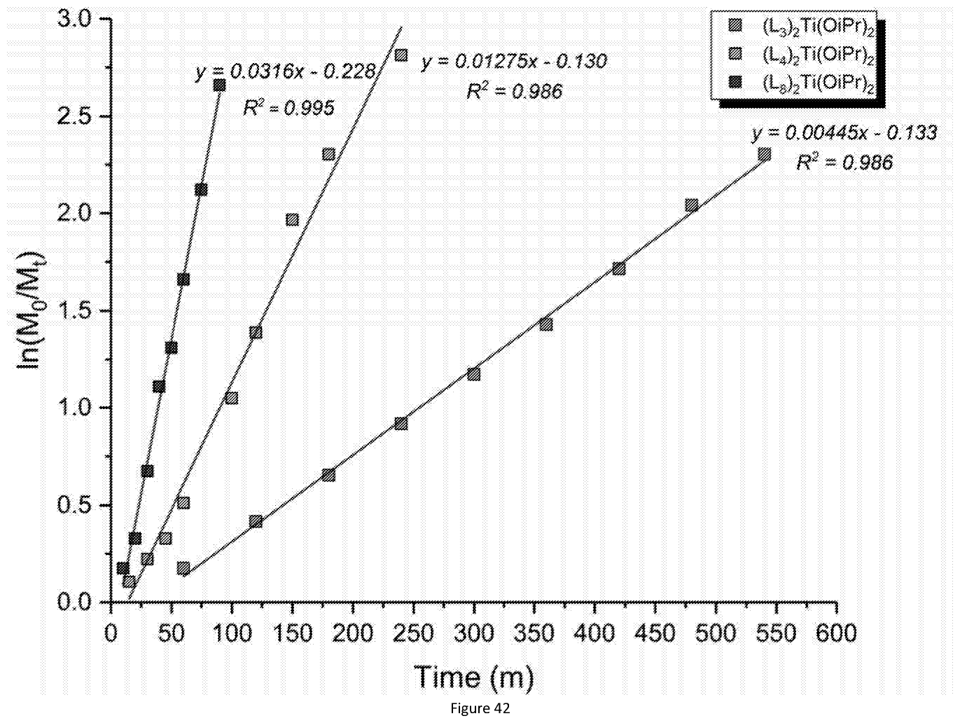

FIG. 42 shows Plots of In(M₀/Mₜ) vs time. Conditions: 0.9 M solution in ε-CL, 200:1 monomer:catalyst, toluene, 80° C.

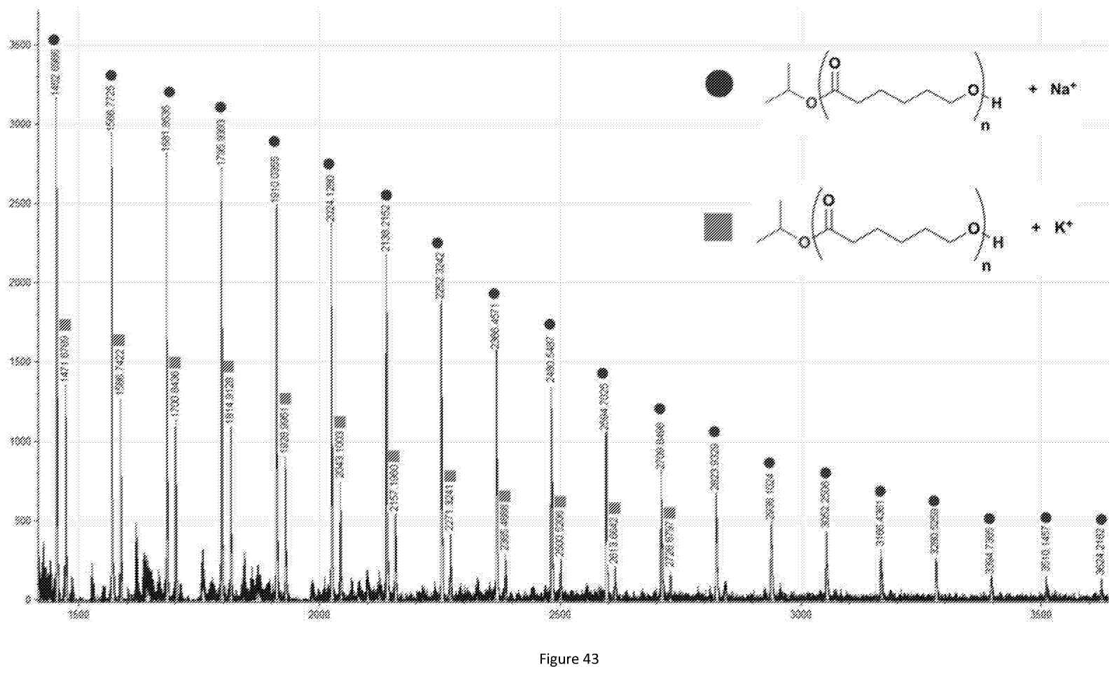

FIG. 43 shows MALDI-ToF of PCL at low conversion from (L₃)₂Ti(OⁱPr)₂.

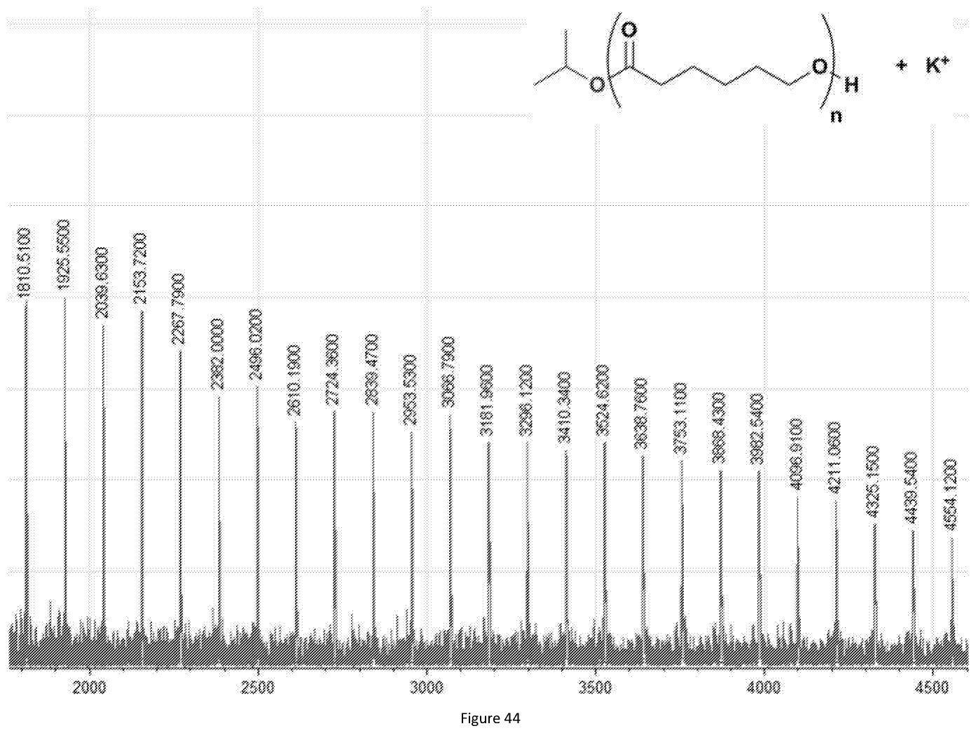

FIG. 44 shows MALDI-ToF of PCL at low conversion from (L₄)₂Ti(OⁱPr)₂.

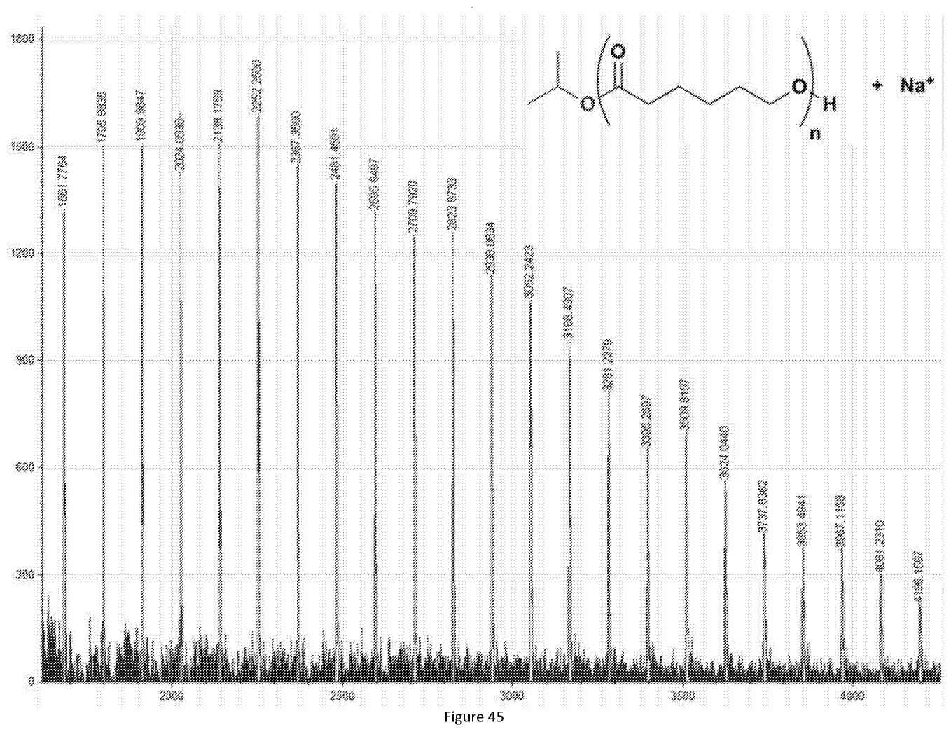

FIG. 45 shows MALDI-ToF of PCL at low conversion from (L₈)₂Ti(OⁱPr)₂.

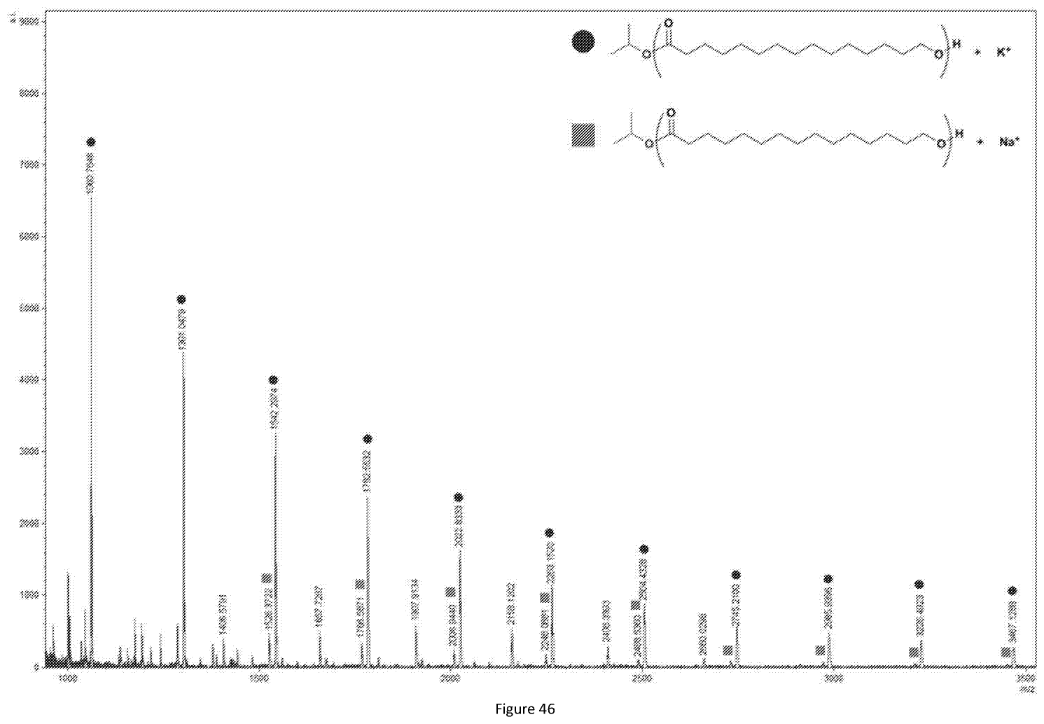

FIG. 46 shows MALDI-ToF of PPDL at low conversion from (L₅)₂Ti(OⁱPr)₂.

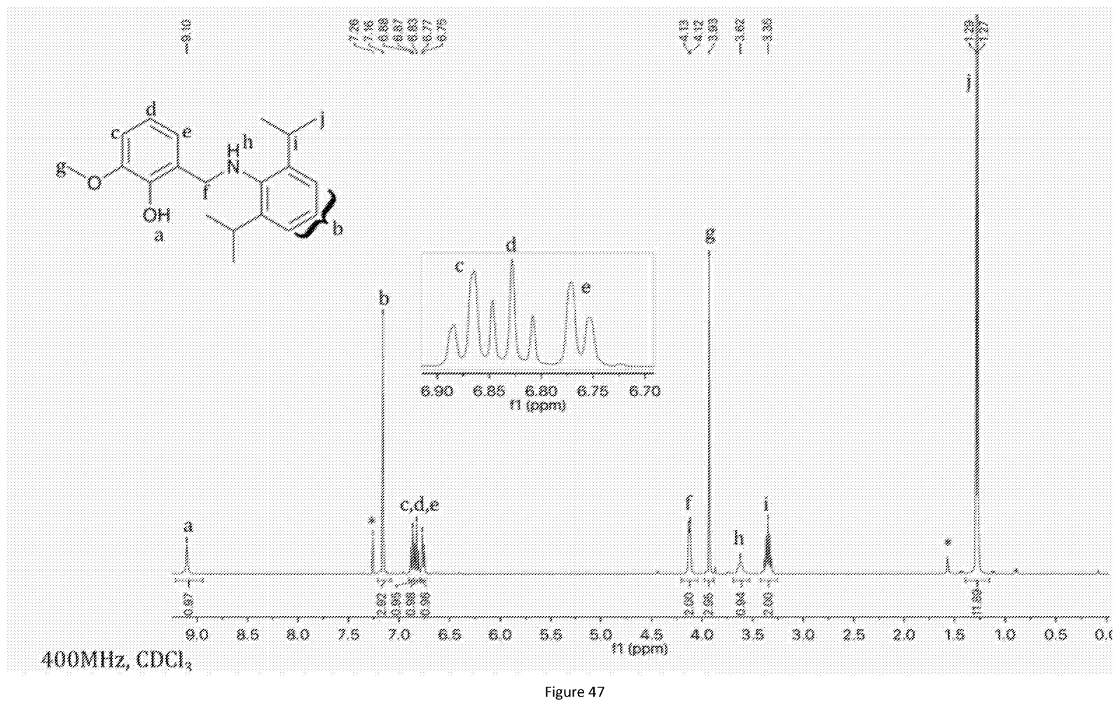

FIG. 47 shows the ¹H NMR spectrum of HL₄′ in CDCl₃, 400 MHz.

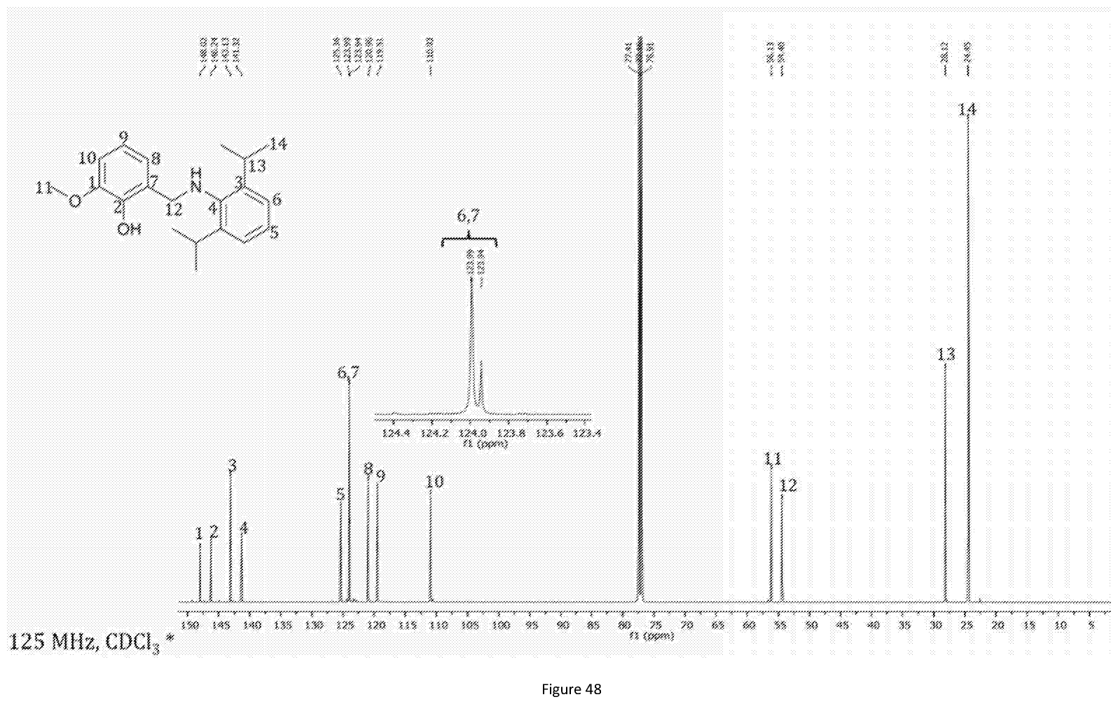

FIG. 48 shows the ¹³C{¹H} NMR spectrum of HL₄′ in CDCl₃, 400 MHz.

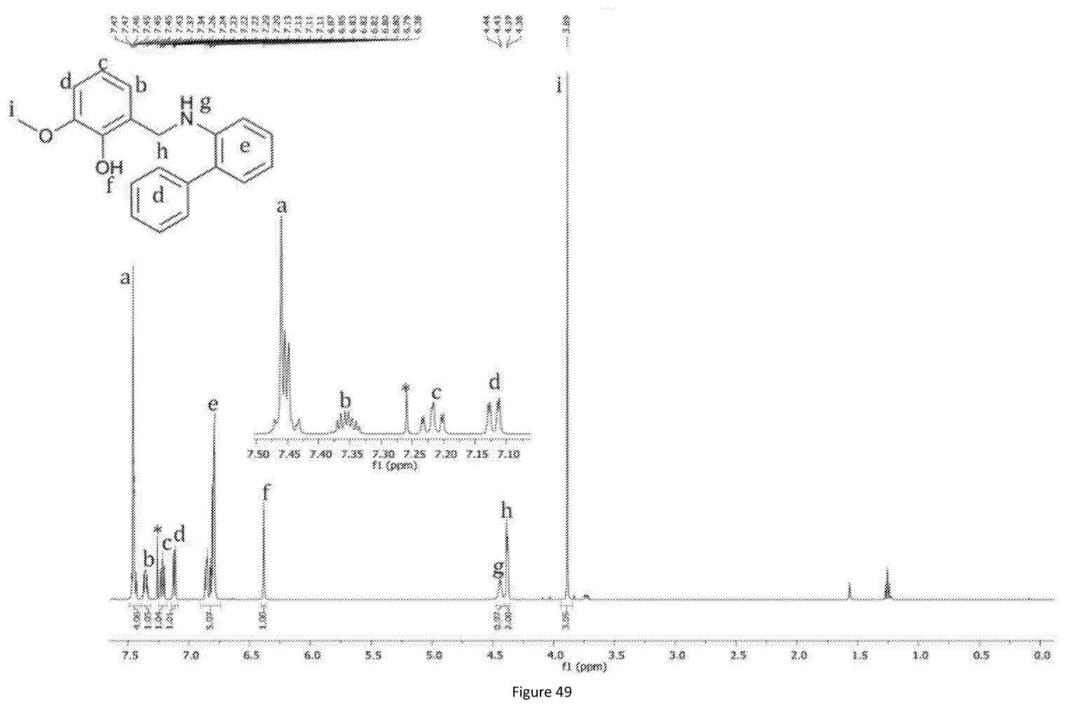

FIG. 49 shows the ¹H NMR spectrum of HL₅′ in CDCl₃, 400 MHz.

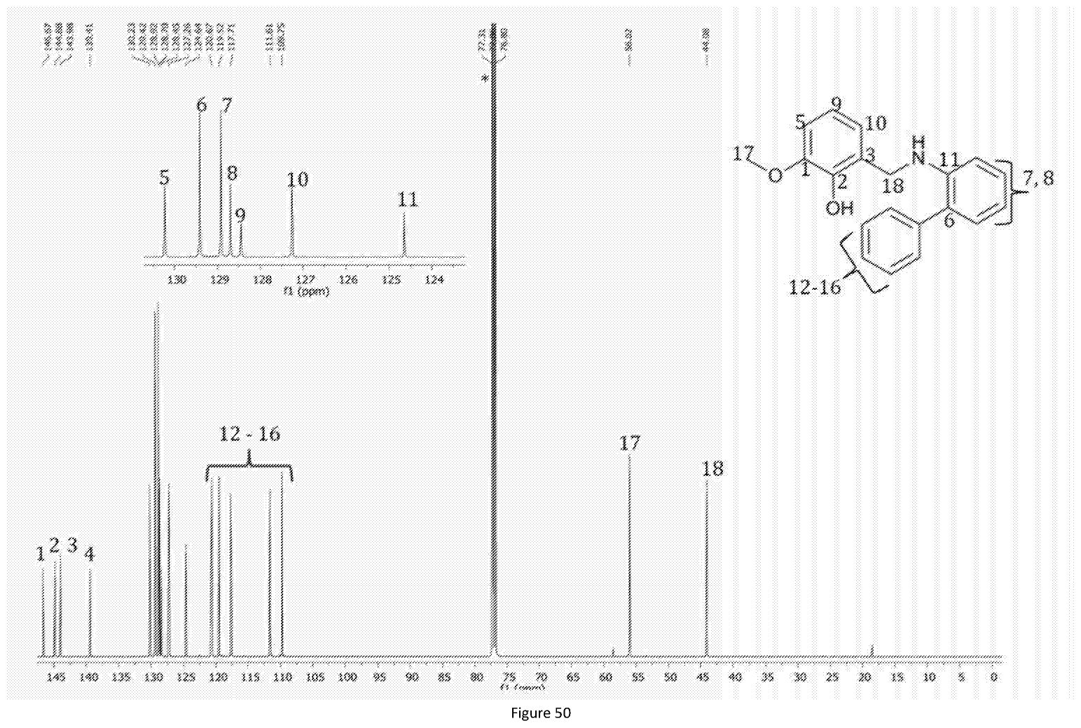

FIG. 50 shows the ¹³C{¹H} NMR spectrum of HL₅′ in CDCl₃, 400 MHz.

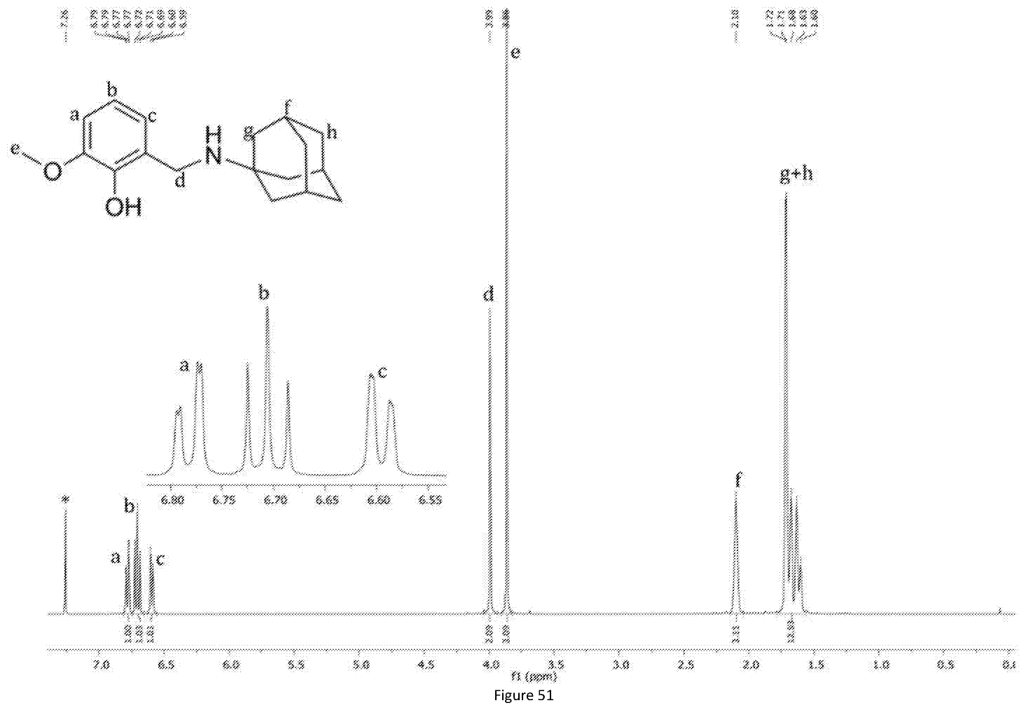

FIG. 51 shows the ¹H NMR spectrum of HL₆′ in CDCl₃, 400 MHz.

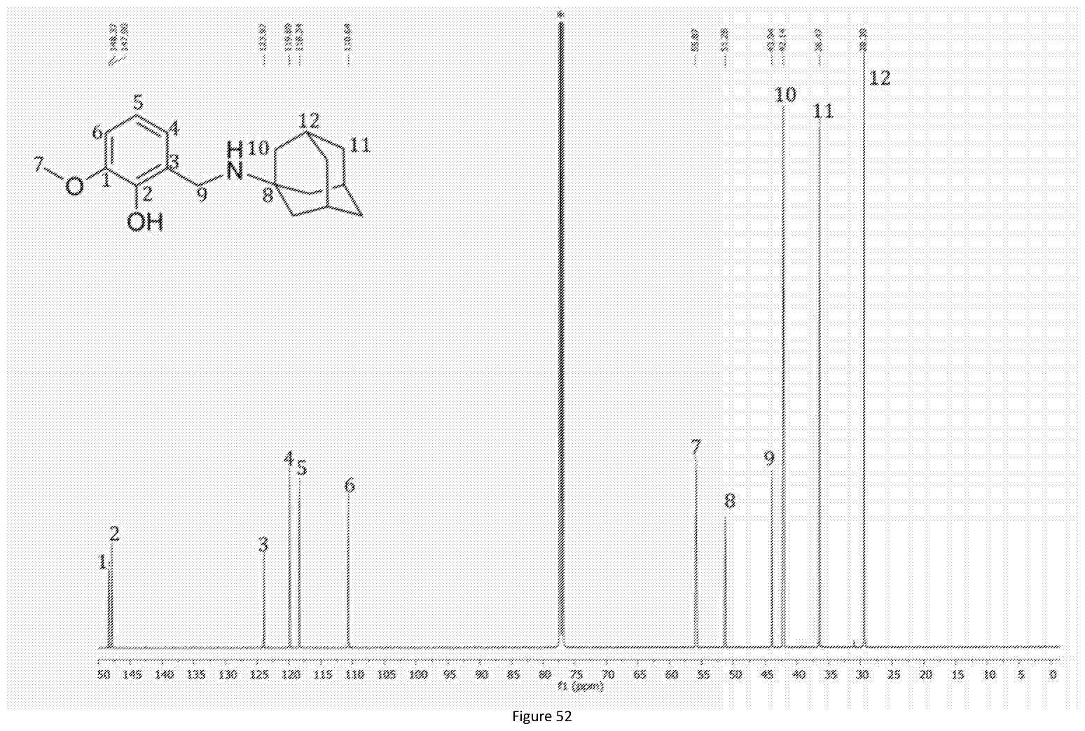

FIG. 52 shows the ¹³C{¹H} NMR spectrum of HL₆′ in CDCl₃, 400 MHz.

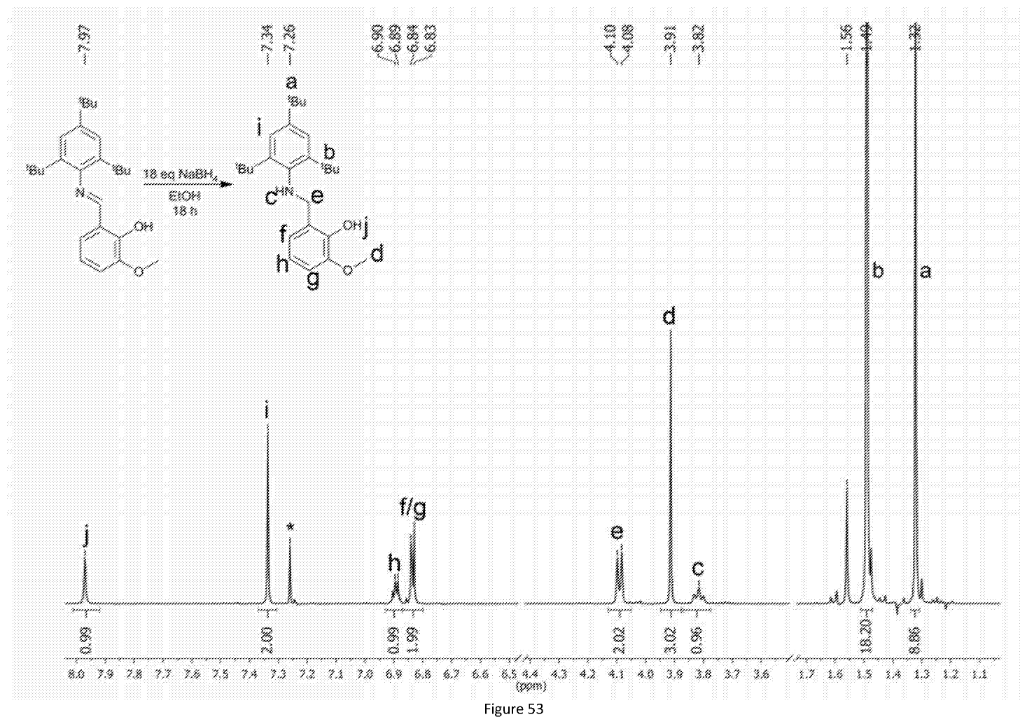

FIG. 53 shows the ¹H NMR spectrum of HL₇′ in CDCl₃, 500 MHz.

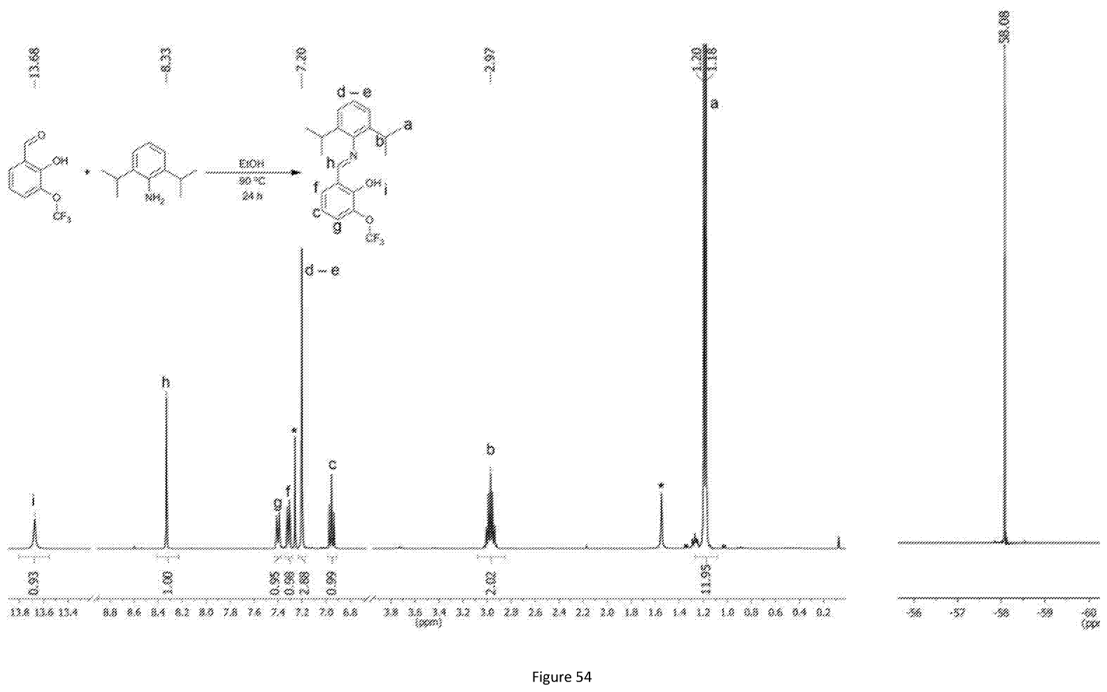

FIG. 54 shows the ¹H NMR spectrum of HL₄^{F} in CDCl₃, 400 MHz.

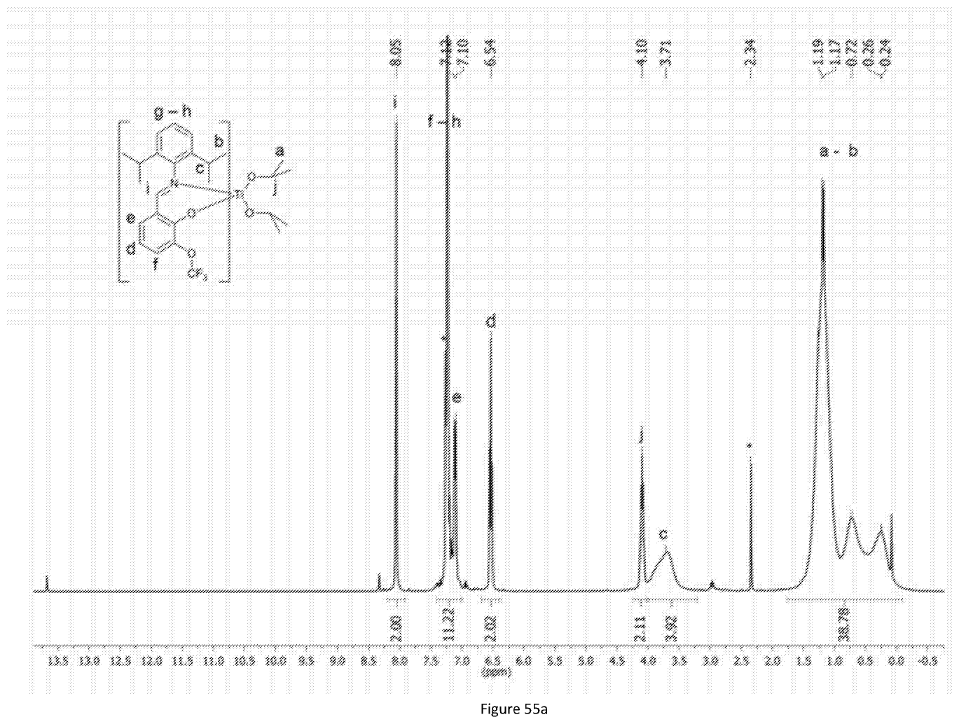

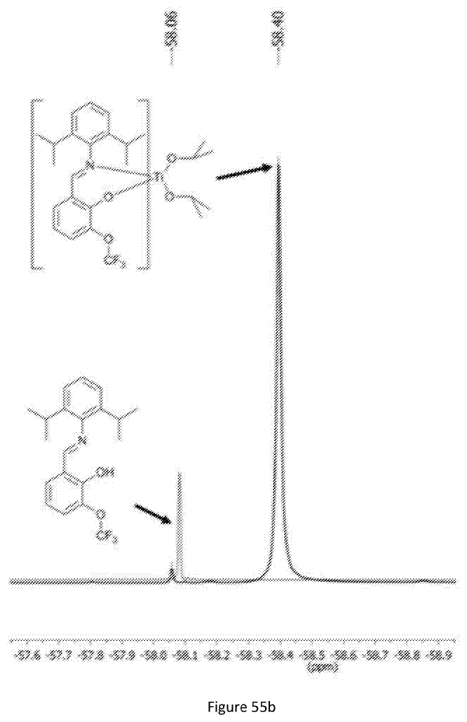

FIG. 55 shows the ¹H NMR spectrum of [(LF₄)₂Ti(OⁱPr)₂] in CDCl₃, 400 MHz, as well as the ¹⁹F{¹H} NMR spectrum comparing HL^{F}₄ (−58.1 ppm) and [(LF₄)₂Ti(OⁱPr)₂] (−58.4) 400 MHz in CDCl₃.

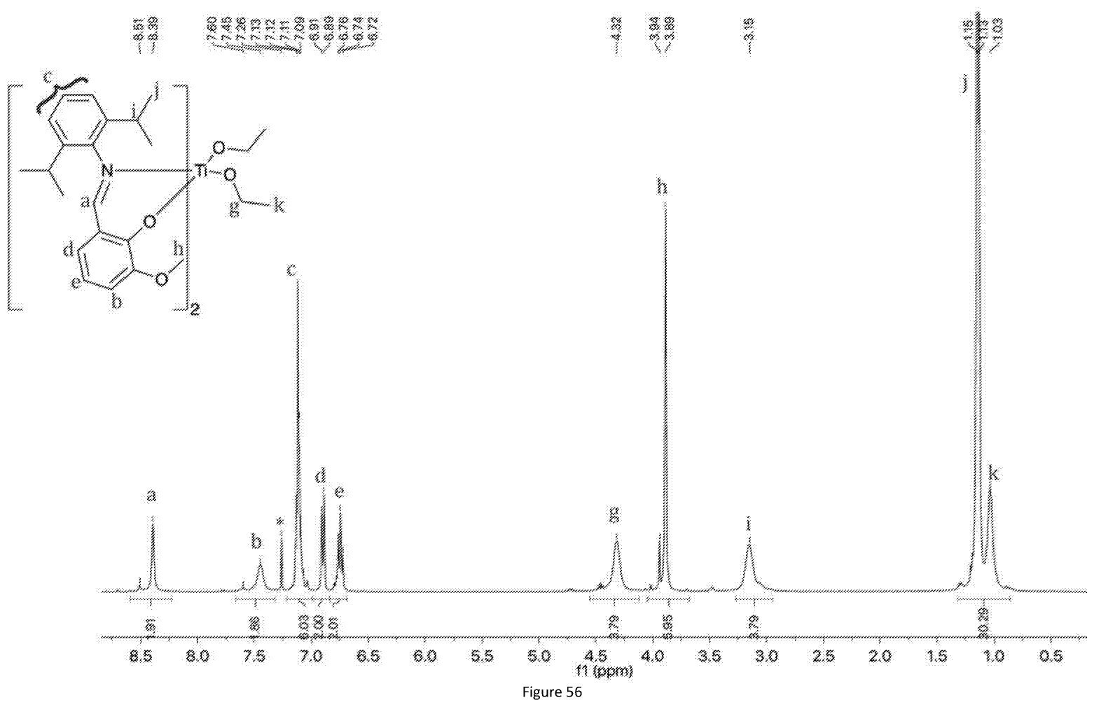

FIG. 56 shows the ¹H NMR spectrum of (L₄)₂Ti(OEt)₂ in CDCl₃ at 298 K.

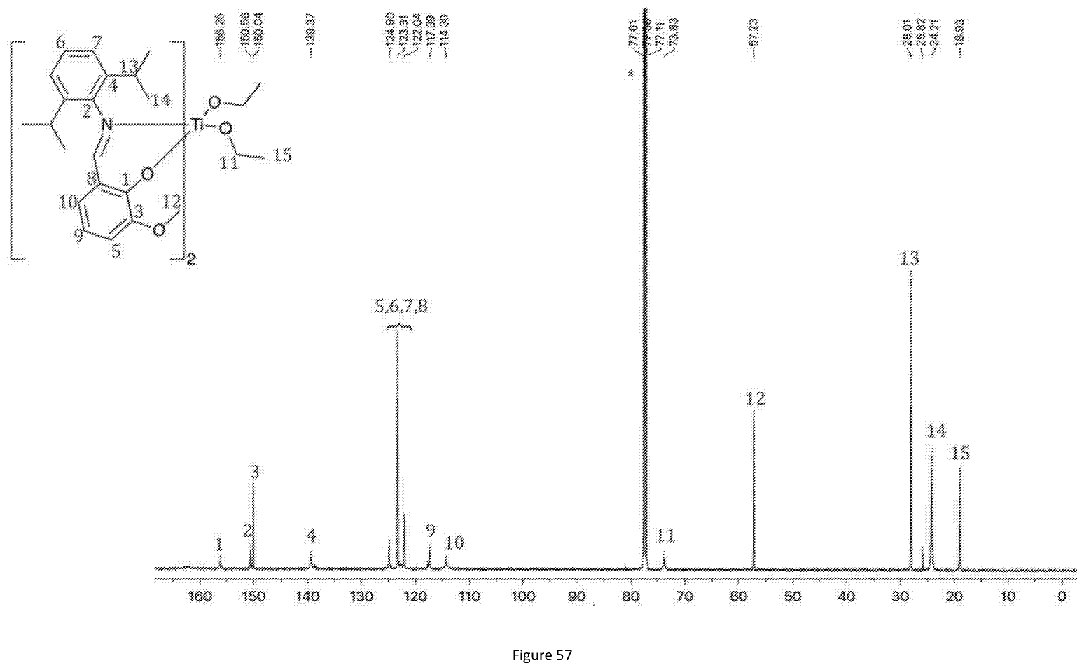

FIG. 57 shows the ¹³C{¹H} NMR spectrum of (L₄)₂Ti(OEt)₂ in CDCl₃ at 298 K.

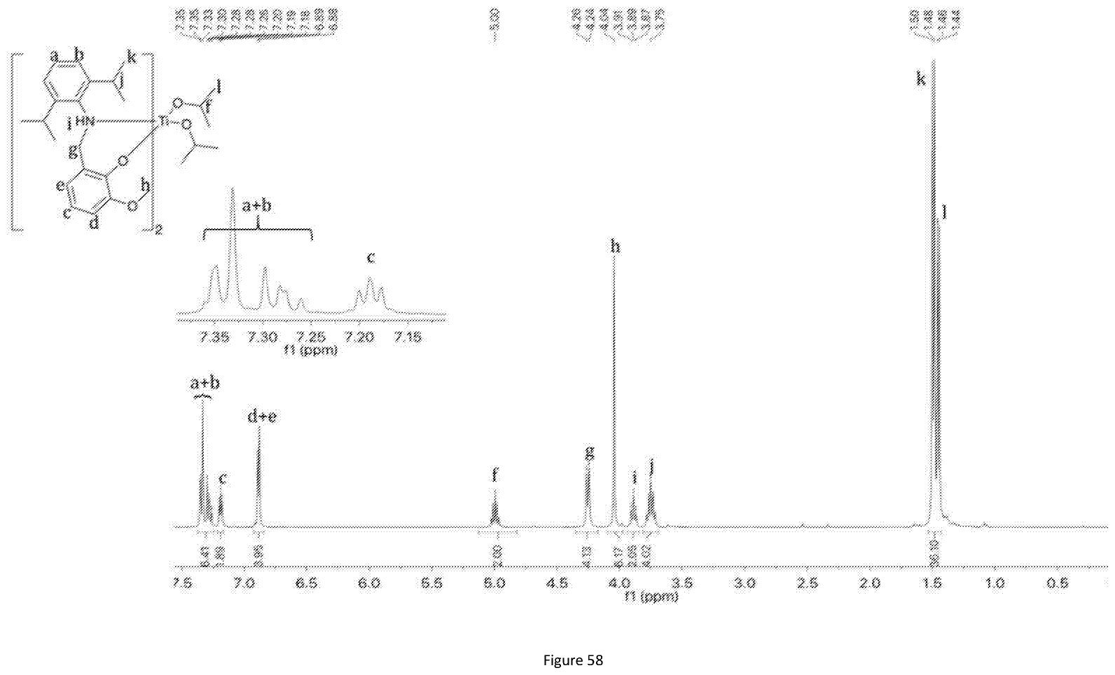

FIG. 58 shows the ¹H NMR spectrum of (L₄′)₂Ti(OⁱPr)₂ in CDCl₃ at 298 K.

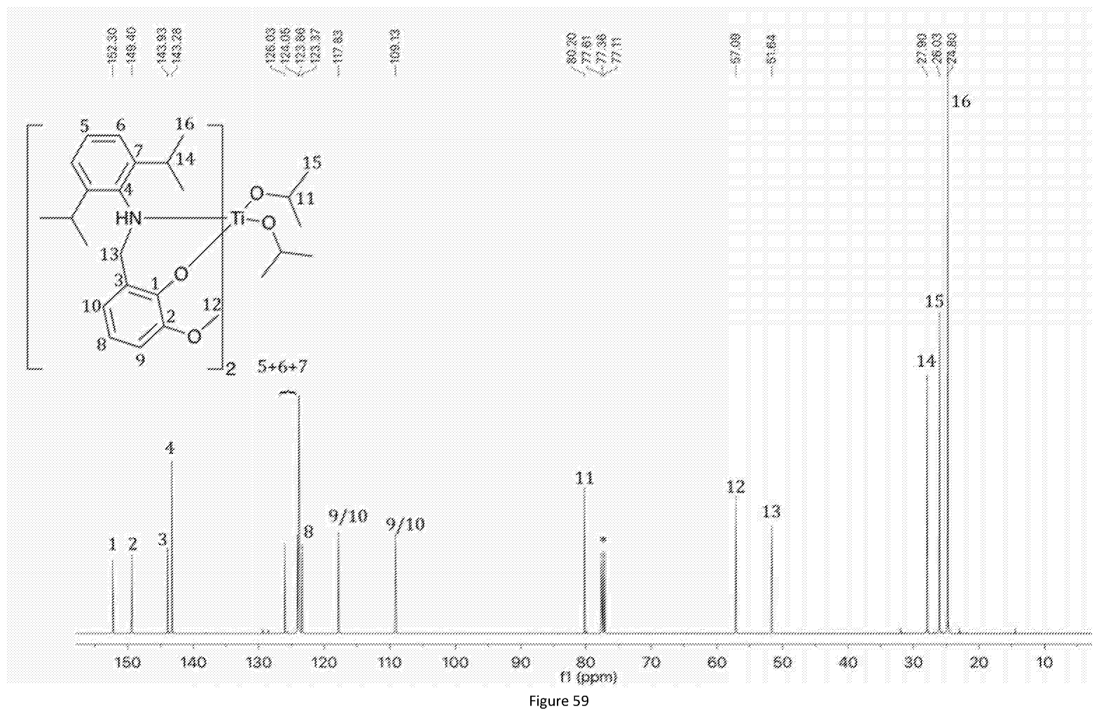

FIG. 59 shows the ¹³C{¹H} NMR spectrum of (L₄′)₂Ti(OⁱPr)₂ in CDCl₃ at 298 K.

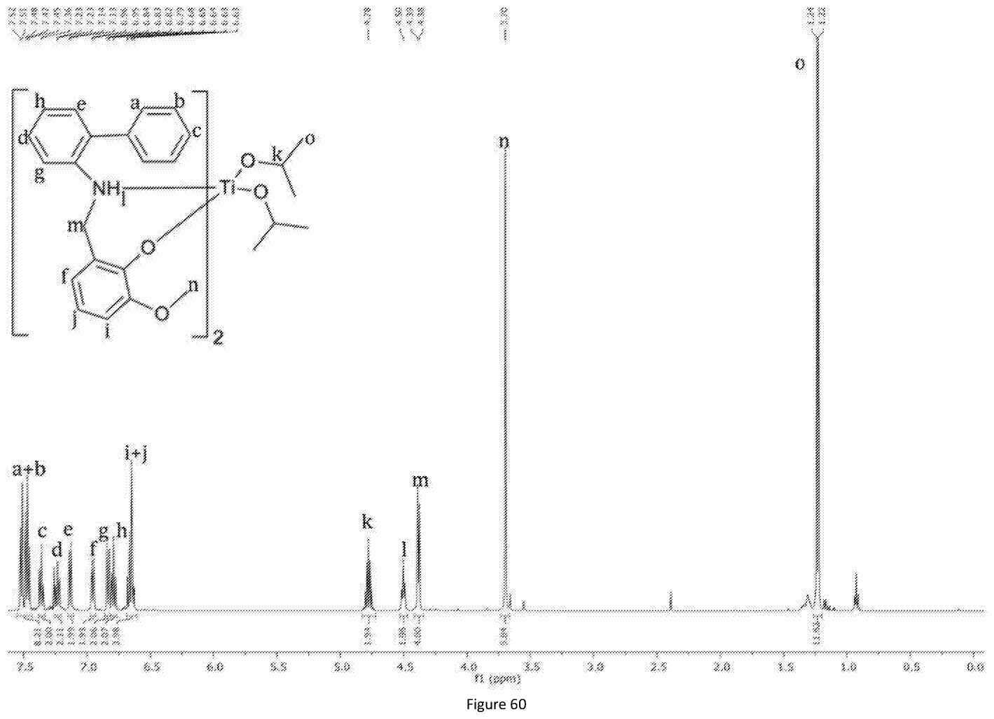

FIG. 60 shows the ¹H NMR spectrum of (L₅′)₂Ti(OⁱPr)₂ in CDCl₃ at 298 K.

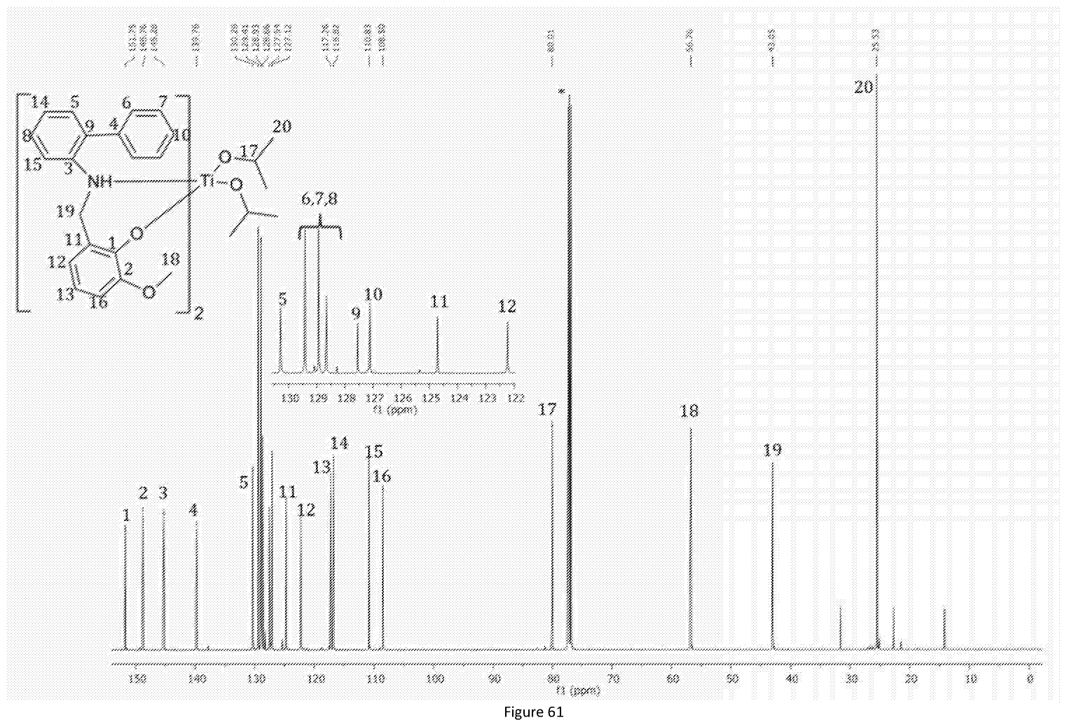

FIG. 61 shows the ¹³C{¹H} NMR spectrum of (L₅′)₂Ti(OⁱPr)₂ in CDCl₃ at 298 K.

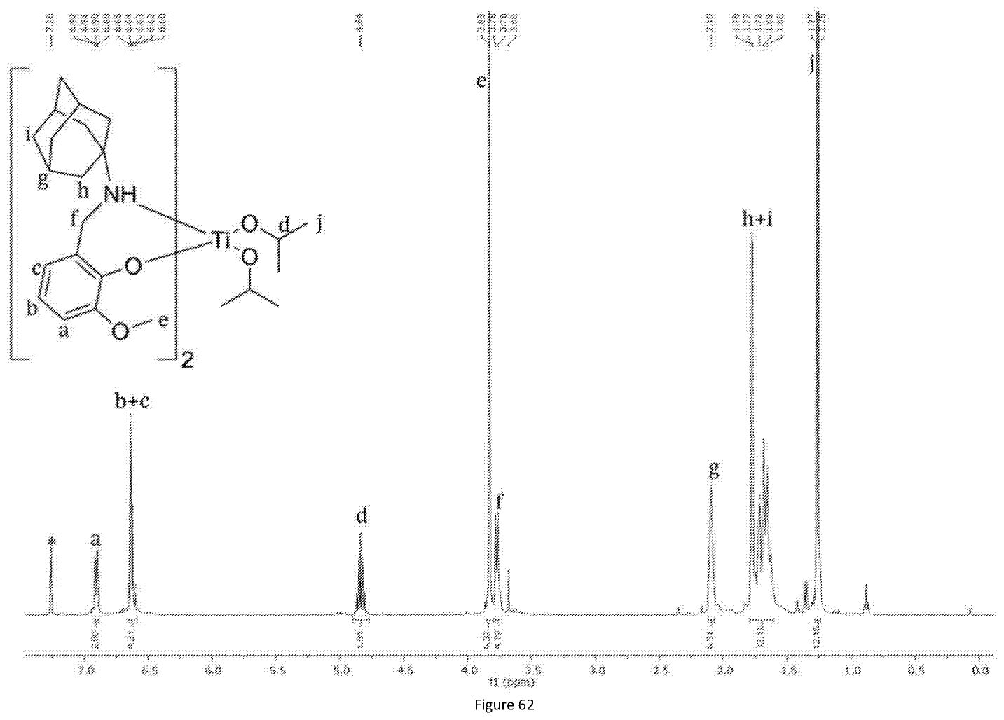

FIG. 62 shows the ¹H NMR spectrum of (L₆′)₂Ti(OⁱPr)₂ in CDCl₃ at 298 K.

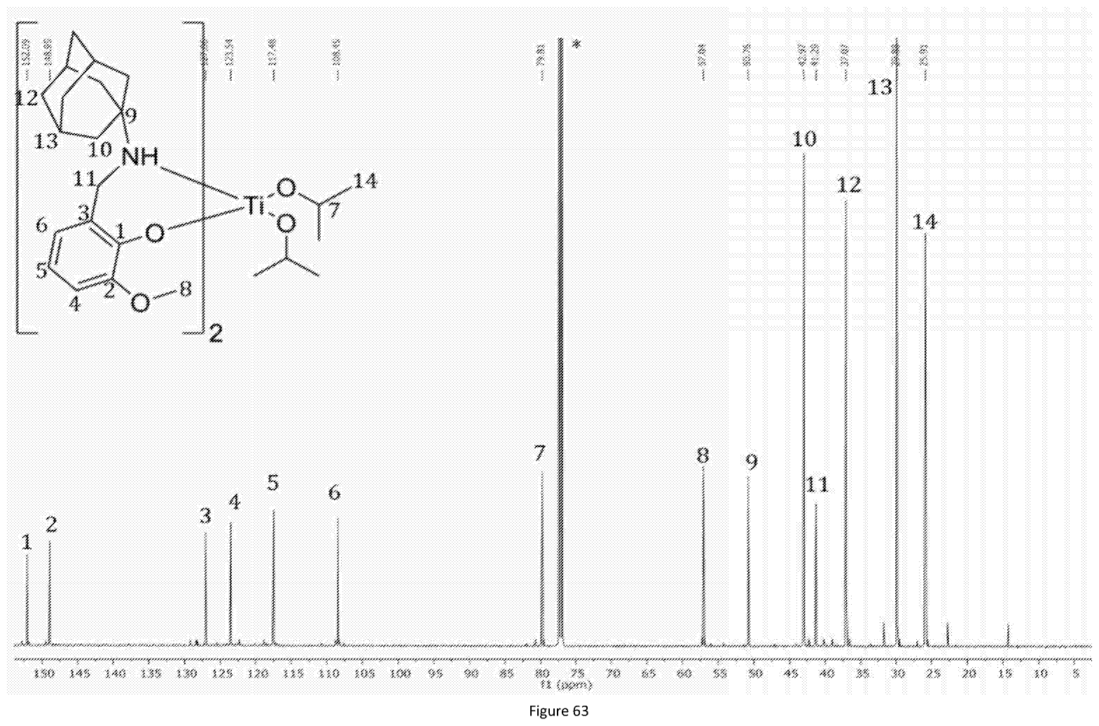

FIG. 63 shows the ¹³C{¹H} NMR spectrum of (L₆′)₂Ti(OⁱPr)₂ in CDCl₃ at 298 K.

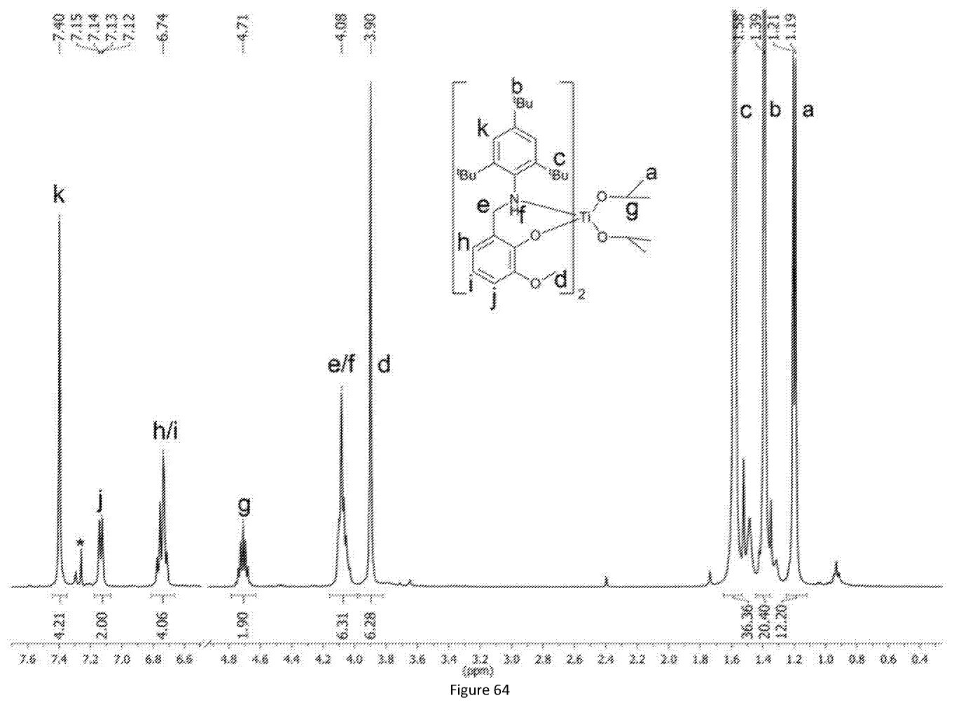

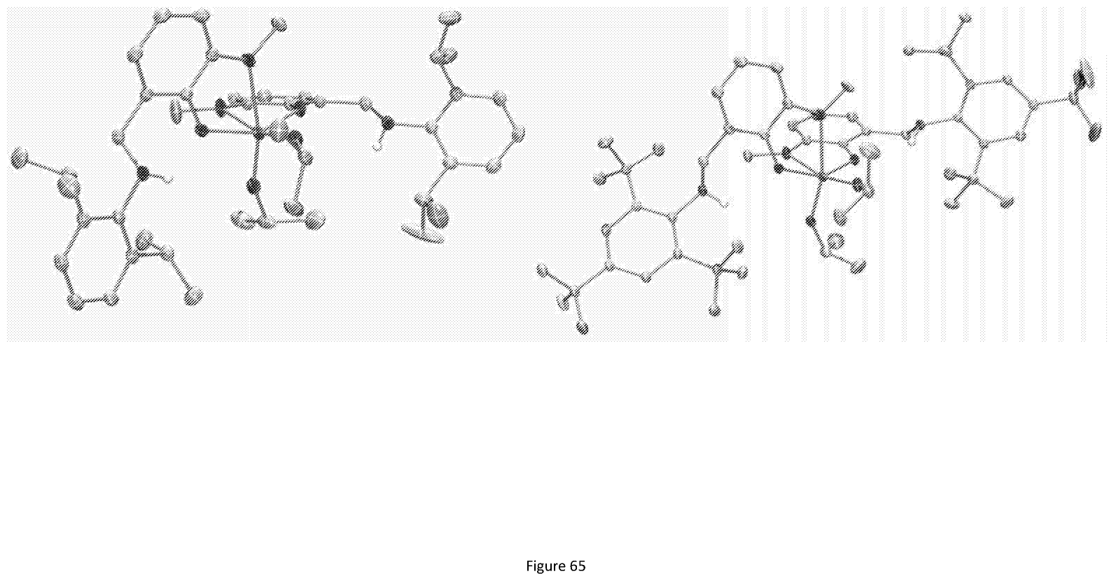

FIG. 64 shows the ¹H NMR spectrum of (L₇′)₂Ti(OⁱPr)₂ in CDCl₃ at 298 K. 400 MHz.

FIG. 65 shows X-ray crystal structures of (L₄′)₂Ti(OⁱPr)₂ (left) and (L₇′)₂Ti(OⁱPr)₂ (right) showing Type C coordination.

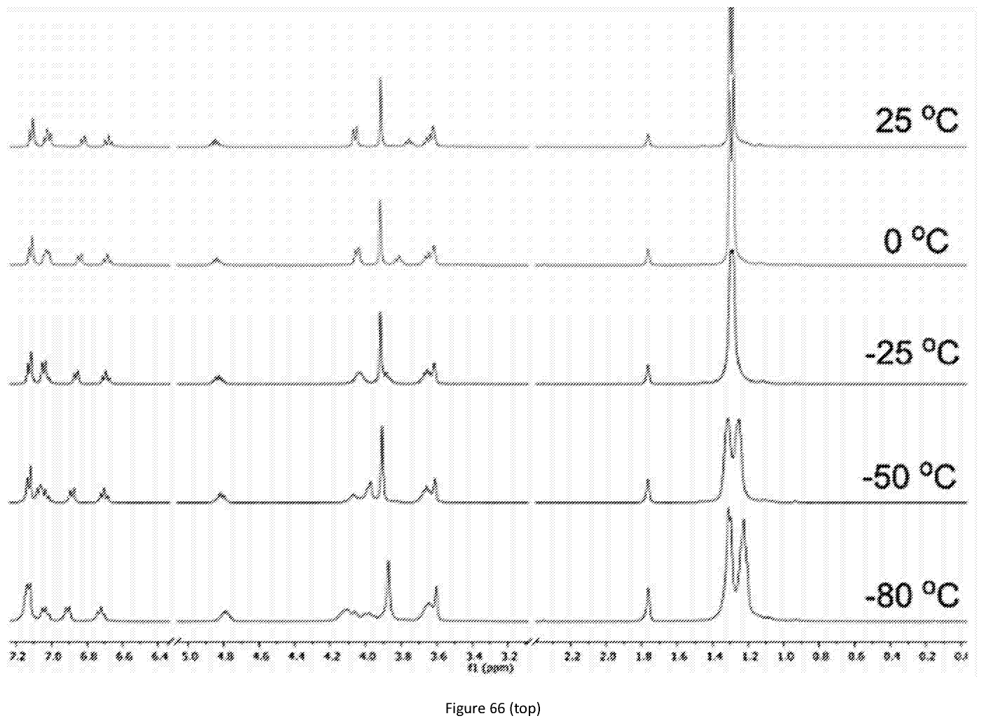

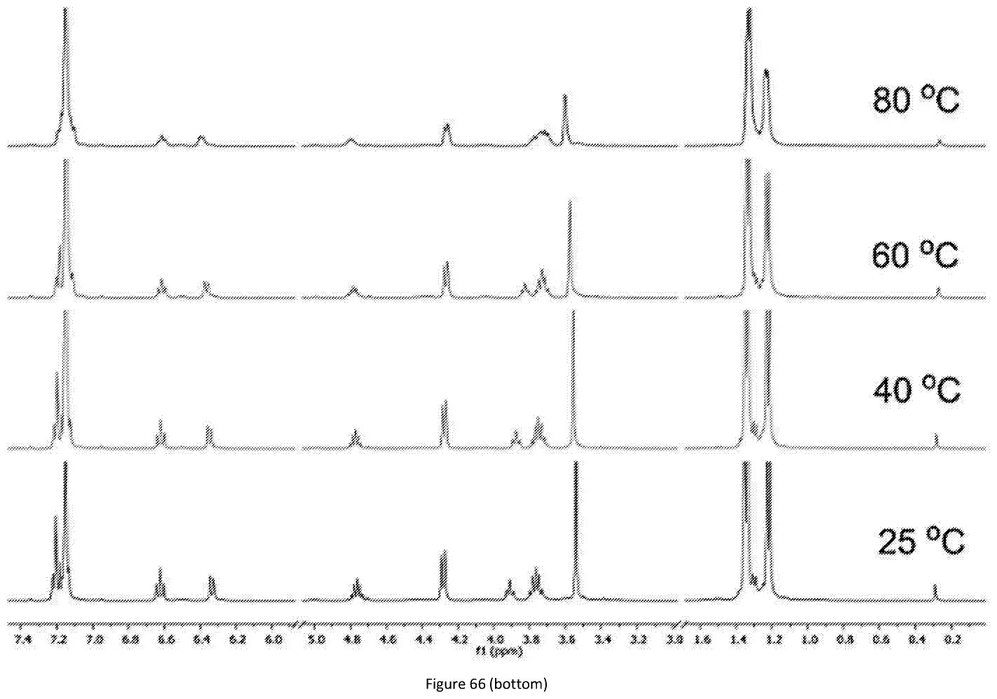

FIG. 66 shows low temperature ¹H NMR spectrum of complex (L₄′)₂Ti(OⁱPr)₂ in d⁸-THF (top) and high temperature ¹H NMR spectrum of complex (L₄′)₂Ti(OⁱPr)₂ (bottom) in C₆D₆.

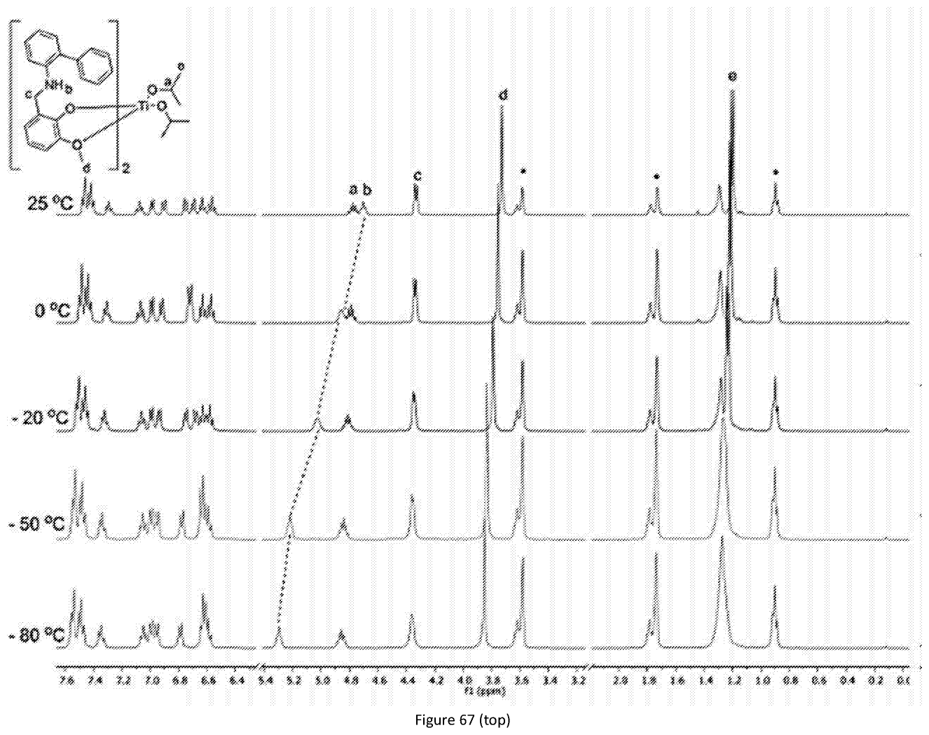

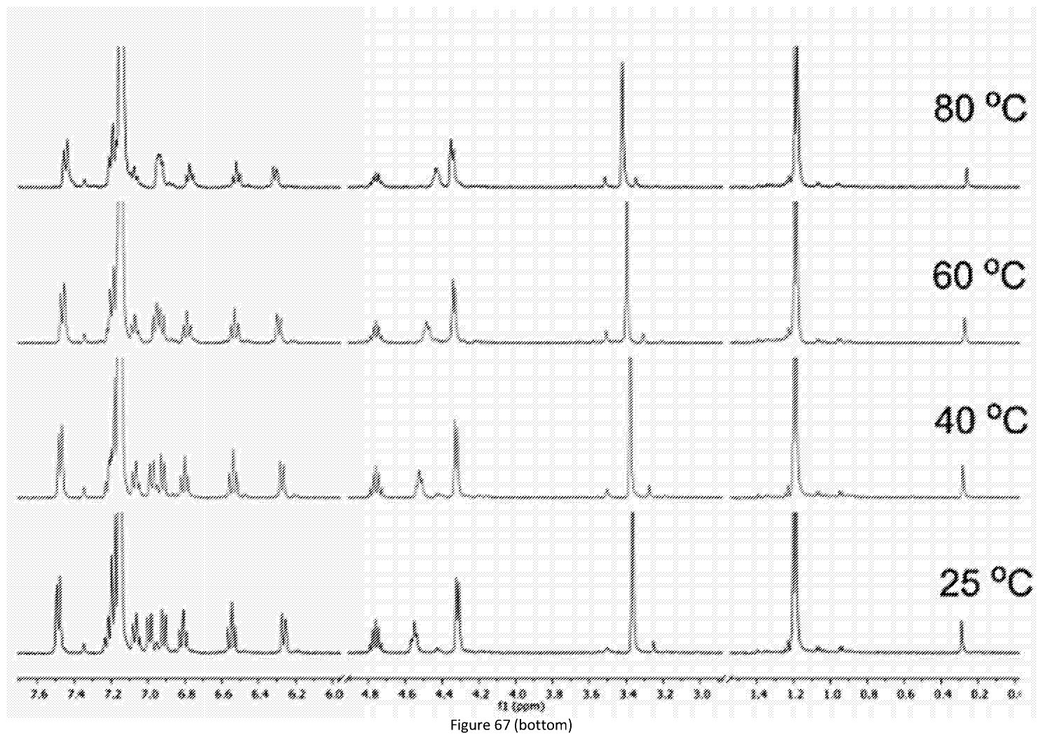

FIG. 67 shows Low temperature ¹H NMR of complex (L₅′)₂Ti(OⁱPr)₂ (shown in its conjectured structure) in THF-d⁸ (* THF or hexane) (top) and high temperature ¹H NMR of complex (L₅′)₂Ti(OⁱPr)₂ in C₆D₆ (bottom).

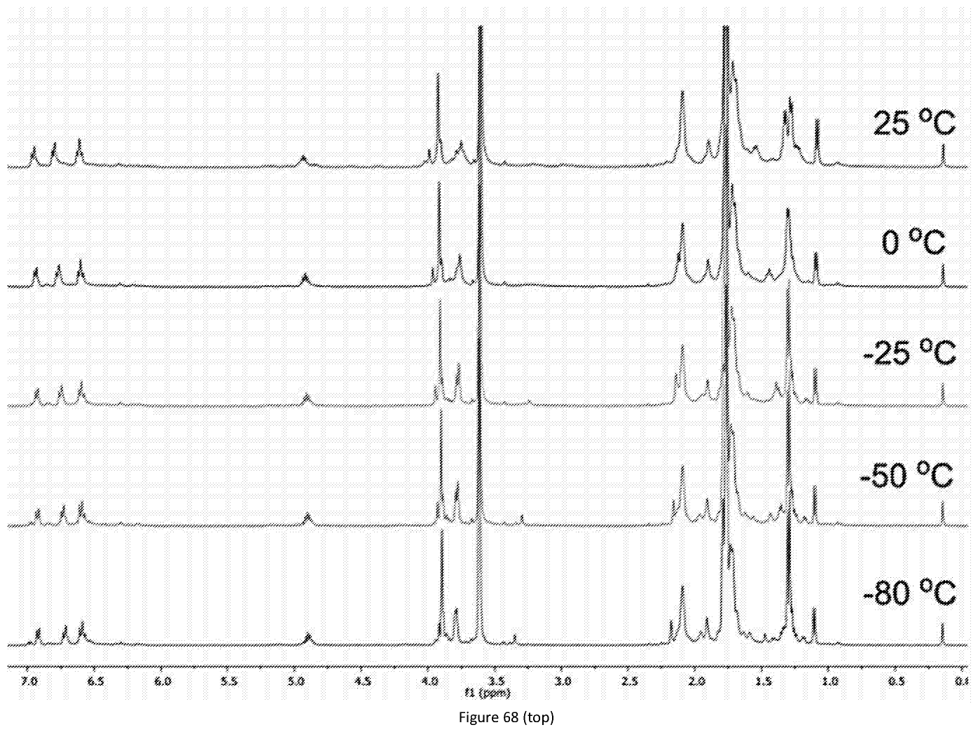

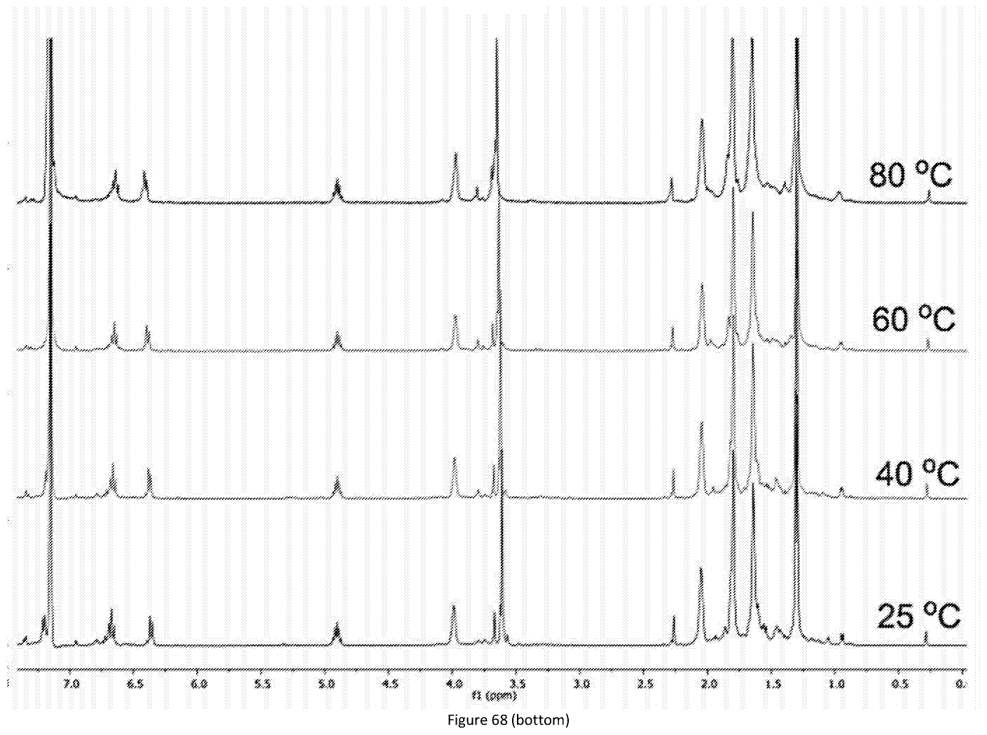

FIG. 68 shows Low temperature ¹H NMR spectrum of complex (L₆′)₂Ti(OⁱPr)₂ in d⁸-THF (top) and high temperature ¹H NMR of complex (L₆′)₂Ti(OⁱPr)₂ in C₆D₆ (bottom).

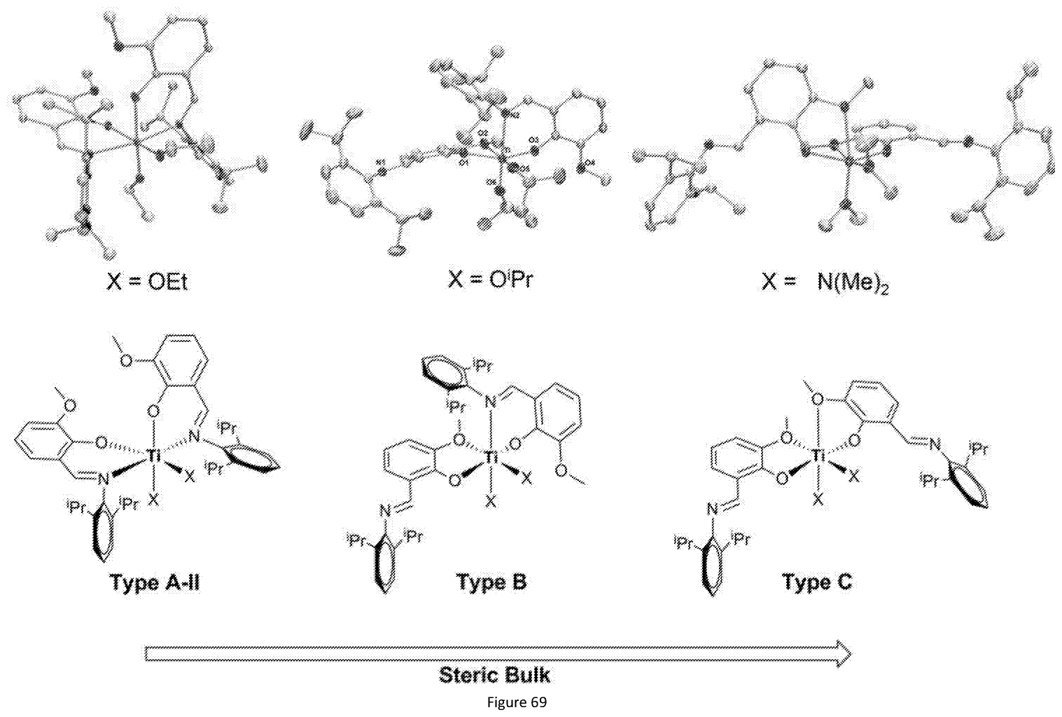

FIG. 69 shows X-ray crystal structures of (L₄)₂Ti(OEt)₂ (left), (L₄)₂Ti(OⁱPr)₂ (middle), and (L₄)₂Ti(NMe₂)₂ (right) showing the variability of coordination based on initiator.

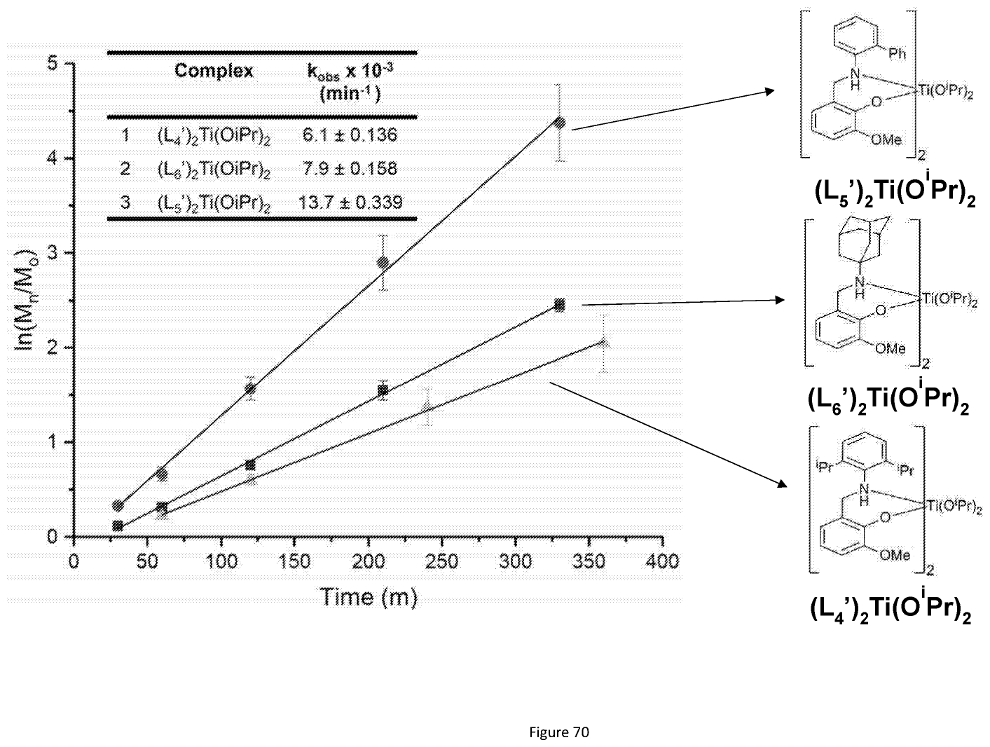

FIG. 70 shows kinetic plots of In([ε-CL]₀/[ε-CL]t) vs. time for complexes (L₄₋₆′)₂Ti(OⁱPr)₂. Conditions: [ε-CL]₀=1 M in toluene, [ε-CL][initiator]=200:1, 80° C.

### MATERIALS AND METHODS

All metal complexes were synthesized under anhydrous conditions, using MBraun gloveboxes and standard Schlenk techniques. Solvents and reagents were obtained from Sigma Aldrich or Strem and were used as received unless stated otherwise. THF and toluene were dried by refluxing over sodium and benzophenone and stored under nitrogen. ε-caprolactone and ω-pentadecalactone were dried over CaH₂ and fractionally distilled under nitrogen before use. All dry solvents were stored under nitrogen and degassed by several freeze-pump-thaw cycles. NMR spectra were recorded using a Bruker AV 400 or 500 MHz spectrometer. Correlation between proton and carbon atoms were obtained by COSY, HSQC, and HMBC spectroscopic methods and subsequently assigned. MALDI-ToF analysis was carried out on a Waters MALDI Micro MX instrument in positive ion mode. Samples were prepared by dissolving the desired molecule (10 mg/ml) and matrix (dithranol, 10 mg/ml) in THF. This mixture was spotted onto the MALDI plate and allowed to dry. Due to a high degree of fragmentation and the formation of clusters, only the M⁺-OⁱPr value is reported for metal complexes. Elemental analysis was carried out by Mr. Stephen Boyer of the London Metropolitan University.

Crystals suitable for single crystal x-ray diffraction were grown either through slow evaporation of hexanes into THF or through low temperature crystallization in concentrated THF at −30° C. Samples were isolated in a glovebox under a pool of fluorinated oil and mounted on MiTeGen MicroMounts. The crystal was then cooled to 150 K with an Oxford Cryosystems Cryostream nitrogen cooling device. Data collection was carried out with an Oxford Diffraction Supernova diffractometer using Cu Kα (λ=1.5417 Å) or Mo Kα (λ=0.7107 Å) radiation. The resulting raw data was processed using CrysAlisPro. Structures were solved by SHELXT and Full-matrix least-squares refinements based on F² were performed in SHELXL-14⁶, as incorporated in the WinGX package.⁷ For each methyl group, the hydrogen atoms were added at calculated positions using a riding model with U(H)=1.5 Ueq (bonded carbon atom). The rest of the hydrogen atoms were included in the model at calculated positions using a riding model with U(H)=1.2 Ueq (bonded atom). Neutral atom scattering factors were used and include terms for anomalous dispersion.⁸

### Part A

### Example 1—Ligand Synthesis

A variety of ligands, HL₁-HL₈, were prepared according to the general synthesis depicted in Scheme 1 shown below:

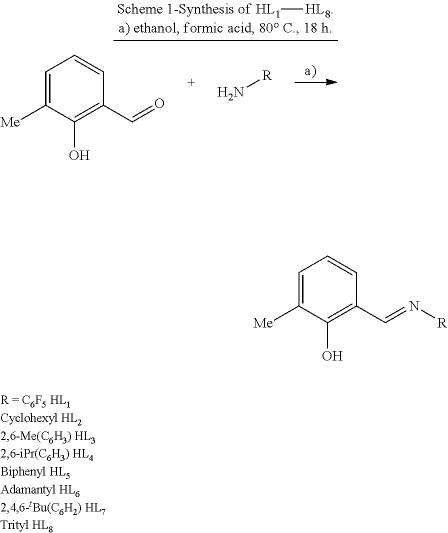

### Synthesis of HL₁

o-Vanillin (5 g, 32.9 mmol) was added to a round bottom flask and dissolved in ethanol (60 mL). 2,3,4,5,6-pentafluoroaniline (6.02 g, 32.9 mmol) was added into the stirring solution along with several drops of formic acid. This reaction mixture was refluxed for 72 hours resulting in a bright orange precipitate and a pale yellow solution. Precipitate was filtered, washed with ethanol (20 mL) and pentane (3×20 mL) and dried under vacuum. Crude product was then washed with hot ethanol (30 mL) and dried. Yield: 3.67 g (35%)¹H NMR (400 MHz, CDCl₃) δ (ppm): 12.58 (s, 1H), 8.85 (s, 1H), 7.05 (m, 2H), 6.93 (t, 1H), 3.94 (s, 3H).

FIG. 1 shows the ¹H NMR spectrum of HL₁ in CDCl₃ at 400 MHz.

### Synthesis of HL₂

o-Vanillin (2.75 g, 18.0 mmol) was added to a round bottom flask and dissolved in ethanol (30 mL). Cyclohexylamine (1.79 g, 18.0 mmol) was syringed into the stirring solution along with several drops of formic acid. Reaction mixture was refluxed for 18 hours resulting in an orange solution. Volatiles were removed under vacuum yielding a viscus yellow oil. The oil was placed in a −30° C. freezer to solidify into a soft yellow solid. Yield: 3.85 g (91%)¹H NMR (400 MHz, CDCl₃) δ (ppm): 8.29 (s, 1H), 6.88-6.82 (m, 2H), 6.73 (t, 1H), 3.87 (s, 3H), 3.28 (m, 1H), 1.81 (m, 4H), 1.62-1.32 (m, 6H).

FIG. 2 shows the ¹H NMR spectrum of HL₂ in CDCl₃ at 400 MHz.

### Synthesis of HL₃

o-Vanillin (3 g, 19.7 mmol) was added to a round bottom flask and dissolved in ethanol (30 mL). 2,6-dimethylaniline (2.34 g, 19.7 mmol) was syringed into the stirring solution along with several drops of formic acid. Reaction mixture was refluxed for 18 hours resulting in a yellow solution. Upon removal of several mL of ethanol under vacuum yellow solid precipitated from solution. This solid was filtered and washed with pentane (3×20 mL). The resulting dark yellow powder was dried to remove residual solvent. Yield: 3.57 g (71%)¹H NMR (400 MHz, CDCl₃) δ (ppm): 13.5 (bs, 1H), 8.35 (s, 1H), 7.12 (m, 2H), 7.04 (m, 2H), 6.97 (m, 1H), 6.91 (t, 1H), 3.96 (s, 3H), 2.21 (s, 6H).

FIG. 3 shows the ¹H NMR spectrum of HL₃ in CDCl₃ at 400 MHz.

### Synthesis of HL₄

o-Vanillin (3 g, 19.7 mmol) was added to a round bottom flask and dissolved in ethanol (30 mL). 2,6-diisopropylaniline (3.5 g, 19.7 mmol) was syringed into the stirring solution along with several drops of formic acid. Reaction mixture was refluxed for 18 hours resulting in an orange solution. Upon cooling to room temperature copious amounts of large orange crystals formed. These crystals were filtered, washed with pentane (3×20 mL) and dried under vacuum. Yield: 5.0 g (82%)¹H NMR (400 MHz, CDCl₃) δ (ppm): 13.5 (bs, 1H), 8.34 (s, 1H), 7.21 (m, 3H), 7.21-7.02 (m, 2H), 7.0 (t, 1H), 3.98 (s, 4H), 3.03, (sep, 2H), 1.20 (d, 12H).

FIG. 4 shows the ¹H NMR spectrum of HL₄ in CDCl₃ at 400 MHz.

### Synthesis of HL₅

o-Vanillin (5 g, 32.9 mmol) was added to a round bottom flask and dissolved in ethanol (25 mL). 2-aminobiphenyl (5.56 g, 32.9 mmol) was added to the stirring solution along with several drops of formic acid. The reaction mixture was refluxed for 24 hours resulting in a deep red solution. Volatiles were removed under vacuum. Yield: 8.06 g (81%). ¹H NMR (400 MHz, CDCl₃) δ (ppm): 12.9 (1H, bs), 8.60 (s, 1H), 7.43-7.36 (m, 8H), 7.22 (d, 1H), 6.96 (m, 2H), 6.86 (t, 1H), 3.88 (s, 3H).

FIG. 5 shows the ¹H NMR spectrum of HL₅ in CDCl₃ at 400 MHz.

### Synthesis of HL₆

o-Vanillin (3 g, 19.7 mmol) was added to a round bottom flask and dissolved in ethanol (30 mL). Adamantan-1-amine (2.98 g, 19.7 mmol) was then added to the stirring solution along with several drops of formic acid. Reaction mixture was refluxed for 20 hours resulting in an orange solution. Volatiles were removed under vacuum yielding an orange solid which was washed with pentane (20 mL×3) Yield: 3.67 g, (65%)¹H NMR (400 MHz, CDCl₃) δ (ppm): 15.16 (bs, 1H), 8.25 (s, 1H), 6.85 (m, 2H), 6.69 (t, 1h), 3.88 (s, 3H), 2.19 (m, 3H), 1.85 (d, 6H), 1.73 (m, 6H).

FIG. 6 shows the ¹H NMR spectrum of HL₆ in CDCl₃ at 400 MHz.

### Synthesis of HL₇

o-Vanillin (1.5 g, 9.86 mmol) was added to a round bottom flask and dissolved in ethanol (30 mL). 2,4,6-tritertbutylaniline (2.58 g, 9.86 mmol) was added into the stirring solution along with several drops of formic acid. Reaction mixture was refluxed for 18 hours resulting in an orange solution. Volatiles were removed under vacuum to yield a yellow solid which was recrystallized from hot ethanol (30 mL). The pure yellow crystalline product was washed with cold pentane (20 mL×3) and dried under vacuum. Yield: 2.8 g (71%)¹H NMR (400 MHz, CDCl₃) δ (ppm): 13.8 (s, 1H), 8.24 (s, 1H), 7.41 (s, 2H), 7.03 (m, 1H), 6.91 (m, 2H), 3.97 (s, 3H), 1.35 (s, 9H), 1.34 (s, 18H).

FIG. 7 shows the ¹H NMR spectrum of HL₇ in CDCl₃ at 400 MHz.

### Synthesis of HL₈

o-Vanillin (1.5 g, 9.86 mmol) was added to a round bottom flask and dissolved in ethanol (30 mL). tritylamine (2.56 g, 9.86 mmol) was added into the stirring solution along with several drops of formic acid. This reaction mixture was refluxed for 24 hours resulting in a bright yellow precipitate and a pale yellow solution. Precipitate was filtered, washed with ethanol (30 mL) and pentane (3×20 mL) and dried under vacuum. Yield: 3.65 g (94%)¹H NMR (400 MHz, CDCl₃) δ (ppm): 14.8 (s, 1H), 7.97 (s, 1H), 7.35-7.23 (m, 15H), 6.98 (dd, 1H), 6.82 (t, 1H), 6.78 (m, 1H), 3.97 (s, 3H).

FIG. 8 shows the ¹H NMR spectrum of HL₈ in CDCl₃ at 400 MHz.

### Example 2—Complex Synthesis

Using ligands HL₁-HL₈ prepared in Example 1, a variety of complexes, (L₁)₂Ti(OⁱPr)₂-(L₈)₂Ti(OⁱPr)₂, were prepared according to the general synthesis depicted in Scheme 2 shown below:

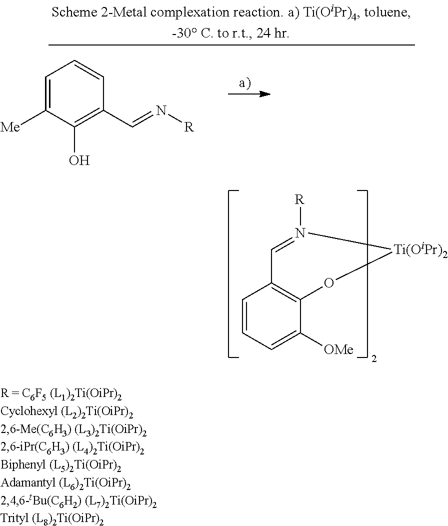

The o-vanillin derived ligands were found to possess two separate modes of coordination to the metal: 6-membered N,O coordination, and 5-membered O,O coordination. These two coordination modes were found to be independent of one another, thus the eight catalysts synthesized each exhibit one of three basic types of coordination chemistries found to be possible in these systems. Type A: N,O:N,O coordination, Type B: N,O:O,O coordination, Type C: O,O:O,O coordination. Within each type there are also additional isomers that are theoretically possible. Upon increasing steric bulk, coordination around the metal centre rearranges from: Type A-I to Type A-II, then to Type B followed by Type C. (Scheme 3).

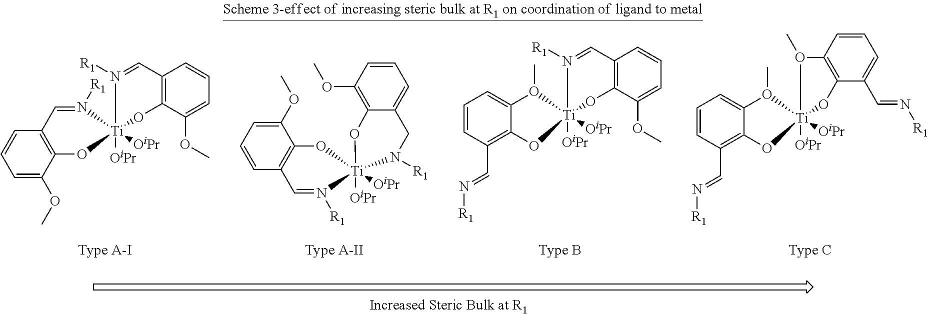

Synthesis of (L₁)₂Ti(OⁱPr)₂

HL₁ (0.50 g, 1.58 mmol) and Ti(OⁱPr)₄ (0.224 g, 0.79 mmol) were dissolved separately in toluene (7 mL and 3 mL, respectively), and cooled to −30° C. in a glovebox freezer. The two solutions were then mixed and allowed to stir for 18 hours. Volatiles were removed in vacuo yielding a bright orange solid. Yield: 316 mg (50%) MALDI-TOF MS (m/z): 739.64 (calc. for [M⁺-OⁱPr=739.077])¹H NMR (400 MHz, CDCl₃) δ (ppm): 8.23 (bs, 2H), 7.16 (bm, 4H), 6.93 (t, 2H), 4.88 (m, 2H), 3.82 (s, 6H), 1.17 (d, 12H). ¹³C{¹H} (125 MHz, CDCl₃) δ (ppm): 171.4, 156.4, 149.5, 141.7, 139.3, 137.3, 136.4, 127.7, 126.2, 121.1, 117.3, 80.7, 56.3, 25.1 C₃₄H₂₈F₁₀N₂O₆Ti (798.45 g/mol) Calculated: C, 51.15; H, 3.53; N, 3.51%. Found: C, 51.03; H, 3.39; N, 3.66%.

FIG. 9 shows the ¹H NMR spectrum of (L₁)₂Ti(OⁱPr)₂ in CDCl₃ at 400 MHz.

FIG. 10 shows the ¹³C{¹H} NMR spectrum of (L₁)₂Ti(OⁱPr)₂ in CDCl₃ at 125 MHz.

FIG. 11 shows the ORTEP representation of (L₁)₂Ti(OⁱPr)₂. (L₁)₂Ti(OⁱPr)₂ crystallize in the centrosymmetric space group P-1 and adopt Type A-I coordination, with imine nitrogens in a cis arrangement. Due to the low steric pressure exerted around the titanium metal centre by R₁=C₆F₅ this complex prefers the coordination mode typically seen in salicylaldehyde derivatives. The coordination is reinforced by the electron deficient C₆F₅ substituent 7ε-stacking with the adjacent Ph-OMe substituent, with an average difference between rings of 3.10 Å.

Synthesis of (L₂)₂Ti(OⁱPr)₂

HL₂ (0.30 g, 1.29 mmol) and Ti(OⁱPr)₄ (0.183 g, 0.643 mmol) were dissolved separately in toluene (15 mL and 5 mL, respectively), and cooled to −30° C. in a glovebox freezer. The two solutions were then mixed and allowed to stir for 24 hours turning from yellow to light orange. Volatiles were removed in vacuo and hexane (30 mL) was added to the resulting orange-yellow wax. Crude mixture was recrystallized from a minimum of THF in a −30° C. freezer. Crude Yield: 332 mg (82%) MALDI-TOF MS (m/z): 571.3003 (calc. for [M⁺-OⁱPr=571.2651])¹H NMR (400 MHz, CDCl₃) δ (ppm): 8.10 (bs, 2H), 6.87 (m, 2H), 6.81 (m, 2H), 6.67 (t, 2H), 3.86 (s, 6H), 2.07 (m, 2H), 1.85-0.88 (m, 30H), 0.36 (m, 2H). C₃₄H₅₀N₂O₆Ti (630.65 g/mol) Calculated: C, 64.75; H, 7.99; N, 4.44%. Found: C, 64.90; H, 8.05; N, 4.32%.

FIG. 12 shows the ¹H NMR spectrum of (L₂)₂Ti(OⁱPr)₂ in CDCl₃ at 400 MHz.

FIG. 13 shows the ORTEP representation of (L₂)₂Ti(OⁱPr)₂. (L₂)₂Ti(OⁱPr)₂ crystallize in the centrosymmetric space group P-1 and adopt Type A-I coordination, with imine nitrogens in a cis arrangement. Due to the low steric pressure exerted around the titanium metal centre by R₁=Cy this complex prefers the coordination mode typically seen in salicylaldehyde derivatives.

Synthesis of (L₃)₂Ti(OⁱPr)

HL₃ (0.246 g, 0.964 mmol) and Ti(OⁱPr)₄ (0.137 g, 0.482 mmol) were dissolved separately in toluene (15 mL and 5 mL, respectively), and cooled to −30° C. in a glovebox freezer. The two solutions were then mixed and allowed to stir for 24 hours. Volatiles were removed in vacuo and hexane (10 mL) was added to the resulting orange-yellow wax. This hexane was removed under vacuum to provide the final complex as a bright orange powder. Yield: 327 mg (99%). MALDI-TOF MS (m/z): 615.3101 (calc. for [M⁺-OⁱPr=615.2338])¹H NMR (400 MHz, CDCl₃) δ (ppm): 8.18 (s, 2H), 7.3 (m, 1H)*, 6.91-6.86 (m, 9H), 6.70 (t, 2H), 4.82 (m, 2H), 4.00 (s, 6H), 2.14 (s, 12H), 1.11 (d, 12H) ¹³C{¹H} (125 MHz, CDCl₃) δ (ppm): 156.2, 151.6, 149.5, 129.0, 128.7, 128.2, 127.6, 124.0, 121.9, 116.6, 80.1, 56.8, 25.4, 18.5 C₃₈H₄₆N₂O₆Ti (674.28 g/mol) Calculated: C, 67.65; H, 6.87; N, 4.15%. Found: C, 67.42; H, 6.89; N, 4.22%.

FIG. 14 shows the ¹H NMR spectrum of (L₃)₂Ti(OⁱPr)₂ in CDCl₃ at 400 MHz

FIG. 15 shows the ¹³C{¹H} NMR spectrum of (L₃)₂Ti(OⁱPr)₂ in CDCl₃ at 125 MHz.

FIG. 16 shows the ORTEP representation of (L₃)₂Ti(OⁱPr)₂. Upon increasing steric hindrance to form (L₃)₂Ti(OⁱPr)₂ a rearrangement is observed from Type A-I to Type A-II where imine nitrogens prefer a trans geometry. In this arrangement, steric pressure is relieved by creating space between R groups while still maintaining O,N:O,N coordination. As a result of this rearrangement, the Ti—N bond distances shorten and Ti—O distances elongate by ˜0.08 Å compared to (L₂)₂Ti(OⁱPr)₂.

Synthesis of (L₄)₂Ti(OⁱPr)

HL₄ (0.30 g, 0.946 mmol) and Ti(OⁱPr)₄ (0.137 g, 0.482 mmol) were dissolved separately in toluene (15 mL and 5 mL, respectively), and cooled to −30° C. in a glovebox freezer. The two solutions were then mixed and allowed to stir for 24 hours. Volatiles were removed in vacuo and hexane (10 mL) was added to the resulting orange-yellow wax. This hexane was removed under vacuum to provide the final complex as a bright orange powder. Yield: 176 mg (46%) MALDI-TOF MS (m/z): 727.5702 (calc. for [M⁺-OⁱPr=727.3590])¹H NMR (400 MHz, CDCl₃) δ (ppm): 8.59 (s, 2H), 7.67 (bs, 2H), 7.15 (m, 6H), 6.91 (d, 2H), 6.80 (t, 2H), 4.76 (m, 2H), 3.97 (s, 6H), 3.10 (bs, 4H), 1.19-1.15 (d, 38H) ¹³C{¹H} (125 MHz, CDCl₃) δ (ppm): 159.9, 155.7, 150.0, 149.6, 138.3, 122.9, 121.9, 120.9, 117.3, 112.9, 80.6, 56.9, 27.8, 25.5, 23.7. C₄₆H₆₂N₂O₆Ti (786.9 g/mol): Calculated: C, 70.22; H, 7.94; N, 3.56%. Found: C, 70.17; H, 8.02; N, 3.56%.

FIG. 17 shows the ¹H NMR spectrum of (L₄)₂Ti(OⁱPr)₂ in CDCl₃ at 400 MHz.

FIG. 18 shows the ¹³C{¹H} NMR spectrum of (L₄)₂Ti(OⁱPr)₂ in CDCl₃ at 125 MHz.

FIG. 19 shows the ORTEP representation of (L₄)₂Ti(OⁱPr)₂. (L₄)₂Ti(OⁱPr)₂ crystallizes in the chiral orthorhombic space group Pna2₁ and adopts Type B coordination with one nitrogen trans to OⁱPr and one detached, in favour of O—O coordination through the o-methoxy group. Due to the formation of a five-membered ring, the O(1)-Ti—O(2) bite angle is far more acute, at 72.92(8°), than the O(3)-Ti—N(2) bite angle, which is similar to that seen in (L₂)₂Ti(OⁱPr)₂, at 80.72(9°). Additionally, Ti—OⁱPr distances are significantly shorter than in Type A by ca. 0.05 Å, and the bound imine moiety is 0.02 Å shorter than the unbound imine, which is expected.

Synthesis of (L₅)₂Ti(OⁱPr)

HL₅ (2 g, 6.60 mmol) and Ti(OⁱPr)₄ (0.937 g, 3.30 mmol) were dissolved separately in toluene (15 mL and 5 mL, respectively), and cooled to −30° C. in a glovebox freezer. The two solutions were then mixed and allowed to stir for 24 hours. Volatiles were removed in vacuo yielding an amber solid. Crude mixture was recrystallized by layering hexanes and THF. Yield: 2.28 g (89%). MALDI-TOF MS (m/z): 712.2714 (calc. for [M⁺-OⁱPr]=711.2338)¹H NMR (400 MHz, CDCl₃) δ (ppm): 8.36 (bs, 2H), 7.23 (m, 18H), 6.78 (bm, 2H), 6.60 (m, 2H), 4.87 (bm, 2H), 3.71 (s, 6H), 1.17 (m, 12H).

FIG. 20 shows the ORTEP representation of (L₅)₂Ti(OⁱPr)₂. (L₅)₂Ti(OⁱPr)₂ crystallizes in the centrosymmetric space group P2₁/n and adopts Type B coordination with one nitrogen trans to OⁱPr and one detached, in favour of O—O coordination through the o-methoxy group. Due to the formation of a five-membered ring, the O(1)-Ti—O(2) bite angle is far more acute, at 72.92(8°), than the O(3)-Ti—N(2) bite angle, which is similar to that seen in (L₂)₂Ti(OⁱPr)₂, at 80.72(9°). Additionally, Ti—OⁱPr distances are significantly shorter than in Type A by ca. 0.05 Å, and the bound imine moiety is 0.02 Å shorter than the unbound imine, which is expected.

Synthesis of (L₆)₂Ti(OⁱPr)

HL₆ (1.193 g, 3.03 mmol) and Ti(OⁱPr)₄ (0.429 g, 1.51 mmol) were dissolved separately in toluene (15 mL and 5 mL, respectively), and cooled to −30° C. in a glovebox freezer. The two solutions were then mixed and allowed to stir for 24 hours. Volatiles were removed in vacuo yielding a light yellow powder. Crude mixture was recrystallized by layering hexanes and THF. Yield: 1.29 g (90%) MALDI-TOF MS (m/z): 675.9662 (calc. for [M⁺-OⁱPr]=675.3277)¹H NMR (400 MHz, CDCl₃) δ (ppm): 8.77 (s, 2H), 7.54 (dd, 2H), 6.72 (m, 4H), 4.90 (m, 2), 3.77 (s, 6H), 2.16 (s, 6H). 1.85 (s, 12H), 1.73 (m, 12H), 1.33 (d, 12H). ¹³C{¹H} (125 MHz, CDCl₃) δ (ppm): 154.1, 152.1, 149.3, 123.0, 120.1, 117.5, 111.1, 80.3, 57.9, 57.0, 43.4, 36.7, 29.8, 25.5.

FIG. 21 shows the ¹H NMR spectrum of (L₆)₂Ti(OⁱPr)₂ in CDCl₃ at 400 MHz.

FIG. 22 shows the ¹³C{¹H} NMR spectrum of (L₆)₂Ti(OⁱPr)₂ in CDCl₃ at 125 MHz.

FIG. 23 shows the ORTEP representation of (L₆)₂Ti(OⁱPr)₂. (L₆)₂Ti(OⁱPr)₂ crystallizes in a centrosymmetric space group and adopts Type C coordination, where steric bulk forces O,O chelation of both ligands. (L₆)₂Ti(OⁱPr)₂ shows O—Ti—O bite angles similar to those found in (L₄)₂Ti(OⁱPr)₂ at 73.67(5)° [O(1)-Ti—O(2)] and 73.99(5)° [O(3)-Ti—O(4)]. OⁱPr moieties arrange trans to the neutral OMe groups and Ti—OⁱPr distances are shorter than those found Type A and B complexes. (Table 1) Both Imine C═N bonds are ca. 1.27 Å as expected.

Synthesis of (L₇)₂Ti(OⁱPr)

HL₇ (0.40 g, 1.01 mmol) and Ti(OⁱPr)₄ (0.144 g, 0.51 mmol) were dissolved separately in toluene (7 mL and 3 mL, respectively), and cooled to −30° C. in a glovebox freezer. The two solutions were then mixed and allowed to stir for 18 hours. Volatiles were removed in vacuo yielding an orange solid. Yield: 176 mg (46%) MALDI-TOF MS (m/z): 896.6176 (calc. for [M⁺-OⁱPr]=895.5468)¹H NMR (400 MHz, CDCl₃) δ (ppm): 8.71 (s, 2H), 7.82 (m, 2H), 7.39 (s, 4H), 6.84 (m, 4H), 4.60 (m, 2H), 3.82 (s, 6H), 1.37 (s, 36H), 1.35 (s, 18H), 1.11 (d, 12H). ¹³C{¹H} (125 MHz, CDCl₃) δ (ppm): 157.8, 155.3, 151.4, 149.9, 143.6, 138.4, 121.7, 120.7, 117.7, 111.7, 80.7, 56.9, 36.0, 34.8, 31.7 31.5, 25.5. C₅₈H₈₆N₂O₆Ti (955.20 g/mol) Calculated: C, 72.93; H, 9.08; N, 2.93%. Found: C, 72.81; H, 9.17; N, 3.12%.

FIG. 24 shows the ¹H NMR spectrum of (L₇)₂Ti(OⁱPr)₂ in CDCl₃ at 400 MHz.

FIG. 25 shows the ¹³C{¹H} NMR spectrum of (L₇)₂Ti(OⁱPr)₂ in CDCl₃ at 125 MHz.

FIG. 26 shows the ORTEP representation of (L₇)₂Ti(OⁱPr)₂. (L₇)₂Ti(OⁱPr)₂ crystallizes in a centrosymmetric space group and adopts Type C coordination, where steric bulk forces O,O chelation of both ligands. OⁱPr moieties arrange trans to the neutral OMe groups and Ti—OⁱPr distances are shorter than those found Type A and B complexes. (Table 1) Both Imine C═N bonds are ca. 1.27 Å as expected.

Synthesis of (L₈)₂Ti(OⁱPr)

HL₈ (2.04 g, 5.18 mmol) was suspended in toluene (20 mL) and THF (5 mL) and Ti(OⁱPr)₄ (0.736 g, 2.59 mmol) dissolved in toluene (5 mL) was added dropwise. The yellow suspension cleared after several minutes of stirring and allowed to react for 24 hours. Volatiles were removed in vacuo yielding a light yellow solid. Yield: 2.32 (94%) MALDI-TOF MS (m/z): 891.3367 (calc. for [M⁺-OⁱPr]=891.3277)¹H NMR (400 MHz, CDCl₃) δ (ppm): 8.40 (s, 2H), 7.91 (dd, 2H), 7.32-7.23 (m, 30H), 6.72 (m, 4H), 4.59 (m, 2H), 3.64 (s, 6H), 1.06 (d, 12H). ¹³C{¹H} (125 MHz, CDCl₃) δ (ppm): 156.2, 154.8, 149.3, 146.4, 129.9, 127.6, 126.6, 125.3, 122.5, 120.3, 117.4, 111.1, 80.3, 78.4, 56.9, 25.5. C₆₀H₅₈N₂O₆Ti (951.00 g/mol) Calculated: C, 75.78; H, 6.15; N, 2.95%. Found: C, 75.88; H, 6.24; N, 3.03%.

FIG. 27 shows the ¹H NMR spectrum of (L₈)₂Ti(OⁱPr)₂ in CDCl₃ at 400 MHz.

FIG. 28 shows the ¹³C{¹H} NMR spectrum of (L₈)₂Ti(OⁱPr)₂ in CDCl₃ at 125 MHz.

FIG. 29 shows the ORTEP representation of (L₈)₂Ti(OⁱPr)₂. (L₈)₂Ti(OⁱPr)₂ crystallizes in a centrosymmetric space group and adopts Type C coordination, where steric bulk forces O,O chelation of both ligands. OⁱPr moieties arrange trans to the neutral OMe groups and Ti—OⁱPr distances are shorter than those found Type A and B complexes. (Table 1) Both Imine C═N bonds are ca. 1.27 Å as expected.

Using ligands HL₂ and HL₃ prepared in Example 1, complexes (L₂)₂ZrCl₂ and (L₃)₂ZrCl₂ were prepared according to the general synthesis depicted in Scheme 4 shown below

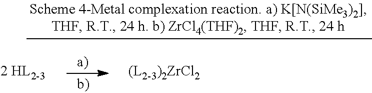

Synthesis of (L₂)₂ZrCl₂

HL₂ (0.40 g, 1.71 mmol) and K[N(SiMe₃)₂] (0.342 g, 1.71 mmol) were dissolved separately in THF (5 mL and 3 mL, respectively). The K[N(SiMe₃)₂] solution was then added dropwise to the stirring solution of ligand and allowed to react for 24 hours. ZrCl₄(THF)₂ (0.323 g, 0.857 mmol) was dissolved in THF (5 mL) and added to the deprotonated ligand. After stirring for 24 hours the resulting cloudy yellow solution was centrifuged and the solution was decanted. Volatiles were removed in vacuo and hexane (10 mL) was added to the resulting yellow wax. This hexane was removed under vacuum to provide the final complex as a light powder. MALDI-TOF MS (m/z): 589.1416 (calc. for [M⁺-Cl=589.1411])¹H NMR (400 MHz, CDCl₃) δ (ppm): 8.18 (s, 2H), 7.06 (m, 2H), 6.89 (t, 2H), 6.87 (m, 2H), 4.16 (m, 2H), 3.98 (s, 6H), 3.74 (m, 4H, THF), 1.85 (m, 4H, THF), 1.59-1.07 (bm, 20H). Calculated: C, 53.66; H, 5.79; N, 4.47%. C, 53.78; H, 5.80; N, 4.31%.

FIG. 30 shows the ¹H NMR spectrum of (L₂)₂ZrCl₂ in CDCl₃ at 400 MHz.

Synthesis of (L₃)₂ZrCl₂

HL₃ (0.246 g, 0.964 mmol) and K[N(SiMe₃)₂] (0.192 g, 0.964 mmol) were dissolved separately in THF (5 mL and 3 mL, respectively). The K[N(SiMe₃)₂] solution was then added dropwise to the stirring solution of ligand and allowed to react for 24 hours. ZrCl₄(THF)₂ (0.182 g, 0.482 mmol) was dissolved in THF (5 mL) and added to the deprotonated ligand. After stirring for 24 hours the resulting cloudy yellow solution was centrifuged and the solution was decanted. Volatiles were removed in vacuo and hexane (10 mL) was added to the resulting yellow wax. This hexane was removed under vacuum to provide a light powder, which could be recrystallized by layering of hexanes and THF. Yield: 0.282 mg, 87.3%. MALDI-TOF MS (m/z): 633.1627 (calc. for [M⁺-Cl=633.1098])¹H NMR (400 MHz, CDCl₃) δ (ppm): 8.33 (s, 2H), 7.09 (m, 6H), 7.06 (d, 2H), 7.0 (d, 2H), 6.90 (t, 2H), 3.78 (s, 6H), 2.45 (s, 12H).

FIG. 31 shows the ¹H NMR spectrum of (L₃)₂ZrCl₂ in CDCl₃ at 400 MHz.

### Example 3—Crystallographic Studies

Table 1 below provides a summary of the T-O distances in complexes (L₁)₂Ti(OⁱPr)₂-(L₈)₂Ti(OⁱPr)₂.

TABLE 1
Summary of T-O distances in complexes
(L₁)₂Ti(OⁱPr)₂—(L₈)₂Ti(OⁱPr)₂

| | Ti—OⁱPr(1) | Ti—OⁱPr(2) | Coordination |
|---|---|---|---|
| Compound | Dist. (Å) | Dist. (Å) | Type |
| (L₁)₂Ti(OⁱPr)₂ | 1.847(2) | 1.834(2) | A-I |
| (L₂)₂Ti(OⁱPr)₂* | 1.77 | 1.81 | A-I |
| (L₃)₂Ti(OⁱPr)₂ | 1.795(1) | 1.803(1) | A-II |
| (L₄)₂Ti(OⁱPr)₂ | 1.77 | 1.786(2) | B |
| (L₅)₂Ti(OⁱPr)₂ | 1.787(1) | 1.800(1) | B |
| (L₆)₂Ti(OⁱPr)₂ | 1.760(2) | 1.785(2) | C |
| (L₅)₂Ti(OⁱPr)₂ | 1.758(2) | 1.776(2) | C |
| (L₈)₂Ti(OⁱPr)₂ | 1.774(2) | 1.780(2) | C |

*An average is given between the two enantiomers in the asymmetric unit

Table 2 below provides select crystallographic details for (L₁)₂Ti(OⁱPr)₂-(L₄)₂Ti(OⁱPr)₂.

TABLE 2
Select crystallographic details for (L₁)₂Ti(OⁱPr)₂—(L₄)₂Ti(OⁱPr)₂

| Compound | (L₁)₂Ti(OⁱPr)₂ | | (L₂)₂Ti(OⁱPr)₂ | | (L₃)₂Ti(OⁱPr)₂ | | (L₄)₂Ti(OⁱPr)₂ | |
|---|---|---|---|---|---|---|---|---|
| Chemical formula | C₃₄H₂₈F₁₀N₂O₆Ti | | C₃₇H₅₇N₂O₆Ti | | C₃₈H₄₆N₂O₆Ti | | C₄₆H₆₂N₂O₆Ti | |
| Formula weight | 798.48 | | 673.74 | | 674.67 | | 786.87 | |
| Temp (K) | 150(2) | | 150(2) | | 150(2) | | 150(2) | |
| Space group | Triclinic, P-1 | | Triclinic, P-1 | | Triclinic, P-1 | | Orthorhombic, Pna2₁ | |
| a (Å) | 13.7054(3) | | 10.9508(3) | | 10.2329(3) | | 23.3761(6) | |
| b (Å) | 14.1810(4) | | 13.4552(4) | | 10.4196(2) | | 13.2107(3) | |
| c (Å) | 19.1110(5) | | 14.3513(4) | | 18.4022(5) | | 14.8217(4) | |
| α (°) | 110.121(2) | | 103.976(3) | | 79.916(2) | | | |
| β (°) | 102.985(2) | | 105.987(2) | | 79.572(2) | | | |
| γ (°) | 91.205(2) | | 109.032(3) | | 66.375(2) | | | |
| V (Å³) | 3378.78(16) | | 1790.69(10) | | 1755.88(8) | | 4577.2(2) | |
| Z | 4 | | 2 | | 2 | | 4 | |
| D_{calcd} (Mg/m³) | 1.570 | | 1.250 | | 1.275 | | 1.142 | |
| Crystal size (mm) | 0.27 × 0 20 × 0.08 | | 0.25 × 0.20 × 0.06 | | 0.25 × 0.25 × 0.15 | | 0.25 × 0.15 × 0.08 | |
| Theta range for | 3.555 to 76.329 | | 3.732 to 76.089 | | 4.653 to 78.178 | | 3.843 to 76.405 | |
| data collection (°) | | | | | | | | |
| μ (mm⁻¹) | (Cu, Kα) | 3.093 | (Cu, Kα) | 2.394 | (Cu, Kα) | 2.449 | (Cu, Kα) | 1.944 |
| Reflections collected | 51454 | | 26538 | | 38003 | | 51906 | |
| Unique reflections | 13998 | [Rᵢₙₜ = 0.0293] | 7376 | [Rᵢₙₜ = 0.0365] | 7295 | [Rᵢₙₜ = 0.0276] | 8674 | [Rᵢₙₜ = 0.8505] |
| Data Completeness | 100.0% | [67.684] | 100.0% | [67.684] | 100.0% | [67.684] | 100.0% | [67.684] |
| to [θ] | | | | | | | | |
| Data/restraints/ | 13998/12/979 | | 7376/0/422 | | 7296/0/434 | | 8674/45/533 | |
| parameters | | | | | | | | |
| R1^{a} (%) (all data) | 3.00 | (3.50) | 4.44 | (5.22) | 3.04 | (3.21) | 4.20 | (4.80) |
| wR2^{b} (%)(all data) | 7.75 | (8.07) | 12.55 | (13.38) | 8.41 | (8.55) | 10.70 | (11.36) |

| | | | | |
|---|---|---|---|---|
| Goodness-of-fit on F² | 1.025 | 1.082 | 1.047 | 1.025 |
| Largest diff. peak and | 0.334 and −0.380 | 1.187 and −0.411 | 0.254 and −0.379 | 0.396 and −0.409 |
| hole (e Å⁻³) | | | | |

^{a}R1 = Σ | |Fₒ| − |F_{c}| |/Σ |Fₒ| × 100
^{b}wR2 = [Σ w(Fₒ² − F_{c}²)²/Σ (w|Fₒ|²)²]^{1/2} × 100

Table 3 below select crystallographic details for (L₅)₂Ti(OⁱPr)₂-(L₈)₂Ti(OⁱPr)₂.

TABLE 3
Select crystallographic details for (L₅)₂Ti(OⁱPr)₂—(L₈)₂Ti(OⁱPr)₂

| Compound | (L₅)₂Ti(OⁱPr)₂ | | (L₆)₂Ti(OⁱPr)₂ | | (L₇)₂Ti(OⁱPr)₂ | | (L₈)₂Ti(OⁱPr)₂ | |
|---|---|---|---|---|---|---|---|---|
| Chemical formula | C₄₆H₄₆N₂O₅Ti | | C₄₂H₅₈N₂O₆Ti | | C₆₆H₁₀₂N₂O₈Ti | | C₆₃H₆₅N₂O₆Ti | |
| Formula weight | 770.75 | | 734.80 | | 1099.39 | | 994.07 | |
| Temp (K) | 150( ) | | 150(2) | | 150(2) | | 150(2) | |
| Space group | Monoclinic, P2₁/n | | Monoclinic, P2₁/c | | Monoclinic, P2₁/c | | Triclinic, P-1 | |
| a (Å) | 16.0712(4) | | 22.6717(4) | | 19.6212(3) | | 9.3703(5) | |
| b (Å) | 9.9873(2) | | 14.4902(2) | | 17.3312(3) | | 16.9578(10) | |
| c (Å) | 25.2051(5) | | 12.0146(2) | | 19.3123(3) | | 18.9044(15) | |
| α (°) | | | | | | | 67.887(7) | |
| β (°) | 94.390(2) | | 91.2620(10) | | 95.4930(10) | | 86.252(5) | |
| γ (°) | | | | | | | 75.730(5) | |
| V (Å³) | 4033.75(15) | | 3946.05(11) | | 6537.16(18) | | 2695.8(3) | |
| Z | 4 | | 4 | | 4 | | 2 | |
| D_{calcd} (Mg/m³) | 1.268 | | 1.237 | | 1.117 | | 1.225 | |
| Crystal size (mm) | 0.30 × 0.15 × 0.08 | | 0.25 × 0.25 × 0.18 | | 0.25 × 0.22 × 0.15 | | 0.25 × 0.20 × 0.06 | |
| Theta range for data | 3.517 to 76.264 | | 3.620 to 76.238 | | 3.434 to 76.282 | | 3.307 to 30.439 | |
| collection (°) | | | | | | | | |
| μ (mm⁻¹) | (Co, Kα) | 2.203 | (Cu, Kα) | 2.218 | (Cu, Kα) | 1.510 | (Mo, Kα) | 0.212 |
| Reflections collected | 25700 | | 36803 | | 50743 | | 27281 | |
| Unique reflections | 8359 | [Rᵢₙₜ = 0.0335] | 8213 | [Rᵢₙₜ = 0.0305] | 13578 | [Rᵢₙₜ = 0.0336] | 13947 | [Rᵢₙₜ = 0.0600] |
| Data Completeness | 100.0% | [67.684] | 100.0% | [67.684] | 100.059 | [67.684] | 99.7% | [25.000] |
| to [θ] | | | | | | | | |

| Data/restraints/ | 8359/0/502 | | 8213/26/496 | | 13570/167/846 | | 13947/96/734 | |
|---|---|---|---|---|---|---|---|---|
| parameters | | | | | | | | |
| R1^{a} (%) (all data) | 3.53 | (4.41) | 4.58 | (5.03) | 4.85 | (6.08) | 7.33 | (16.63) |
| wR2^{b} (%)(all data) | 8.84 | (9.48) | 12.53 | (12.99) | 13.59 | (14.69) | 11.65 | (14.90) |

| | | | | |
|---|---|---|---|---|
| Goodness-of-fit on F² | 1.020 | 1.028 | 1.039 | 1.003 |
| Largest diff. peak and | 0.259 and −0.334 | 0.733 and −0.476 | 0.454 and −0.524 | 9.324 and −0.396 |
| hole (e Å⁻³) | | | | |

^{a}R1 = Σ | |Fₒ| − |F_{c}| |/Σ |Fₒ| × 100
^{b}wR2 = [Σ w(Fₒ² − F_{c}²)²/Σ (w|Fₒ|²)²]^{1/2} × 100

### Example 4—NMR Studies

Evidence of different isomers in solution can be seen by following the ¹H NMR spectra of each type. For (L₁)₂Ti(OⁱPr)₂, which has Type A-I coordination, the imine CH resonance shifts up field by 0.67 ppm, relative to the parent ligand, and broadens significantly. (FIG. 32) (L₄)₂Ti(OⁱPr)₂ which adopts Type B coordination shows a single CH imine peak shifted 0.25 ppm downfield from the parent ligand, along with a slight broadening. (FIG. 33) Broadening is likely due to the rapid conversion between Δ and Λ enantiomers, along with fluxionality between the two asymmetrically bound ligands, vida infra. This rapid conversion has been seen previously in similar systems and can be frozen out by variable temperature NMR. Broadening can also be seen in the aryl ⁱPr resonance at ˜3 ppm which suggests restricted rotation of these groups in solution. (L₆-L₈)₂Ti(OⁱPr)₂ adopt the third conformation, Type C, where both ligands are O—O chelated, and they all display the same gross features in their ¹H NMR. In each case the imine CH resonance shifts significantly down field by ca. 0.5 ppm, while the OMe resonance shifts up field from the parent ligand. (FIG. 34)

### Example 5—Variable Temperature NMR

To better understand the nature of intermediate case of Type B catalysts, variable temperature NMR experiments were undertaken on (L₄)₂Ti(OⁱPr)₂. As Type B coordination shows both N,O and O,O chelation, but only shows a single imine resonance, it was necessary to confirm that the asymmetry observed in the solid state structure remains in solution. (FIG. 35) Upon cooling (L₄)₂Ti(OⁱPr)₂ from room temperature to −80° C. the imine resonance at ˜8.6 ppm broadened and split into two peaks at ˜8.75 and 8.3 ppm. These two peaks correlate to the individual imine resonance on the O,N and O,O bound ligands. Additionally, the ppm value of the O,N imine resonance correlates closely with that seen in Type A complexes, ˜8.3 ppm, while the ppm value of the O,O resonance correlates to that seen in Type C complexes, ˜8.7 ppm. This indicates that the Type B coordination is retained in solution, and at room temperature signals are averaged due to dynamic exchange between ligands.

Upon heating (L₄)₂Ti(OⁱPr)₂ in d²-1,1,2,2-tetrachloroethane (TCE) incrementally from room temperature to 100° C., peaks sharpened slightly but did not shift (FIG. 36). Additionally, after being held at this temperature for 24 hours, the ¹H NMR of (L₄)₂Ti(OⁱPr)₂ showed no discernible change. There was also no change in the ¹H NMR after heating at 70° C. in d⁸-THF for five hours. This resilience at high temperature indicates that the molecule retains its structure under reaction conditions in both coordinating and non-coordinating solvent.

### Example 6—Polymerisation Studies

### Caprolactone Polymerisation

The general polymerisation conditions were as follows: In a glovebox, catalyst was weighed (˜7 mg) into a vial, dissolved in ε-caprolactone and, in cases where the reaction was not run neat, enough toluene to produce a 1 M solution in lactone. The vial was sealed and the stirring solution was immersed in an oil bath preheated to 80° C. After the desired time samples were cooled to 0° C., exposed to air and aliquots of the crude reaction mixture were taken for analysis by ¹H NMR in CDCl₃. Volatiles were removed under vacuum and a 10 mg/mL THF solution was prepared for GPC. The conversion of ε-CL to PCL was determined by integration of the methylene proton peaks of the ¹H NMR spectra, δ 4.30-3.95.

ε-caprolactone was chosen to initially test the newly synthesized family of catalysts towards the ROP of lactones. Polymerizations were conducted both in toluene solution (1:200 [I]:[ε-CL], 1 M [ε-CL]; Table 4) and under neat conditions (1:200 [I]:[ε-CL] or 1:1000 [I]:[ε-CL]; Table 5). Catalysts (L₁)₂Ti(OⁱPr)₂ and (L₂)₂Ti(OⁱPr)₂ were capable of polymerization under both conditions. After 24 hours, however both (L₁)₂Ti(OⁱPr)₂ and (L₂)₂Ti(OⁱPr)₂ had reached full conversion, indicating a significant initiation period.

(L₄₋₈)₂Ti(OⁱPr)₂ are all active initiators and are, in some cases, several times faster than (L_{1,2})₂Ti(OⁱPr)₂. (L₄)₂Ti(OⁱPr)₂ reached full conversion to PCL within four hours, while (L₆-8)₂Ti(OⁱPr)₂ reached full conversion in just two. In each case the resulting PCL shows a monomodal distribution in the GPC trace with narrow PDIs. Experimental Mₙ were in good agreement with calculated values when accounting for two growing PCL chains per Ti centre. All catalysts polymerize CL in a living manner, with Mₙ increasing with reaction time while maintaining narrow PDI.

Interestingly, the order of reactivity follows the trend (L₈)₂Ti(OⁱPr)₂˜(L₇)₂Ti(OⁱPr)₂˜(L₆)₂Ti(OⁱPr)₂>(L₅)₂Ti(OⁱPr)₂˜(L₄)₂Ti(OⁱPr)₂>(L₃)₂Ti(OⁱPr)₂>(L₂)₂Ti(OⁱPr)₂˜(L₁)₂Ti(OⁱPr)₂ or, written in terms of coordination chemistry, Type C>Type B>Type A-II>Type A-I. The reasons for this trend can be explained by examining the crowding around the metal centre. Type C complexes possess bulkier R groups, however this bulk is pushed distal to the metal centre and actually results in less steric crowding around the Ti than Type A-I. This more open coordination environment causes an increase in rate through the coordination insertion mechanism.

TABLE 4
Polymerisation of ε-caprolactone in toluene

| | | Time | Conv. | Mₙ | Mₙ | | Coordination |
|---|---|---|---|---|---|---|---|
| Entry | Catalyst^{a} | (h) | (%)^{b} | (exp)^{c} | (calc)^{d} | Ð | Type |
| 1 | (L₁)₂Ti(OⁱPr)₂ | 4 | 32 | — | — | — | A-I |
| 2 | (L₁)₂Ti(OⁱPr)₂ | 24 | 99 | 9,460 | 11,300 | 1.13 | A-I |
| 3 | (L₂)₂Ti(OⁱPr)₂ | 4 | — | — | — | — | A-I |
| 4 | (L₂)₂Ti(OⁱPr)₂ | 24 | 99 | 8,780 | 11,300 | 1.20 | A-I |
| 5 | (L₃)₂Ti(OⁱPr)₂ | 9 | 90 | 8,890 | 10,270 | 1.27 | A-II |
| 6 | (L₃)₂Ti(OⁱPr)₂ | 24 | 99 | 15,200 | 11,300 | 1.47 | A-II |
| 7 | (L₄)₂Ti(OⁱPr)₂ | 4 | 99 | 13,090 | 11,300 | 1.27 | B |
| 8 | (L₅)₂Ti(OⁱPr)₂ | 3 | 61 | 9,060 | 7,000 | 1.09 | B |
| 9 | (L₅)₂Ti(OⁱPr)₂ | 4 | 73 | 10,940 | 8,330 | 1.10 | B |
| 10 | (L₆)₂Ti(OⁱPr)₂ | 2 | 99 | 16,113 | 11,300 | 1.47 | C |
| 11 | (L₇)₂Ti(OⁱPr)₂ | 2 | 99 | 13,100 | 11,300 | 1.09 | C |
| 12 | (L₈)₂Ti(OⁱPr)₂ | 2 | 99 | 12,200 | 11,300 | 1.27 | C |

^{a}1M ε-CL in toluene, 80° C., N₂, 0.5 mol %
^{b}Calculated by ¹H NMR of the methylene region.
^{c}Measured by GPC relative to polystyrene standard and corrected by a factor of 0.56
^{d}Mₙ(calc) = (conversion/100) × loading/[2 Growing Chains] × RMM(εCL)
^{e}TOF = (conversion/100) × loading/(time × 2 growing chains)

TABLE 5
Polymerisation of ε-caprolactone in neat ε-caprolactone

| | Catalyst | Time | Conv. | Mₙ | Mₙ | | TOF |
|---|---|---|---|---|---|---|---|
| Entry | (mol %)^{a} | (m) | (%)^{b} | (exp)^{c} | (calc)^{d} | Ð | (h⁻¹)^{e} |
| 1 | (L₁)₂Ti(OⁱPr)₂ (0.5%) | 60 | 17 | 2,120 | 1,940 | 1.10 | 34 |
| 2 | (L₁)₂Ti(OⁱPr)₂ (0.1%) | 60 | 2 | — | — | — | — |
| 3 | (L₂)₂Ti(OⁱPr)₂ (0.5%) | 20 | 0 | — | — | — | — |
| 4 | (L₂)₂Ti(OⁱPr)₂ (0.5%) | 1,260 | 56 | 17,130 | 6,390 | 1.37 | 5 |
| 5 | (L₃)₂Ti(OⁱPr)₂ (0.5%) | 60 | 24 | 5,510 | 2,740 | 1.05 | 48 |
| 6 | (L₃)₂Ti(OⁱPr)₂ (0.1%) | 60 | 7 | 4,330 | 4,000 | 1.06 | 70 |
| 7 | (L₄)₂Ti(OⁱPr)₂ (0.5%) | 20 | 24 | 3,980 | 2,740 | 1.09 | 138 |
| 8 | (L₄)₂Ti(OⁱPr)₂ (0.5%) | 80 | 71 | 12,570 | 8,100 | 1.12 | 106 |
| 9 | (L₄)₂Ti(OⁱPr)₂ (0.1%) | 60 | 31 | 17,810 | 17,690 | 1.04 | 310 |
| 10 | (L₇)₂Ti(OⁱPr)₂ (0.5%) | 50 | 90 | 15,440 | 10,270 | 1.28 | 216 |
| 11 | (L₇)₂Ti(OⁱPr)₂ (0.1%) | 60 | 40 | 35,390 | 22,820 | 1.05 | 400 |
| 12 | (L₈)₂Ti(OⁱPr)₂ (0.5%) | 50 | 71 | 16,060 | 8,104 | 1.17 | 170 |
| 13 | (L₈)₂Ti(OⁱPr)₂ (0.1%) | 50 | 44 | 37,430 | 25,110 | 1.06 | 440 |

^{a}Neat ε-CL, 80° C., N₂
^{b}Calculated by ¹H NMR of the methylene region, stirring restricted by increased viscosity at high conversion.
^{c}Measured by GPC relative to polystyrene standard and corrected by a factor of 0.56
^{d}Mₙ(calc) = (conversion/100) × loading/[2 growing chains] × RMM(εCL)
^{e}TOF = (conversion/100) × loading/(time × 2 growing chains)

### Caprolactone Kinetic Studies

The general polymerisation conditions for analysing the ε-caprolactone kinetics were as follows: In a glovebox, catalyst was weighed (0.025 mmol, ˜20 mg) into a volumetric flask (5 mL), and dissolved with dry toluene. ε-caprolactone was then added to the solution (5 mmol, 0.554 mL), mixed thoroughly, and divided into individual vials. Vials were sealed with isolation tape and added simultaneously to a pre-heated oil bath set to 80° C. Vials were removed at set time intervals and immediately submerged in an ice bath. The solution was then exposed to air and a portion of the crude mixture was dissolved in wet CDCl₃ to determine conversion via NMR. Pentane/Hexane was added to the remaining aliquot to precipitate the resulting polymer followed by the removal of all volatiles under high vacuum. A 10 mg/mL THF solution of the polymer was then prepared for GPC analysis.

To better understand the effect coordination type has on the rate of polymerization, kinetic studies were conducted in toluene (0.9 M solution of ε-CL in toluene, 200:1 monomer:catalyst) at 80° C. All polymerizations showed expected increases in Mₙ and narrow PDI values which implies a well-controlled, living-polymerization. Calculated and experimental Mₙ values were in good agreement for 2 growing polymer chains per metal center throughout the duration of each experiment indicating that the two chains grow at a similar rate with similar initiation times. (FIGS. 40a,b,c) The three catalysts studied (L₃)₂Ti(ⁱOPr)₂, (L₄)₂Ti(OⁱPr)₂, and (L₈)₂Ti(OⁱPr)₂ show first order kinetics in monomer and the trend in reactivity confirms what was observed in the bulk polymerizations where Type C>Type B>Type A. From this data we can see that generally, Type C is twice as fast as Type B, which is three times faster than Type A-II. (FIG. 41) The coordination insertion mechanism with OⁱPr as an initiator was confirmed through MALDI-ToF analysis of low molecular weight PCL produced from each catalyst. (FIG. 42-45) In each case a distribution of (ⁱPrO)(PCL)ₙ(H) was identified. This data, taken together, indicates that despite the drastic change in coordination environment in this family of catalysts, the mechanism remains the same.

Polymerization reactions conducted in neat ε-CL show similar trends to those in toluene, however, they are hampered by an increase in viscosity with increasing conversion. As such, several reactions show experimental Mₙ higher than calculated values at high conversion. This may be due to chain coupling at the metal centre. Additionally, PDI values remained narrow for all catalysts (1.05-1.37). Several catalysts were also tested in the melt at lower catalyst loading (1:1000, [1]:[ε-CL]) and all maintain their activity.

### ω-Pentadecalactone Polymerisation

The general polymerisation conditions were as follows: In a glovebox, catalyst was weighed (˜7 mg) into a vial, along with ω-pentadecalactone and, in cases where the reaction was not run neat, enough toluene to produce a 1 M solution in lactone. The vial was sealed and the stirring solution was immersed in an oil bath preheated to 100° C. After the desired time aliquots of the crude reaction mixture were taken for analysis by ¹H NMR in CDCl₃. Samples were then cooled to 0° C., exposed to air and quenched with wet hexanes. Volatiles were removed under vacuum and a 25 mg/mL CHCl₃ solution was prepared for GPC. The conversion of ω-PDL to PPDL was determined by integration of the methylene proton peaks of the ¹H NMR spectra, δ 4.30-3.95.

Following the successful formation of PCL, the ROP of PDL was screened with the new family of catalysts. Polymerizations were conducted under similar conditions, in toluene solution at 100° C. (1:100 [I]:[ω-PDL], 1 M [ω-PDL]; Table 6) and in the melt (1:100 [I]:[ω-PDL] Table 6). As expected, the ROP of PDL is universally slower than CL. The order in catalyst, however, remains the same with Type C>Type B>Type A-II>Type A-I.

Molecular weights are considerably higher than anticipated for two growing chains. Advantageous water in the reaction may serve to deactivate a portion of catalyst causing an increase in Mₙ, however PPDL produced from (L₈)₂Ti(OⁱPr)₂ with freshly distilled PDL and unpurified PDL gave very similar conversion and Mₙ after 5 hours. This suggests that even at high temperature (L)₂Ti(OⁱPr)₂ catalysts are relatively tolerant to impurities, such as water.

TABLE 6
Polymerisation of ω-pentadecalactone in toluene

| | Catalyst | Time | Conv. | Mₙ | Mₙ | | Coordination |
|---|---|---|---|---|---|---|---|
| Entry | (mol %)^{a} | (h) | (%)^{c} | (exp)^{d} | (calc)^{e} | Ð | Type |
| | (L₁)₂Ti(OⁱPr)₂ (1%) | 4 | 2 | — | — | — | A-I |
| | (L₁)₂Ti(OⁱPr)₂ (1%) | 24 | 5 | — | — | — | A-I |
| | (L₃)₂Ti(OⁱPr)₂ (1%) | 4 | 5 | — | — | — | A-II |
| | (L₃)₂Ti(OⁱPr)₂ (1%) | 24 | 27 | 7,680 | 3,250 | 1.49 | A-II |
| | (L₄)₂Ti(OⁱPr)₂ (1%) | 4 | 4 | — | — | — | B |
| | (L₄)₂Ti(OⁱPr)₂ (1%) | 24 | 53 | 14,890 | 6,370 | 1.74 | B |
| | (L₄)₂Ti(OⁱPr)₂ (1%) | 48 | 72 | 21,710 | 8,650 | 1.79 | B |
| | (L₅)₂Ti(OⁱPr)₂ (1%) | 4 | 7 | — | — | — | B |
| | (L₅)₂Ti(OⁱPr)₂ (1%) | 24 | 32 | 3,430 | 3,850 | 1.89 | B |
| | (L₆)₂Ti(OⁱPr)₂ (1%) | 4 | 35 | 5,330 | 4,210 | 1.60 | C |
| | (L₆)₂Ti(OⁱPr)₂ (1%) | 24 | 96 | 36,470 | 11,540 | 1.69 | C |
| | (L₇)₂Ti(OⁱPr)₂ (1%) | 4 | 17 | 5,860 | 2,040 | 1.38 | C |
| | (L₇)₂Ti(OⁱPr)₂ (1%) | 24 | 47 | 14,789 | 5,650 | 1.70 | C |
| | (L₈)₂Ti(OⁱPr)₂ (1%) | 4 | 10 | 5,100 | 1,200 | 1.30 | C |
| | (L₈)₂Ti(OⁱPr)₂ (1%) | 24 | 55 | 24,311 | 6,610 | 1.59 | C |
| | (L₈)₂Ti(OⁱPr)₂ (1%) | 72 | 95 | 6,960 | 11,418 | 2.15 | C |
| | (L₁)₂Ti(OⁱPr)₂ (1%)^{b} | 5 | 32 | 17,610 | 3,850 | 1.46 | A-I |
| | (L₃)₂Ti(OⁱPr)₂ (1%)^{b} | 5 | 42 | | 5,050 | | A-II |
| | (L₄)₂Ti(OⁱPr)₂ (1%)^{b} | 5 | 41 | 16,500 | 4,930 | 1.76 | B |
| | (L₇)₂Ti(OⁱPr)₂ (1%)^{b} | 5 | 62 | 30,050 | 7,450 | 2.09 | C |
| | (L₈)₂Ti(OⁱPr)₂ (1%)^{b} | 5 | 54 | 16,167 | 6,490 | 1.89 | C |
| | (L₈)₂Ti(OⁱPr)₂ (1%)^{b}* | 5 | 48 | 13,880 | 5,770 | 2.34 | C |

^{a}1M ω-PDL in toluene, 100° C., N₂
^{b}Neat ω-PDL, 100° C., N₂
*Utilizing unpurified ω-PDL
^{c c}Calculated by ¹H NMR of the methylene region.
^{d}Measured by GPC relative to polystyrene standard and uncorrected
^{e}Mₙ(calc) = (conversion/100) × loading/[2 growing chains] × RMM(ωPDL)

### Part B

### Example 7—Ligand Synthesis

### Amine Ligands

Following the formation of imine ligands previously described (L₁₋₈) a reduction with excess NaBH₄ could be performed to yield amine ligands (L₄₋₈′). These ligands were characterized through ¹H and ¹³C{¹H} NMR.

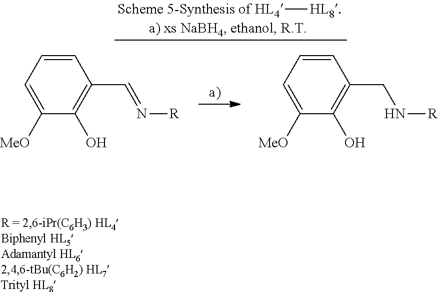

### Synthesis of HL₄′

2 equivalents of NaBH₄ (0.49 g, 12.84 mmol) were slowly added to HL₄ (2.00 g, 6.42 mmol) dissolved in ethanol (20 mL), and the solution was stirred for 2 hours, until it turned from yellow to colourless. Water (10 mL) was added dropwise to the flask at 0° C. causing a white precipitate to form. Concentrated HCl was added dropwise until a neutral pH was obtained. The reaction was left without stirring for an hour, then the solid was filtered, washed with cold water, and dried in a vacuum oven at 40° C. Isolated Yield: 1.91 g, 6.08 mmol, 95%. ¹H NMR (400 MHz, CDCl₃) δ (ppm): 9.10 (s, 1H), 7.16 (s, 3H), 6.88-6.87 (d, 1H), 6.83 (t, 1H), 6.77-6.75 (d, 1H), 4.13 (s, 2H), 3.93 (s, 3H), 3.62 (bs, 1H), 3.35 (septet, 2H), 1.29-1.27 (d, 12H). ¹³C{¹H} NMR (125 MHz, CDCl₃) δ (ppm): 148.0, 146.2, 143.1, 141.3, 125.4, 124.0, 123.9, 121.0, 119.5, 110.9, 56.1, 54.4, 28.1, 24.5.

FIG. 47 shows the ¹H NMR spectrum of HL₄′ in CDCl₃, 400 MHz.

FIG. 48 shows the ¹³C{¹H} NMR spectrum of HL₄′ in CDCl₃, 400 MHz.

### Synthesis of HL₅′

4 equivalents of NaBH₄ (0.50 g, 13.19 mmol) were slowly added to HL₅ (1.00 g, 3.30 mmol) which was partially dissolved in ethanol (20 mL), and the reaction was stirred for 3 hours, until the solution turned colourless. Water (40 mL) was added slowly to the flask at 0° C., and was left without stirring overnight, producing a small amount of off-white aggregated solid. The liquid was decanted off and recrystallised from ethanol to give a solid which was washed with pentane and dried under vacuum. Isolated Yield: 0.71 g, 2.32 mmol, 71%.¹H NMR (400 MHz, CDCl₃) δ (ppm): 7.47-7.43 (m, 4H), 7.39-7.34 (m, 1H), 7.24-7.20 (td, 1H), 7.13-7.11 (dd, 1H), 6.87-6.79 (m, 5H), 6.38 (s, 1H), 4.44 (bs, 1H), 4.39-4.38 (m, 2H), 3.89 (s, 3H). ¹³C{¹H} NMR (125 MHz, CDCl₃) δ (ppm): 146.7, 144.9, 144.0, 139.4, 130.2, 129.4, 128.9, 128.7, 128.5, 127.3, 124.5, 120.7, 119.5, 117.7, 111.6, 109.8, 56.0, 44.1.

FIG. 49 shows the ¹H NMR spectrum of HL₅′ in CDCl₃, 400 MHz.

FIG. 50 shows the ¹³C{¹H} NMR spectrum of HL₅′ in CDCl₃, 400 MHz.

### Synthesis of HL₆′

2 equivalents of NaBH₄ (0.66 g, 17.52 mmol) were slowly added to HL₆ (2.50 g, 8.76 mmol) dissolved in ethanol (30 mL), and the reaction was stirred for 2 hours, until the solution turned colourless, and a white precipitate appeared. Water (20 mL) was added dropwise to the flask at 0° C. without stirring. The solid formed was filtered, washed with cold water and dried under vacuum. Isolated Yield: 2.20 g, 7.66 mmol, 87%.¹H NMR (400 MHz, CDCl₃) δ (ppm): 6.79-6.77 (m, 1H), 6.72 (t, 1H), 6.60-6.59 (m, 1H), 3.99 (s, 2H), 3.86 (s, 3H), 2.10 (bs, 3H), 1.72-1.60 (m, 12H). ¹³C{¹H} NMR (125 MHz, CDCl₃) δ (ppm): 148.4, 147.9, 124.0, 119.9, 118.3, 110.6, 55.9, 51.3, 43.9, 42.1, 36.5, 29.4.

FIG. 51 shows the ¹H NMR spectrum of HL₆′ in CDCl₃, 400 MHz.

FIG. 52 shows the ¹³C{¹H} NMR spectrum of HL₆′ in CDCl₃, 400 MHz.

### Synthesis of HL₇′

12 equivalents of NaBH₄ (1.15 g, 37.83 mmol) were added to HL₇ (1 g, 2.5 mmol) dissolved in ethanol (30 mL), over the course of 8 hours, until the solution turned colourless. The next day water (60 mL) was added to the flask at 0° C. without stirring. The solid formed was filtered, washed with cold water and dried under vacuum. Isolated Yield: 0.937 g, 2.36 mmol, 95%.¹H NMR (500 MHz, CDCl₃) δ (ppm): 7.97 (s, 1H), 7.34 (s, 2H), 6.90 (m, 1H), 6.84 (d, 2H), 4.09 (d, 2H), 3.91 (s, 3H), 3.82 (t, 1H), 1.49 (2, 18H), 1.32 (s, 9H).

FIG. 53 shows the ¹H NMR spectrum of HL₇′ in CDCl₃, 500 MHz.

### Synthesis of HL₆′

12 equivalents of NaBH₄ (1.15 g, 30.49 mmol) were added gradually to HL₈ (1.00 g, 2.45 mmol) which was partially dissolved in ethanol (20 mL) over 4 hours, producing a colourless solution. The flask was left to stir overnight and an off-white solid formed. Water (10 mL) was added dropwise to the flask at 0° C. HCl was added to neutralise the solution and the reaction was stirred for an hour. The resulting white solid was filtered and washed with cold water twice. Because some solid appeared in the filtrate, this was re-filtered, washed similarly, and all product was dried in a vacuum oven at 40° C. Isolated Yield: 0.74 g, 1.86 mmol, 74%. ¹H NMR (400 MHz, CDCl₃) δ (ppm): 10.63 (s, 1H), 7.50-7.23 (m, 15H), 6.83-6.80 (d, 1H), 6.72 (t, 1H), 6.53-6.51 (s, 1H), 3.93 (s, 3H), 3.59 (s, 2H), 2.56 (bs, 1H). ¹³C{¹H} NMR (125 MHz, CDCl₃) δ (ppm): 148.3, 146.9, 144.8, 129.0, 128.5, 127.2, 123.9, 121.1, 119.4, 110.8, 72.0, 56.3, 47.0, 31.3.

### Fluorinated Methoxy Ligands

Synthesis of HL₄^{F}

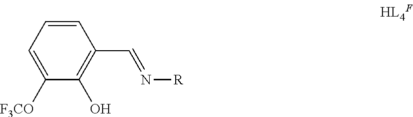

2-Hydroxy-3-(Trifluoromethoxy)benzaldehyde) (0.50 g, 2.4 mmol) was added to a round bottom flask and dissolved in ethanol (15 mL). 2,6-diisopropylaniline (0.43 g, 2.4 mmol) was added into the stirring solution and his reaction mixture was refluxed for 24 hours resulting in a bright solution. Ethanol was removed and the crude product was recrystallized from DCM. ¹H NMR (400 MHz, CDCl₃) δ (ppm): 13.9 (s, 1H), 8.33 (s, 1H), 7.45 (d, 1H), 7.30 (d, 1H), 7.20 (s, 3H), 6.95 (t, 1H), 2.97 (m, 2H), 1.19 (d, 12H). ¹⁹F{¹H} NMR (376 MHz, CDCl₃) δ (ppm): 58.08

FIG. 54 shows the ¹H NMR spectrum of HL₄^{F} in CDCl₃, 400 MHz.

### Example 8—Complex Synthesis

### Using Imine Ligands

Synthesis of [(L₄^{F})₂Ti(OⁱPr)₂]

HL₄F (0.50 g, 1.37 mmol) and Ti(OⁱPr)₄ (0.19 g, 0.68 mmol) were dissolved separately in toluene (5 mL and 5 mL, respectively), and cooled to −30° C. in a glovebox freezer. The two solutions were then mixed and allowed to stir for 24 hours. Volatiles were removed in vacuo and hexane (10 mL) was added to the resulting orange-yellow wax. This hexane was removed under vacuum to provide the final complex as a bright orange powder. ¹H NMR (400 MHz, CDCl₃) δ (ppm): 8.05 (s, 2H), 7.25-7.10 (m, 10H), 6.54 (t, 2H), 4.10 (m, 2H), 3.71 (bm, 4H), 1.19-0.24 (bm, 36H). ¹⁹F{¹H} (376 MHz, CDCl₃) δ (ppm): 58.4.

FIG. 55 shows the ¹H NMR spectrum of [(L^{F}₄)₂Ti(OⁱPr)₂] in CDCl₃, 400 MHz, as well as the ¹⁹F{¹H} NMR spectrum comparing HL^{F}₄ (−58.1 ppm) and [(L^{F}₄)₂Ti(OⁱPr)₂] (−58.4)₄₀₀ MHz in CDCl₃.

Synthesis of [(L₄)₂Ti(OEt)₂]

HL₄ (0.5 g, 1.61 mmol) and Ti(OEt)₄ (0.18 g, 0.80 mmol) were dissolved separately in toluene (10 mL and 10 mL, respectively), and cooled to −30° C. in a glovebox freezer. The two solutions were then mixed and allowed to stir for 24 hours. Volatiles were removed in vacuo and hexane (10 mL) was added to the resulting orange-yellow solid. This hexane was removed under vacuum to provide the final complex as a bright yellow powder (0.49 g, 0.65 mmol, 81%).¹H NMR (400 MHz, CDCl₃) δ (ppm): 8.51-8.39 (m, 2H), 7.6-7.45 (bs, 2H), 7.13-7.09 (m, 6H), 6.90 (d, 2H), 6.74 (t, 2H), 4.32 (bs, 4H), 3.94-3.89 (m, 6H), 3.15 (bs, 4H), 1.15-1.03 (m, 30H). *Broad signals as well as shouldering suggests isomerization in solution.

FIG. 56 shows the ¹H NMR spectrum of (L₄)₂Ti(OEt)₂ in CDCl₃ at 298 K.

FIG. 57 shows the ¹³C{¹H} NMR spectrum of (L₄)₂Ti(OEt)₂ in CDCl₃ at 298 K.

Synthesis of [(L₄)₂Ti(NMe₂)₂]

HL₄ (2 eq.) and Ti(NMe₂)₄ (1 eq) were dissolved separately in toluene (10 mL and 10 mL, respectively), and cooled to −30° C. in a glovebox freezer. The two solutions were then mixed and allowed to stir for 24 hours. Volatiles were removed in vacuo and hexane (10 mL) was added to the resulting red solid. Hexane was removed under vacuum to provide the final complex as a dark red powder. Crystals suitable for XRD were grown from slow evaporation of CDCl₃. ¹H NMR was inconclusive, most likely due to fluxionality in the catalyst.

### Using Amine Ligands

### General Synthesis

The appropriate amine ligand and Ti(OⁱPr)₄ in a 2:1 molar ratio, were dissolved separately in toluene (20 mL and 5 mL, respectively), and cooled in a glovebox freezer to −30° C. The dissolved ligand was added slowly to the Ti(OⁱPr)₄ solution in a Schlenk flask. After stirring for 24 hours, volatiles were removed under vacuum, and the resulting solid was twice dissolved in hexane and dried under vacuum to yield a coloured solid.

Synthesis of [(L₄)₂Ti(OⁱPr)₂]

HL₄′ (1.00 g, 3.19 mmol) was reacted with Ti(OⁱPr)₄ (0.45 g, 1.60 mmol) to give a yellow powder. Isolated Yield: 0.98 g, 1.20 mmol, 75%.¹H NMR (400 MHz, CDCl₃) δ (ppm): 7.35-7.26 (m, 6H), 7.20-7.18 (m, 2H), 6.89-6.88 (m, 4H), 5.00 (septet, 2H), 4.26-4.24 (d, 4H), 4.04 (s, 6H), 3.91-3.87 (t, 2H), 3.75 (septet, 4H), 1.50-1.44 (m, 36H). ¹³C{¹H} NMR (125 MHz, CDCl₃) δ (ppm): 152.3, 149.4, 143.9, 143.3, 126.0, 124.1, 123.9, 123.4, 117.8, 109.1, 80.2, 57.1, 51.6, 27.9, 26.0, 24.8.

FIG. 58 shows the ¹H NMR spectrum of (L₄′)₂Ti(OⁱPr)₂ in CDCl₃ at 298 K.

FIG. 59 shows the ¹³C{¹H} NMR spectrum of (L₄′)₂Ti(OⁱPr)₂ in CDCl₃ at 298 K.

Synthesis of [(L₅)₂Ti(OⁱPr)₂]

HL₅′ (0.40 g, 1.31 mmol) was reacted with Ti(OⁱPr)₄ (0.19 g, 1.31 mmol) to give a pale-yellow powder. Isolated Yield: 0.23 g, 0.30 mmol, 46%. ¹H NMR (400 MHz, CDCl₃): 7.52-7.45 (m, 8H), 7.36 (m, 2H), 7.23 (m, 2H), 7.14-7.13 (dd, 2H), 6.96-6.95 (dd, 2H), 6.83 (d, 2H), 6.79 (td, 2H), 6.68-6.63 (m, 4H), 4.78 (septet, 2H), 4.50 (t, 2H), 4.38 (d, 4H), 3.7 (s, 6H), 1.23 (d, 12H). ¹³C{¹H} NMR (125 MHz, CDCl₃) δ (ppm): 151.8, 148.8, 145.3, 139.8, 130.3, 129.4, 128.9, 128.7, 127.5, 127.1, 124.7, 122.2, 117.3, 116.8, 110.8, 108.5, 80.0, 56.8, 43.1, 25.5.

FIG. 60 shows the ¹H NMR spectrum of (L₅′)₂Ti(OⁱPr)₂ in CDCl₃ at 298 K.

FIG. 61 shows the ¹³C{¹H} NMR spectrum of (L₅′)₂Ti(OⁱPr)₂ in CDCl₃ at 298 K.

Synthesis of [(L₆)₂Ti(OⁱPr)₂]

HL₆′ (2.00 g, 6.96 mmol) was reacted with Ti(OⁱPr)₄ (0.99 g, 6.96 mmol) to give an orange solid. Isolated Yield: 1.60 g, 2.16 mmol, 62%. ¹H NMR (400 MHz, CDCl₃): 6.90 (d, 2H), 6.65-6.60 (m, 4H), 4.84 (septet, 2H), 3.83 (s, 6H), 3.77 (d, 4H), 2.10 (s, 6H), 1.78-1.66 (m, 30H), 1.26 (d, 12H). ¹³C{¹H} NMR (125 MHz, CDCl₃) δ (ppm): 152.1, 149.0, 127.1, 123.5, 117.5, 108.5, 79.8, 57.0, 50.8, 43.0, 41.3, 37.1, 29.9, 25.9.

FIG. 62 shows the ¹H NMR spectrum of (L₆′)₂Ti(OⁱPr)₂ in CDCl₃ at 298 K.

FIG. 63 shows the ¹³C{¹H} NMR spectrum of (L₆′)₂Ti(OⁱPr)₂ in CDCl₃ at 298 K.

Synthesis of [(L₇)₂Ti(OⁱPr)₂]

HL₇′ (0.80 g, 2.02 mmol) was reacted with Ti(OⁱPr)₄ (0.29 g, 1.01 mmol) to give a yellow solid. Isolated Yield: 0.749 g, 0.780 mmol, 77%. ¹H NMR (400 MHz, CDCl₃): 7.40 (s, 4H), 7.14 (d, 2H), 6.74 (m, 4H), 4.71 (m, 2H), 4.08 (m, 6H), 3.90 (s, 6H), 1.58 (s, 36H), 1.39 (s, 18H), 1.20 (d, 12H).

FIG. 64 shows the ¹H NMR spectrum of (L₇′)₂Ti(OⁱPr)₂ in CDCl₃ at 298 K. 400 MHz.

### Example 9—Crystallographic Studies

The structure of the complexes prepared from amine ligands could in some cases be confirmed by X-ray crystallography and are shown to adopt Type C coordination (O,O/O,O coordination, Scheme 3). FIG. 65 shows the X-ray crystal structures of (L₄₁₂Ti(OⁱP02 (top) and (L₇′)₂Ti(OⁱPr)₂ (bottom) showing Type C coordination.

Having regard to FIGS. 66 to 68, the ¹H NMR spectra of (L₄₋₆′)₂Ti(OⁱPr)₂ remain virtually unchanged upon cooling (R.T. to −80° C.) or heating (R.T. to 80° C.) confirming (based on the assignment of the R.T. ¹H NMR and the solid state structures of (L₄₋₆′)₂Ti(OⁱPr)₂) that 1) all of these catalysts contain Type C coordination 2) and these catalysts retain this coordination chemistry from −80° C. to 80° C.

The initiating group on the titanium could be changed from isopropoxide to ethoxide or dimethylamide by changing the titanium precursor to Ti(OEt)₄ or Ti(NMe₂)₄, thus yielding (L₄)₂Ti(OEt)₂ and (L₄)₂Ti(NMe₂)₂ respectively. The structures of these compounds were confirmed using x-ray crystallography. FIG. 69 suggests that changing the steric bulk of the initiating group has an effect on the observed coordination type.

### Example 10—Polymerisation Studies

### ROP of ε-Caprolactone, ε-Decalactone, ω-Pentadecalactone, and Rac-Lactide

Catalysts prepared from phenoxy-amine ligands were tested for the ROP of ε-caprolactone, and in the case of (L₅′)₂Ti(OⁱPO₂, ε-decalactone, ω-pentadecalactone, and rac-lactide. The general conditions used in each ROP polymerisation experiment are outlined below:

ε-caprolactone ROP polymerisation: In a glovebox, the catalyst was weighed (˜7 mg) into a vial, dissolved in ε-caprolactone and, in cases where solvent was used, sufficient toluene was added to form a 1 M solution in lactone. The vial was sealed and the stirring solution was immersed in an oil bath preheated to 80° C. After the desired time, samples were cooled to 0° C., exposed to air and aliquots of the crude reaction mixture were evaporated to dryness. The crude PCL was characterized as a 10 mg/mL THF solution for GPC and in CHCl3 for ¹H NMR spectroscopy.
ω-pentadecalactone ROP polymerisation: In a glovebox, the catalyst was weighed (˜7 mg) into a vial, along with ω-pentadecalactone and, in cases where solvent was used, sufficient toluene was added to form a 1 M solution in lactone. The vial was sealed and the stirring solution was immersed in an oil bath preheated to 100° C. After the desired time aliquots of the crude reaction mixture were taken for analysis by ¹H NMR in CDCl₃. Samples were then cooled to 0° C., exposed to air and quenched with wet hexanes. Volatiles were removed under vacuum and a 25 mg/mL CHCl₃ solution was prepared for GPC. The conversion of PDL to PPDL was determined by integration of the methylene proton peaks of the ¹H NMR spectra, δ 4.30-3.95.
ε-decalactone ROP polymerisation: The catalyst (0.012 g, 0.015 mmol) was dissolved in a 1 M solution of toluene (1.5 mL) and monomer (1.500 mmol: 0.255 g ε-DL), to yield a 100:1 monomer:catalyst ratio. The reaction solution was divided up into 4 separate vials, which were sealed, removed from the glovebox, and placed in a pre-heated aluminum block to stir at 100° C. At each time point, the vials were aliquoted and quenched as in the ε-CL polymerisations.
rac-lactide ROP polymerisation: LA (0.058 g, 4.0×10⁻⁴ mmol) was added to each of 4 vials along with dry toluene to give a 1M solution. The catalyst was then added to each vial, to give a 200:1 monomer:catalyst ratio. After sealing, the vials were removed from the glovebox and placed in a pre-heated aluminum block to stir at 100° C. Aliquots were taken and reactions were quenched as in the e-caprolactone polymerisations.

### Reaction Kinetics

The kinetics of the ROP of ε-caprolactone using catalysts prepared from phenoxy-amine ligands were studied (FIG. 70) and, in conjunction with MALDI-ToF analysis of the polymer, confirm a coordination-insertion mechanism. The general conditions used for this experiment are outlined below:

In a glovebox, catalyst was weighed (0.025 mmol, ˜20 mg) into a volumetric flask (5 mL), and dissolved with dry toluene. ε-Caprolactone was then added to the solution (0.55 mL, 5 mmol), mixed thoroughly, and divided into individual vials. Vials were sealed with isolation tape and added simultaneously to a pre-heated oil bath set to 80° C. Vials were removed at set time intervals and immediately submerged in an ice bath. The solution was then exposed to air and a portion of the crude mixture was dissolved in wet CDCl₃ to determine conversion via NMR. Pentane/Hexane was added to the remaining aliquot to precipitate the resulting polymer followed by the removal of all volatiles under high vacuum. A 10 mg/mL THF solution of the polymer was then prepared for GPC analysis.

### Copolymerisation Studies

Copolymerization of ε-caprolactone and rac-lactide was also achieved using (L₅′)₂Ti(OⁱPr)₂ through subsequent addition of one monomer after full conversion of the first to yield poly(PLA-b-CL) or poly(CL-b-LA) depending on the order of addition. The general conditions used for this experiment are outlined below:

Into one vial LA (0.216 g, 1.500 mmol), toluene (1.5 mL) and the catalyst (0.012 g, 0.015 mmol) were added, giving a 100:1 monomer:catalyst ratio. This was taped, removed from the glovebox, and placed on a pre-heated aluminium block stir at 100° C. After 4 hours, the vial was taken into the glove box, an aliquot of the reaction mixture was added to C₆D₆, and ε-CL (0.270 g, 2.37 mmol) was added. The vial was retaped, removed from the glovebox and placed on a pre-heated aluminium block to stir for a further 3 hours at 80° C., after which the vial was opened, another aliquot was taken in C₆D₆, and the reaction was quenched as in previous polymerisations.
Into a second vial ε-CL (0.171 g, 1.500 mmol), toluene (1.5 mL) and the catalyst (0.012 g, 0.015 mmol) were added (100:1 monomer:catalyst ratio). This was taped, removed from the glovebox, and placed on a pre-heated metal adaptor to stir at 80° C. After 3 hours, the vial was taken into the glove box, an aliquot of the reaction mixture was added to C₆D₆, and LA (0.216 g, 1.500 mmol) was added. The vial was retaped, removed from the glovebox and placed on a pre-heated aluminium block to stir for a further 4 hours at 100° C., after which the vial was opened, another aliquot was taken in C₆D₆, and the reaction was quenched as in previous polymerisations.
¹H{¹H} NMR spectra for the block polymers were taken in CDCl₃ after the aliquots in C₆D₆ were evaporated and re-dissolved. These samples were then dried under a stream of nitrogen gas and dissolved in THF for GPC analysis.
The polymers were purified by adding a solution of polymer in a small amount of DCM dropwise into stirring methanol (100 mL) to precipitate the polymer. The solid was then filtered and washed with pentane to be used for ¹³C{¹H} NMR spectra and GPC analysis of the final product.

Additionally, a one pot copolymerization of ε-caprolactone and ω-pentadecalactone with (L₆)₂Ti(OⁱPr)₂ yielded a statistical copolymer of poly(CL-co-PDL). The general conditions used for this experiment are outlined below:

In a glovebox, catalyst (˜7 mg, 0.010 mmol) was weighed into a vial, along with w-pentadecalactone, ε-caprolactone and enough toluene to produce a 1 M solution. The vial was then sealed and the stirring solution was immersed in an oil bath preheated to 100° C. Aliquots were removed at 2.5 h and 24 h for analysis by ¹H NMR in CDCl₃. Samples were then cooled to 0° C., exposed to air and quenched with wet hexanes.

While specific embodiments of the invention have been described herein for the purpose of reference and illustration, various modifications will be apparent to a person skilled in the art without departing from the scope of the invention as defined by the appended claims.

### REFERENCES

1. Letizia Focarete, M.; Scandola, M.; Kumar, A.; Gross, R. A., Physical characterization of poly(ω-pentadecalactone) synthesized by lipase-catalyzed ring-opening polymerization. Journal of Polymer Science Part B: Polymer Physics 2001, 39 (15), 1721-1729.
2. Nomura, R.; Ueno, A.; Endo, T., Anionic ring-opening polymerization of macrocyclic esters. Macromolecules 1994, 27, 620-621.
3. Bouyahyi, M.; Duchateau, R., Metal-Based Catalysts for Controlled Ring-Opening Polymerization of Macrolactones: High Molecular Weight and Well-Defined Copolymer Architectures. Macromolecules 2014, 47, 517-524.
4. Pepels, M. P. F.; Bouyahyi, M.; Heise, A.; Duchateau, R., Kinetic Investigation on the Catalytic Ring-Opening (Co)Polymerization of (Macro)Lactones Using Aluminum Salen Catalysts. Macromolecules 2013, 46 (11), 4324-4334.
5. van der Meulen, I.; Gubbels, E.; Huijser, S.; Sablong, R.; Koning, C. E.; Heise, A.; Duchateau, R., Catalytic Ring-Opening Polymerization of Renewable Macrolactones to High Molecular Weight Polyethylene-like Polymers. Macromolecules 2011, 44 (11), 4301-4305.
6. Sheldrick, G. M., A short history of SHELX. Acta Crystallographica Section A: Foundations of Crystallography 2008, 64, 112-122.
7. Farrugia, L. J., WinGX and ORTEP for Windows: an update. Journal of Applied Crystallography 2012, 45, 849-854.
8. Wilson, A. J. C., International Tables for Crystallography. 1st ed.; Kluwer Academic Publishers: Dordrecht, 1992; Vol. C.

1. A compound having a structure according to formula (I-A), (I-B) or (I-C) shown below: 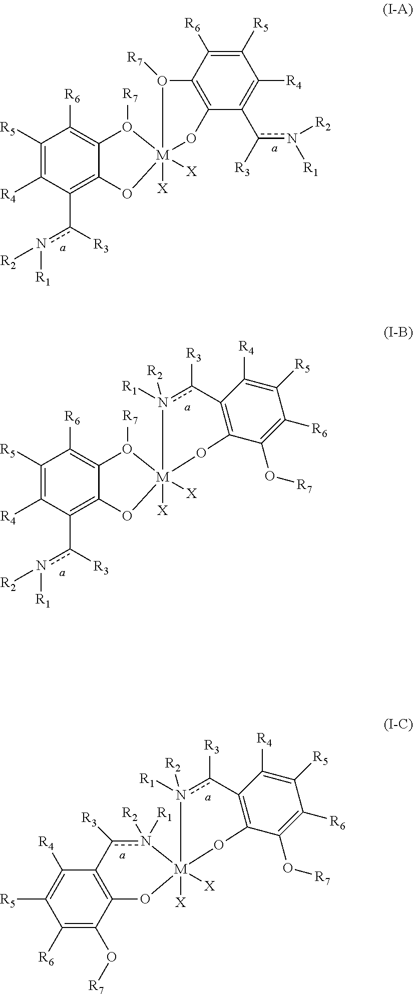
wherein
M is a Group IV transition metal,
each X is independently selected from halo, hydrogen, a phosphonate, sulfonate or boronate group, (1-4C)dialkylamino, (1-6C)alkyl, (1-6C)alkoxy, aryl, and aryloxy, any of which may be optionally substituted one of more groups selected from halo, oxo, hydroxy, amino, nitro, (1-6C)alkyl, (2-6C)alkenyl, (2-6C)alkynyl, (1-6C)haloalkyl, (1-6C)alkoxy, aryl and Si[(1-4C)alkyl]₃,
R₂ is absent or is selected from hydrogen, halo, oxo, hydroxy, amino, nitro, (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and (1-6C)alkoxy,
bond a is a carbon-nitrogen single bond (C—N) or a carbon-nitrogen double bond (C═N), with the proviso that when R₂ is absent, bond a is a carbon-nitrogen double bond (C═N), and when R₂ is other than absent, bond a is a carbon-nitrogen single bond (C—N),
R₃, R₄, R₅ and R₆ are each independently selected from hydrogen, halo, oxo, hydroxy, amino, nitro, (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and (1-6C)alkoxy,
R₇ is selected from (1-6C)alkyl, (2-6C)alkenyl, (2-6C)alkynyl, (1-6C)haloalkyl, aryl, heteroaryl, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and (1-6C)alkoxy,
R₁ is a group having the formula (II) shown below: 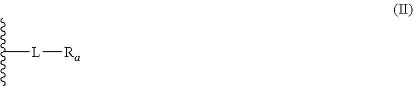
wherein
Rₐ is selected from (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl, aryl, aryloxy, heteroaryl, heteroaryloxy, carbocyclyl and heterocyclyl,
L is a group —[C(Rₓ)₂]ₙ—
wherein
each Rₓ is independently selected from hydrogen, (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and aryl, and
n is 0, 1, 2, 3 or 4.

2. The compound of claim 1, wherein the compound has a structure according to formula (I-A) or (I-B).

3. The compound of claim 1, wherein the compound has a structure according to formula (I-A).

4. The compound of claim 1, wherein the compound has a structure according to formula (I-B).

5. The compound of claim 1, wherein the compound has a structure according to formula (I-C).

6. The compound of any preceding claim, wherein M is selected from titanium, zirconium and hafnium.

7. The compound of any preceding claim, wherein M is selected from titanium and zirconium.

8. The compound of any preceding claim, wherein M is titanium.

9. The compound of any preceding claim, wherein each X is independently selected from halo, hydrogen, (1-6C)alkoxy, —N(CH₃)₂, —N(CH₂CH₃)₂ and aryloxy, any of which may be optionally substituted one of more groups selected from halo, oxo, hydroxy, amino, nitro, (1-6C)alkyl, (2-6C)alkenyl, (2-6C)alkynyl, (1-6C)haloalkyl, (1-6C)alkoxy, aryl and Si[(1-4C)alkyl]₃.

10. The compound of any preceding claim, wherein each X is independently selected from halo, hydrogen, (1-6C)alkoxy, and aryloxy, any of which may be optionally substituted one of more groups selected from halo, oxo, hydroxy, amino, nitro, (1-6C)alkyl, (2-6C)alkenyl, (2-6C)alkynyl, (1-6C)haloalkyl, (1-6C)alkoxy, aryl and Si[(1-4C)alkyl]₃.

11. The compound of any one of claims 1 to 9, wherein each X is independently selected from halo, hydrogen, (1-6C)alkoxy, —N(CH₃)₂, —N(CH₂CH₃)₂ and aryloxy, any of which may be optionally substituted one of more groups selected from halo, oxo, hydroxy, amino, nitro, (1-6C)alkyl, (1-6C)haloalkyl, (1-6C)alkoxy and aryl.

12. The compound of claim 11, wherein each X is independently selected from halo, hydrogen, (1-6C)alkoxy, and aryloxy, any of which may be optionally substituted one of more groups selected from halo, oxo, hydroxy, amino, nitro, (1-6C)alkyl, (1-6C)haloalkyl, (1-6C)alkoxy and aryl.

13. The compound of any one of claims 1 to 9, wherein each X is independently selected from halo, hydrogen, (1-4C)alkoxy, —N(CH₃)₂, —N(CH₂CH₃)₂ and phenoxy, any of which may be optionally substituted one of more groups selected from halo, oxo, hydroxy, amino, nitro, (1-4C)alkyl, (1-4C)haloalkyl, (1-4C)alkoxy and phenyl.

14. The compound of claim 13, wherein each X is independently selected from halo, hydrogen, (1-4C)alkoxy, and phenoxy, any of which may be optionally substituted one of more groups selected from halo, oxo, hydroxy, amino, nitro, (1-4C)alkyl, (1-4C)haloalkyl, (1-4C)alkoxy and phenyl.

15. The compound of any preceding claim, wherein each X is independently selected from halo, hydrogen, and (1-4C)alkoxy, any of which may be optionally substituted one of more groups selected from halo, hydroxy, amino, (1-4C)alkyl and (1-4C)alkoxy.

16. The compound of any preceding claim, wherein each X is independently selected from chloro, bromo and (1-4C)alkoxy.

17. The compound of any preceding claim, wherein each X is independently (1-4C)alkoxy.

18. The compound of any preceding claim, wherein each X is isopropoxy.

19. The compound of any one of claims 1 to 9, wherein each X is independently —N(CH₃)₂ or —N(CH₂CH₃)₂.

20. The compound of any preceding claim, wherein R₂ is absent or hydrogen.

21. The compound of any preceding claim, wherein R₂ is absent.

22. The compound of any one or claims 1 to 20, wherein R₂ is hydrogen.

23. The compound of any preceding claim, wherein R₃, R₄, R₅ and R₆ are each independently selected from hydrogen, halo, oxo, hydroxy, amino, nitro, (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-4C)alkyl, (2-4C)alkenyl, (2-4C)alkynyl, (1-4C)haloalkyl and (1-4C)alkoxy.

24. The compound of any preceding claim, wherein R₃, R₄, R₅ and R₆ are each independently selected from hydrogen, halo, oxo, hydroxy, amino, nitro, (1-4C)alkyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy.

25. The compound of any preceding claim, wherein R₃, R₄, R₅ and R₆ are each independently selected from hydrogen, halo, amino, nitro, (1-4C)alkyl, (1-4C)haloalkyl, (1-4C)alkoxy, aryl and heteroaryl, any of which may be optionally substituted with one or more substituents selected from halo and (1-4C)alkyl.

26. The compound of any preceding claim, wherein R₃ is hydrogen.

27. The compound of any preceding claim, wherein R₃, R₄, R₅ and R₆ are hydrogen.

28. The compound of any preceding claim, wherein R₇ is selected from (1-6C)alkyl, (2-6C)alkenyl, (2-6C)alkynyl, (1-6C)haloalkyl, aryl and heteroaryl, any of which may be optionally substituted with one or more substituents selected from halo, oxo, hydroxy, amino, nitro, (1-6C)alkyl, (1-6C)haloalkyl and (1-6C)alkoxy.

29. The compound of any preceding claim, wherein R₇ is selected from (1-4C)alkyl, (2-4C)alkenyl, (2-4C)alkynyl, (1-4C)haloalkyl, aryl and heteroaryl, any of which may be optionally substituted with one or more substituents selected from halo, oxo, hydroxy, amino, nitro, (1-4C)alkyl, (1-4C)haloalkyl and (1-4C)alkoxy.

30. The compound of any preceding claim, wherein R₇ is selected from (1-4C)alkyl, (1-4C)haloalkyl, aryl and heteroaryl, any of which may be optionally substituted with one or more substituents selected from halo, hydroxy, amino, (1-4C)alkyl and (1-4C)alkoxy.

31. The compound of any preceding claim, wherein R₇ is selected from (1-4C)alkyl and aryl, any of which may be optionally substituted with one or more substituents selected from halo, hydroxy, amino, (1-4C)alkyl and (1-4C)alkoxy.

32. The compound of any preceding claim, wherein R₇ is selected from (1-2C)alkyl and phenyl, any of which may be optionally substituted with one or more substituents selected from halo, hydroxy, amino and (1-4C)alkyl.

33. The compound of any preceding claim, wherein R₇ is selected from (1-2C)alkyl, which may be optionally substituted with one or more substituents selected from halo (e.g. fluoro).

34. The compound of any preceding claim, wherein R₇ is (1-2C)alkyl.

35. The compound of any preceding claim, wherein R₇ is methyl.

36. The compound of any preceding claim, wherein Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (2-6C)alkenyl, (2-6C)alkynyl, (1-6C)haloalkyl, aryl, aryloxy, heteroaryl, heteroaryloxy, carbocyclyl and heterocyclyl.

37. The compound of any preceding claim, wherein Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy.

38. The compound of any preceding claim, wherein Rₐ is selected from (1-4C)alkyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy.

39. The compound of any preceding claim, wherein Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy.

40. The compound of any preceding claim, wherein Rₐ is selected from phenyl, phenoxy, 5-7 membered heteroaryl, 5-7 membered heteroaryloxy, 5-12 membered carbocyclyl and 5-12 membered heterocyclyl, any of which (for example the phenyl group) may be optionally substituted with one or more substituents selected from halo, oxo, hydroxy, amino, nitro, (1-5C)alkyl, (1-5C)haloalkyl, phenyl, phenoxy, heteroaryl and heteroaryloxy.

41. The compound of any preceding claim, wherein Rₐ is selected from phenyl, 5-7 membered heteroaryl and 5-12 membered carbocyclyl, any of which (for example the phenyl group) may be optionally substituted with one or more substituents selected from halo, oxo, hydroxy, amino, nitro, (1-5C)alkyl, (1-5C)haloalkyl, phenyl, and heteroaryl.

42. The compound of any preceding claim, wherein Rₐ is selected from phenyl and 5-12 membered carbocyclyl, any of which (for example the phenyl group) may be optionally substituted with one or more substituents selected from halo, hydroxy, amino, (1-5C)alkyl, (1-5C)haloalkyl, phenyl, and heteroaryl.

43. The compound of any preceding claim, wherein Rₐ is selected from phenyl, cyclohexyl and adamantyl, any of which (for example the phenyl group) may be optionally substituted with one or more substituents selected from halo, (1-5C)alkyl, phenyl, and heteroaryl.

44. The compound of any preceding claim, wherein each Rₓ is independently selected from hydrogen, (1-6C)alkyl, (1-6C)alkoxy and aryl, any of which may be optionally substituted with one or more substituents selected from halo, oxo, hydroxy, amino, nitro, (1-6C)alkyl and (1-6C)haloalkyl.

45. The compound of any preceding claim, wherein each Rₓ is independently selected from hydrogen, (1-4C)alkyl, (1-4C)alkoxy and phenyl, any of which may be optionally substituted with one or more substituents selected from halo, amino and (1-6C)alkyl.

46. The compound of any preceding claim, wherein each Rₓ is independently selected from hydrogen, (1-4C)alkyl, and phenyl, any of which may be optionally substituted with one or more substituents selected from halo, amino and (1-3C)alkyl.

47. The compound of any preceding claim, wherein each Rₓ is phenyl.

48. The compound of any preceding claim, wherein n is 0, 1 or 2.

49. The compound of any preceding claim, wherein n is 0 or 1.

50. The compound of any preceding claim, wherein the compound is immobilized on a supporting substrate.

51. The compound of claim 50, wherein the supporting substrate is a solid.

52. The compound of claim 50 or 51, wherein the supporting substrate is selected from silica, alumina, zeolite and layered double hydroxide.

53. A process for the ring opening polymerisation (ROP) of a cyclic ester or a cyclic amide, the process comprising the step of:
a) contacting a compound as defined in any preceding claim with one or more cyclic esters or cyclic amides.

54. The process of claim 53, wherein the one or more cyclic esters or cyclic amides has a structure according to formula (III) shown below: 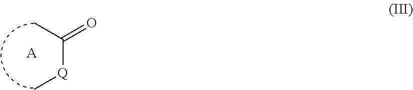
wherein
Q is selected from O or NR_{y}, wherein R_{y} is selected from hydrogen, (1-6C)alkyl, (2-6C)alkenyl and (2-6C)alkynyl; and
ring A is a 4-23 membered heterocycle containing 1 to 4 O or N ring heteroatoms in total, wherein the heterocycle is optionally substituted with one or more substituents selected from oxo, (1-6C)alkyl, (2-6C)alkenyl, (2-6C)alkynyl, (1-6C)alkoxy, aryl and heteroaryl.

55. The process of claim 54, wherein Q is selected from O or NR_{y}, wherein R_{y} is selected from hydrogen, (1-3C)alkyl, (2-3C)alkenyl or (2-3C)alkynyl.

56. The process of claim 54 or 55, wherein Q is O.

57. The process of claim 54, 55 or 56, wherein ring A is a 4-18 membered heterocycle containing 1 to 3 O or N ring heteroatoms in total, wherein the heterocycle is optionally substituted with one or more substituents selected from oxo, (1-6C)alkyl, (1-6C)alkoxy and aryl.

58. The process of any one of claims 54 to 57, wherein ring A is a 4-, 6-, 7- or 16-membered heterocycle containing 1 to 3 O or N ring heteroatoms in total, wherein the heterocycle is optionally substituted with one or more substituents selected from oxo, (1-6C)alkyl, (1-6C)alkoxy and aryl.

59. The process of any one of claims 54 to 58, wherein ring A does not contain any N ring heteroatoms.

60. The process of any one of claims 53 to 59, wherein the cyclic ester or cyclic amide is a lactone.

61. The process of any one of claims 53 to 59, wherein the cyclic ester or cyclic amide is a lactide.

62. The process of any one of claims 53 to 58, wherein the cyclic ester or cyclic amide is a lactam.

63. The process of any one of claims 53 to 60, wherein the cyclic ester or cyclic amide is w-pentadecalactone

64. The process of any one of claims 53 to 63, wherein, in step a), the mole ratio of the compound of formula (I-A), (I-B) or (I-C) to the cyclic ester or cyclic amide is 1:50 to 1:10,000.

65. The process of any one of claims 53 to 64, wherein, in step a), the mole ratio of the compound of formula (I-A), (I-B) or (I-C) to the cyclic ester or cyclic amide is 1:150 to 1:5000.

66. The process of any one of claims 53 to 65, wherein, in step a), the mole ratio of the compound of formula (I-A), (I-B) or (I-C) to the cyclic ester or cyclic amide is 1:200 to 1:1000.

67. The process of any one of claims 53 to 66, wherein step a) is not conducted in a solvent.

68. The process of any one of claims 53 to 67, wherein step a) is conducted in a solvent selected from toluene, tetrahydrofuran and methylene chloride.

69. The process of any one of claims 53 to 68, wherein step a) is conducted for a period of 1 minute to 96 hours.

70. The process of any one of claims 53 to 69, wherein step a) is conducted for a period of 5 minute to 72 hours.

71. The process of any one of claims 53 to 70, wherein step a) is conducted at a pressure of 0.9 to 5 bar.

72. The process of any one of claims 53 to 71, wherein step a) is conducted at a pressure of 0.9 to 2 bar.

73. The process of any one of claims 53 to 72, wherein step a) is conducted in the presence of a chain transfer agent suitable for use in the ring opening polymerisation of a cyclic ester or cyclic amide.

74. The process of claim 73, wherein the chain transfer agent is a hydroxy-functional compound (e.g. an alcohol, diol or polyol).

75. Use of a compound as claimed in any preceding claim in the ring opening polymerisation (ROP) of a cyclic ester or a cyclic amide.

76. Use of claim 75, wherein the cyclic ester or amide is as defined in any one of claims 54 to 63.
